(19) United States
(12) Patent Application Publication
(10) Pub. No.: US 2006/0286538 A1
(43) Pub. Date: Dec. 21, 2006

(54) Interactive distributed processing learning system and method

(76) Inventors: Alan Ray Scalone, Canoga Park, CA (US); James Ronald Nelson, Lincoln, NE (US); Armyn E. Carabet, Agoura Hills, CA (US)

Correspondence Address: Mr. Alan Ray Scalone, Suite 116, 7109 Farralone Avenue, Canoga Park, CA, 91303, US

(21) Appl. No.: 11/453,584

(22) Filed: Jun. 14, 2006

Related U.S. Application Data
(60) Provisional application No. 60/692,707, filed on Jun. 20, 2005.

(51) Int. Cl. G09B 3/00

(52) U.S. Cl. 434/350

(57) ABSTRACT

An interactive distributed processing learning system and method, consisting of a dynamic distributed processing approach that combines computerized interactive, visual and audible exercises with a lead-model-test instructional format to deliver a set of multiple predefined, systematic, simulated classroom instruction lessons to Student Users in a wide range of subject areas wherein interactive lessons are configurable to each Student User's instructional needs and learning style. The computerized feature of the system may be used either on or off line. Incorporated into the learning system and method are means for enabling errorless learning that reinforces, tracks, assesses, and reports each Student User's progress.

### RELATED APPLICATION

This non-provisional application claims the benefit of priority from U.S. provisional application 60/692,707 filed on Jun. 20, 2005.

### FIELD OF THE INVENTION

This invention relates generally to a learning system and method using computerized, on or offline, aurally augmented, interactive, visual exercises to deliver instruction in a wide range of subject areas including but not limited to reading, mathematics, chemistry, science, history, language, to name a few. Incorporated into the learning system and method are means for systematic delivery of instruction, simulation of classroom instruction, lead-model-test instructional format fostering an errorless learning environment that reinforces, tracks, assesses, and reports each user's progress in a motivating and user friendly environment that is highly configurable to tailor instruction individually to the instructional needs and learning styles of each student user.

### BACKGROUND OF THE INVENTION

Delivering instruction through the means of computing systems has for some time now come into wide use due to the multimedia capabilities of today's computing systems and the costs associated with having qualified human instructors. Also, the advent of the internet creates the opportunity to deliver instruction that reach large populations regardless of time and geography. Further, virtually all subject areas of learning require precise systematic presentation of the instruction content to achieve skill mastery and all subject areas being instructed benefit from instruction delivery that includes an instructor who guides students through the instruction content. Thus, it is desirable to provide a computer based interactive distributed processing learning system and method that may be used for virtually any subject matter where the instruction is delivered in a precise systematic manner that is configurable to the individual learning needs and styles of each student and delivered by a computer simulated instructor where the high quality and comprehensive content may be delivered via the internet on both slow and fast internet connection speeds while maintaining uninterrupted and continuous delivery and it is to this end that the present invention is directed.

### SUMMARY OF THE INVENTION

The present invention is an instructional learning system and method comprising a dynamic, distributed, processing approach wherein the processes are controlled by a set of multiple predefined instructional content (including Lesson Data and Audio Data), control tables, and a user defined instruction control configuration instruction delivery system, that will be explained in greater detail in the text that follows. The instructional learning system utilizes a computer system that includes a central processing unit, monitor and keyboard. By using the instructional learning system, the user is able to interact with the learning system content, which is accessible by the user opening the instructional learning system.

The user may include one or more students, i.e. Student User. Each such Student User is a person using the instructional learning system to receive the instruction delivered by the instructional learning system, and one or more teachers. Each teacher is a person who tracks the learning process using the user defined instruction control configuration for one or more Student Users and may be, for example, the parent of an individual Student User or a teacher in charge of a group of Student Users.

It is an object of the invention that the instruction delivery system includes predefined instructional content and simulates actual classroom instruction by including a virtual teacher that is programmed to “re-teach” as many times as necessary for instruction acquisition by repeating the predefined instructional content every single time an incorrect discrimination response is given by the Student User. Because the teacher is “virtual,” the teacher is able to pronounce all verbal instructions with a precision and consistency of recitation employing state of the art voice recording and editing techniques.

It is another object of the invention that the Student User may only access the instruction in that predetermined systematic sequence when prior correct discriminations have been made to advance through a lesson.

It is yet another object of the invention that once the user defined instruction control configuration is entered, the instruction delivery system becomes entirely automated, requiring only start up of the learning system to deliver all instruction content in its precise sequence regardless of how many subsequent times the learning system is started to complete all instruction, nor of the length of time the instruction system is used each time it is started.

The computer presents to the Student User the predefined instructional content, wherein the predefined instructional content is presented to the Student User in a precise predetermined step-by-step sequence, and the Student User, utilizing said computer, responds to visual and audible prompts to select a discriminative response to the instructional content.

A significant feature of the instruction delivery system is a “lead-model-test” instruction-presentation sequence that (i) first, leads the Student User by describing exactly what is each new instructional content presentation, (ii) immediately follows with a modeled example demonstration of the new instructional content described, (iii) then immediately follows with a test step wherein the Student User is given the opportunity to demonstrate an understanding of the new instruction content with an accurate discrimination response; or, in the event of an inaccurate response, repeats the “lead-model-test” instruction-presentation sequence.

The instruction delivery system is an errorless learning system that produces evidence of demonstrated mastery of all instructional content by building into the instructional learning system (i) systematic instruction, (ii) the requirement that all correct discriminations be made by a Student User before the individual may advance to the next lesson, as well as to advance to each next instructional element in any given lesson, (iii) the “lead-model-test” instruction presentation process such that the correct discriminations are never revealed to the Student User, (iv) the recording to a data storage device every single discrimination response made by each Student User for each lesson, (v) the statistical reporting of individual lesson results that retrieves the entire discrimination response data collection for a specified lesson for a particular Student User and presents the data in a manner that every single instructional element that was incorrectly discriminated, and (vi) the statistical reporting over time of the cumulative results that retrieves the entire discrimination response data collection for a Student User and presents the data in a manner that particular pinpoints mastery and deficiencies.

Another significant feature of the invention is tailoring the instruction delivery system to the learning needs and learning style of each individual Student User by incorporation of instruction delivery control mechanisms for students who benefit from such mechanisms and restricted from those who do not. The mechanisms may be, but are not limited to (i) audible confirmations of correct discriminations, (ii) varying the minutes of instruction time durations that control specific portions of the learning system to longer time periods for students who require a longer instruction cycle to acquire a specific skill or, varying the minutes of instruction time duration to shorter time periods for those who quickly acquire specific skills, or (iii) varying instruction playback speeds that control specific portions of the learning system by adjusting to a slower speed for students who require instruction to be presented at a slower rate for effective skill acquisition or by adjusting to a faster speed for students who require a faster rate of instruction presentation for effective skill acquisition.

Another feature of the invention is enabling the instructional lessons to be repeated for students who require additional instruction of a specific lesson content, yet to omit repeated lessons for those who do not require the repetition.

Another feature of the invention is the capability of the instruction delivery system to group together students at the same or similar levels of acquired skill in the learning system to minimize the negative results that occur when students are engaged in instruction at the same time with others who are at notably differing skill levels.

Another feature of the invention is the capability for the computer system to interface with the World Wide Web such that the instructional learning system content is accessible by a user logging on to the instructional learning system web site.

Further, the instructional learning system allows for the delivery over the internet of high resolution graphic movies of approximately 30 minute play times, or longer, that are voiceover narrated, interactive and containing comprehensive instructional content resulting in very large file sizes that are able to begin playback within approximately 15-20 seconds with continuous and uninterrupted playback on slow internet connection speeds of approximately 56 K by the distributed processing, wherein, in one embodiment, one instruction module is activated while the next one is being loaded at the same time and further. If the next module is not loaded and ready for playback, module 1 which has already been loaded is reactivated to maintain continuous and uninterrupted playback while subsequent modules complete their loading process.

It should be apparent the for the embodiment of the instructional learning system comprised of a beginning reading program that includes instruction in spelling, the embodiment also provides keyboarding skill development.

A further feature of the instructional learning system is the teacher users capability of completing the entire setup to deliver the entire instruction content in 2 simple steps by using an Instruction Control Process Bulk Add Students function to add all student user names at the same time and depress an “Add Students” button and then depress a “Run Lessons” button.

A yet further feature of the instructional learning system is the ability of the system, through the computing device program, to enable users who have never used a computing device before to learn and advance by building into such system a “lead-model-test” instruction-presentation sequence that (i) first, leads the Student User by describing exactly what is each new instructional content presentation, (ii) immediately follows with a modeled example demonstration of the new instructional content described, (iii) then immediately follows with a test step in which the Student User is given the opportunity to demonstrate his or her understanding of the new instruction content with an accurate discrimination response, or (iv) in the event of an inaccurate response, repeats the “lead-model-test” instruction-presentation sequence. Thus, the ability to instruct users who have never used a computing device is enhanced by presenting what each instructional element is, and demonstrating how it is done combined with creation of the Lesson Data and Audio Data in such a manner that how to use the computing device is presented using the “lead-model-test” process along with the Add Student and Run Lessons features and the systematic instruction delivery of such predetermined Lesson Data and Audio Data content wherein a Student User may only access the instruction in that predetermined systematic sequence when prior correct discriminations have been made to advance through a lesson.

### BRIEF DESCRIPTION OF THE FIGURES

FIG. 101 is a System Process Diagram illustrating the System Process wherein the Information Technology system of the present invention is defined.

FIG. 211 is a Screen Shot illustrating the Instruction Control Process user account information set up screen wherein the login password, name, address, and other user contact information may be modified as well as where the user subscription information is shown.

FIG. 221 is a Screen Shot illustrating the Instruction Control Process teacher account set up function wherein instructor user names, passwords, email address and the number of student user allocations are created and assigned to each instructor who will be utilizing the instruction system process.

FIG. 231 is a Screen Shot illustrating the Instruction Control Process transfer students function wherein student users and their corresponding instruction control settings and discrimination response lesson results data may be transferred from one instructors account to a second instructors account.

FIG. 241 is an illustration detailing the Instruction Control Process method used to define all of the Student Users that will be permitted to use the learning system for the Teacher or Parent that has accessed the learning system, as well as to define separate learning system control parameters for each Student User.

FIG. 251 is a Screen Shot illustrating the Instruction Control Process bulk add student function wherein groups of student user instruction system ID's (names) and their corresponding lesson control settings may be set up all at one time.

FIG. 261 is a Screen Shot illustrating the Instruction Control Process bulk modify student settings function wherein groups of student user corresponding lesson control settings may be modified all at one time.

FIG. 271 is a Screen Shot illustrating the Instruction Control Process individual lesson report function wherein a student users' discrimination response results data may be recalled and displayed for any one single lesson completed at a prior time.

FIG. 281 is a Screen Shot illustrating the Instruction Control Process cumulative results report function wherein a student users' discrimination response results data may be recalled and displayed for all prior completed lessons where the results are calculated as a percentage over time.

FIG. 291 is a Screen Shot illustrating the Instruction Control Process lesson center function wherein all student user instruction system ID for an instructors account are displayed on a single screen where each student may use to start their prescribed lesson.

FIG. 301 is a diagram illustrating the Instruction Main Process wherein the Instruction Module Process(s) are activated depending on the Instruction Main Process conditions.

FIG. 401 is a diagram illustrating the Instruction Module 1 process wherein the Instruction Element Processes (FIGS. 501-510) are activated depending on the Instruction Module 1 Process conditions.

FIG. 402 is a diagram illustrating the Instruction Module 2 process wherein the Instruction Element Processes (FIGS. 501-510) are activated depending on the Instruction Module 2 Process conditions.

FIG. 403 is a diagram illustrating the Instruction Module 3 process wherein the Instruction Element Processes (FIGS. 501-510) are activated depending on the Instruction Module 3 Process conditions.

FIG. 404 is a diagram illustrating the Instruction Module 4 process wherein the Instruction Element Processes (FIGS. 501-510) are activated depending on the Instruction Module 4 Process conditions.

FIG. 405 is a diagram illustrating the Instruction Module 5 process wherein the Instruction Element Processes (FIGS. 501-510) are activated depending on the Instruction Module 5 Process conditions.

FIG. 406 is a diagram illustrating the Instruction Module 6 process wherein the Instruction Element Processes (FIGS. 501-510) are activated depending on the Instruction Module 6 Process conditions.

FIG. 416 is a Screen Shot illustrating the Instruction Module 6 Process (FIG. 406) wherein student discrimination response results data is display in accordance with the criterion of Instruction Module 6 Process.

FIG. 501 is a diagram that illustrates the Instruction Element 1 Process wherein the instruction elements found in the Lesson Data (FIG. 550) and Audio Data (FIG. 560) are delivered to the Student User and the Student User discrimination responses are received and stored to the Report Data. (FIG. 271 & FIG. 281)

FIG. 502 is a diagram that illustrates the Instruction Element 2 Process wherein the instruction elements found in the Lesson Data (FIG. 550) and Audio Data (FIG. 560) are delivered to the Student User and the Student User discrimination responses are received and stored to the Report Data. (FIG. 271 & FIG. 281)

FIG. 503 is a diagram that illustrates the Instruction Element 3 Process wherein the instruction elements found in the Lesson Data (FIG. 550) and Audio Data (FIG. 560) are delivered to the Student User and the Student User discrimination responses are received and stored to the Report Data. (FIG. 271 & FIG. 281)

FIG. 504 is a diagram that illustrates the Instruction Element 4 Process wherein the instruction elements found in the Lesson Data (FIG. 550) and Audio Data (FIG. 560) are delivered to the Student User and the Student User discrimination responses are received and stored to the Report Data. (FIG. 271 & FIG. 281)

FIG. 506 is a diagram that illustrates the Instruction Element 6 Process wherein the instruction elements found in the Lesson Data. (FIG. 550) and Audio Data (FIG. 560) are delivered to the Student User and the Student User discrimination responses are received and stored to the Report Data. (FIG. 271 & FIG. 281)

FIG. 507 is a diagram that illustrates the Instruction Element 7 Process wherein the instruction elements found in the Lesson Data (FIG. 550) and Audio Data (FIG. 560) are delivered to the Student User and the Student User discrimination responses are received and stored to the Report Data. (FIG. 271 & FIG. 281)

FIG. 508 is a diagram that illustrates the Instruction Element 8 Process wherein the instruction elements found in the Lesson Data (FIG. 550) and Audio Data (FIG. 560) are delivered to the Student User and the Student User discrimination responses are received and stored to the Report Data. (FIG. 271 & FIG. 281)

FIG. 509 is a diagram that illustrates the Instruction Element 9 Process wherein the instruction elements found in the Lesson Data (FIG. 550) and Audio Data (FIG. 560) are delivered to the Student User and the Student User discrimination responses are received and stored to the Report Data. (FIG. 271 & FIG. 281)

FIG. 510 is a diagram that illustrates the Instruction Element 10 Process wherein the instruction elements found in the Lesson Data (FIG. 550) and Audio Data (FIG. 560) are delivered to the Student User and the Student User discrimination responses are received and stored to the Report Data. (FIG. 271 & FIG. 281)

FIG. 550 is a chart illustrating Lesson Data as an example of one of the embodiments of the invention as a reading instruction program. Someone skilled in art can readily see how the invention can be applied to number, alphabetic characters, strings of characters—sentences, atomic symbols, shapes and the like to construct an embodiment of the invention including but not limited to math, science, chemistry, history, geography or any other instructional content area.

FIG. 560 is a script illustrating Audio Data as an example of one of the embodiments of the invention as a reading instruction program. Someone skilled in art can readily see how the invention can be applied to an embodiment of the invention including but not limited to math, science, chemistry, history, geography or any other instructional content area where the audio data is representative of the audible instruction prescribed to teach the given instructional content area.

FIG. 600 is a Screen Shot illustrating the Instruction Element 1 Process (FIG. 501) wherein multiple instruction sets are processed in accordance with the criterion of Instruction Element 1 Process as an example of one of the embodiments of the invention as a reading instruction program.

FIG. 610 is a Screen Shot illustrating another Instruction Element 1 Process (FIG. 501) wherein multiple instruction sets are processed in accordance with the criterion of Instruction Element 1 Process as an example of one of the embodiments of the invention as a reading instruction program.

FIG. 620 is a Screen Shot illustrating yet another Instruction Element 1 Process (FIG. 501) wherein multiple instruction sets are processed in accordance with the criterion of Instruction Element 1 Process as an example of one of the embodiments of the invention as a reading instruction program.

FIG. 630 is a Screen Shot illustrating the Instruction Element 2 Process (FIG. 502) wherein multiple instruction sets are processed in accordance with the criterion of Instruction Element 2 Process as an example of one of the embodiments of the invention as a reading instruction program.

FIG. 640 is a Screen Shot illustrating another Instruction Element 2 Process (FIG. 502) wherein multiple instruction sets are processed in accordance with the criterion of Instruction Element 2 Process as an example of one of the embodiments of the invention as a reading instruction program.

FIG. 650 is a Screen Shot illustrating yet another Instruction Element 2 Process (FIG. 502) wherein multiple instruction sets are processed in accordance with the criterion of Instruction Element 2 Process as an example of one of the embodiments of the invention as a reading instruction program.

FIG. 660 is a Screen Shot illustrating the Instruction Element 3 Process (FIG. 503) wherein multiple instruction sets are processed in accordance with the criterion of Instruction Element 3 Process as an example of one of the embodiments of the invention as a reading instruction program.

FIG. 670 is a Screen Shot illustrating another Instruction Element 3 Process (FIG. 503) wherein multiple instruction sets are processed in accordance with the criterion of Instruction Element 3 Process as an example of one of the embodiments of the invention as a reading instruction program.

FIG. 680 is a Screen Shot illustrating the Instruction Element 4 Process (FIG. 504) wherein multiple instruction sets are processed in accordance with the criterion of Instruction Element 4 Process as an example of one of the embodiments of the invention as a reading instruction program.

FIG. 690 is a Screen Shot illustrating another Instruction Element 4 Process (FIG. 504) wherein multiple instruction sets are processed in accordance with the criterion of Instruction Element 4 Process as an example of one of the embodiments of the invention as a reading instruction program.

FIG. 700 is a Screen Shot illustrating yet another Instruction Element 4 Process (FIG. 504) wherein multiple instruction sets are processed in accordance with the criterion of Instruction Element 4 Process as an example of one of the embodiments of the invention as a reading instruction program.

FIG. 710 is a Screen Shot illustrating yet another Instruction Element 4 Process (FIG. 504) wherein multiple instruction sets are processed in accordance with the criterion of Instruction Element 4 Process as an example of one of the embodiments of the invention as a reading instruction program.

FIG. 720 is a Screen Shot illustrating the Instruction Element 5 Process (FIG. 506) wherein multiple instruction sets are processed in accordance with the criterion of Instruction Element 5 Process as an example of one of the embodiments of the invention as a reading instruction program.

FIG. 730 is a Screen Shot illustrating the Instruction Element 6 Process (FIG. 506) wherein multiple instruction sets are processed in accordance with the criterion of Instruction Element 6 Process as an example of one of the embodiments of the invention as a reading instruction program.

FIG. 740 is a Screen Shot illustrating another Instruction Element 6 Process (FIG. 506) wherein multiple instruction sets are processed in accordance with the criterion of Instruction Element 6 Process as an example of one of the embodiments of the invention as a reading instruction program.

FIG. 750 is a Screen Shot illustrating the Instruction Element 7 Process (FIG. 507) wherein multiple instruction sets are processed in accordance with the criterion of Instruction Element 7 Process as an example of one of the embodiments of the invention as a reading instruction program.

FIG. 760 is a Screen Shot illustrating the Instruction Element 8 Process (FIG. 508) wherein multiple instruction sets are processed in accordance with the criterion of Instruction Element 8 Process as an example of one of the embodiments of the invention as a reading instruction program.

FIG. 770 is a Screen Shot illustrating another Instruction Element 8 Process (FIG. 508) wherein multiple instruction sets are processed in accordance with the criterion of Instruction Element 8 Process as an example of one of the embodiments of the invention as a reading instruction program.

FIG. 780 is a Screen Shot illustrating yet another Instruction Element 8 Process (FIG. 508) wherein multiple instruction sets are processed in accordance with the criterion of Instruction Element 8 Process as an example of one of the embodiments of the invention as a reading instruction program.

FIG. 790 is a Screen Shot illustrating yet another Instruction Element 8 Process (FIG. 508) wherein multiple instruction sets are processed in accordance with the criterion of Instruction Element 8 Process as an example of one of the embodiments of the invention as a reading instruction program.

FIG. 800 is a Screen Shot illustrating the Instruction Element 9 Process (FIG. 509) wherein multiple instruction sets are processed in accordance with the criterion of Instruction Element 9 Process as an example of one of the embodiments of the invention as a reading instruction program.

FIG. 810 is a Screen Shot illustrating the Instruction Element 10 Process (FIG. 510) wherein multiple instruction sets are processed in accordance with the criterion of Instruction Element 10 Process as an example of one of the embodiments of the invention as a reading instruction program.

FIG. 820 is a Screen Shot illustrating another Instruction Element 10 Process (FIG. 510) wherein multiple instruction sets are processed in accordance with the criterion of Instruction Element 10 Process as an example of one of the embodiments of the invention as a reading instruction program.

### DETAILED DESCRIPTION

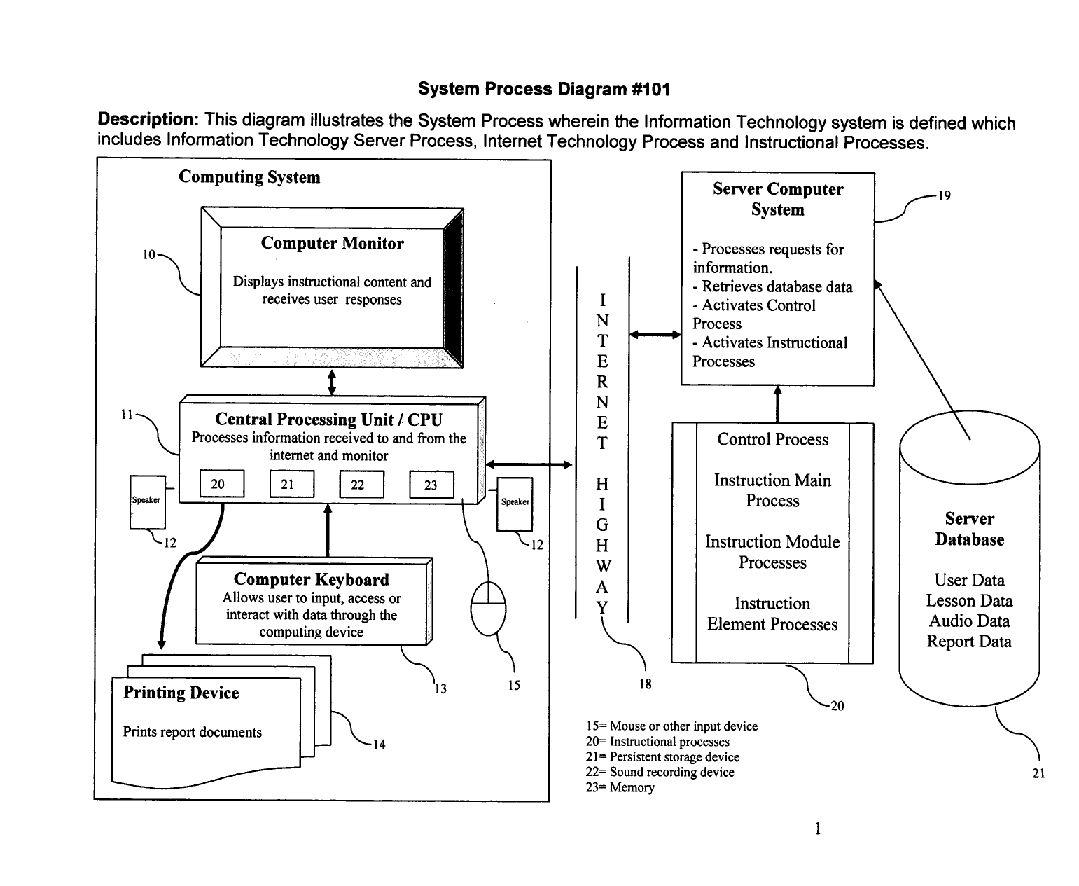

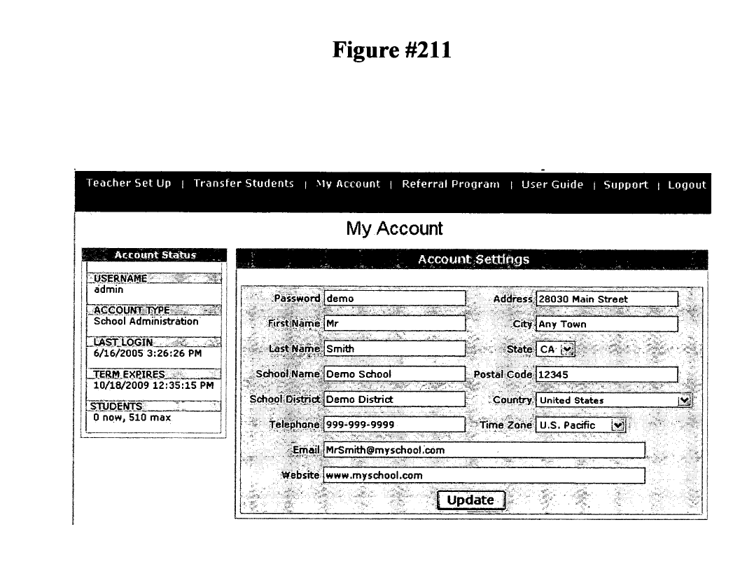

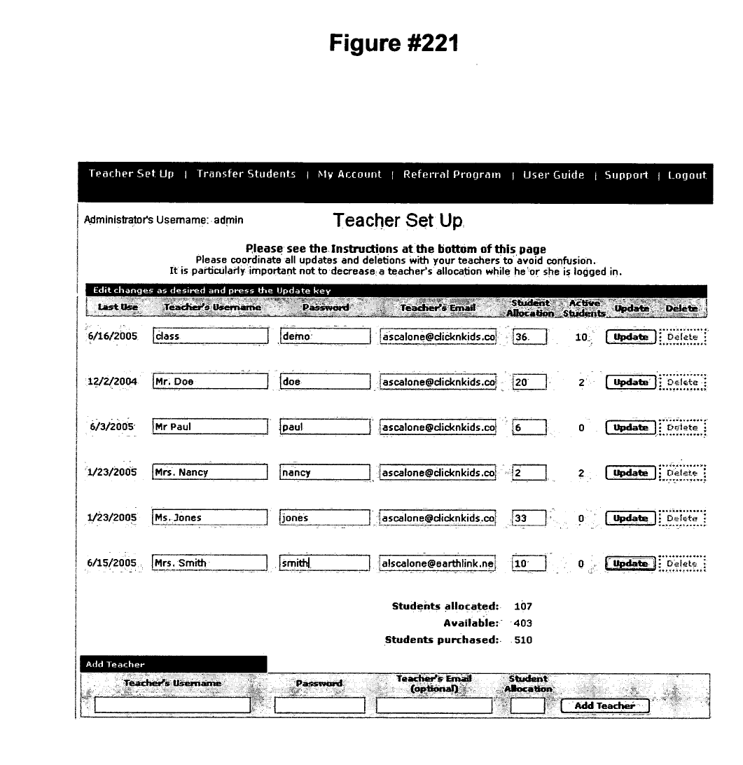

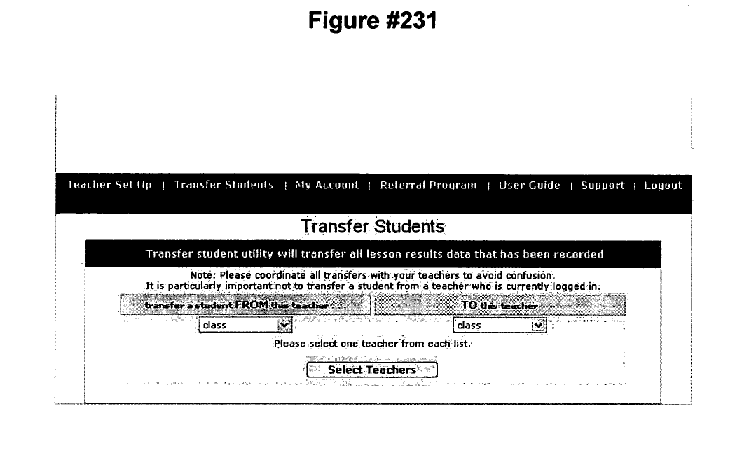

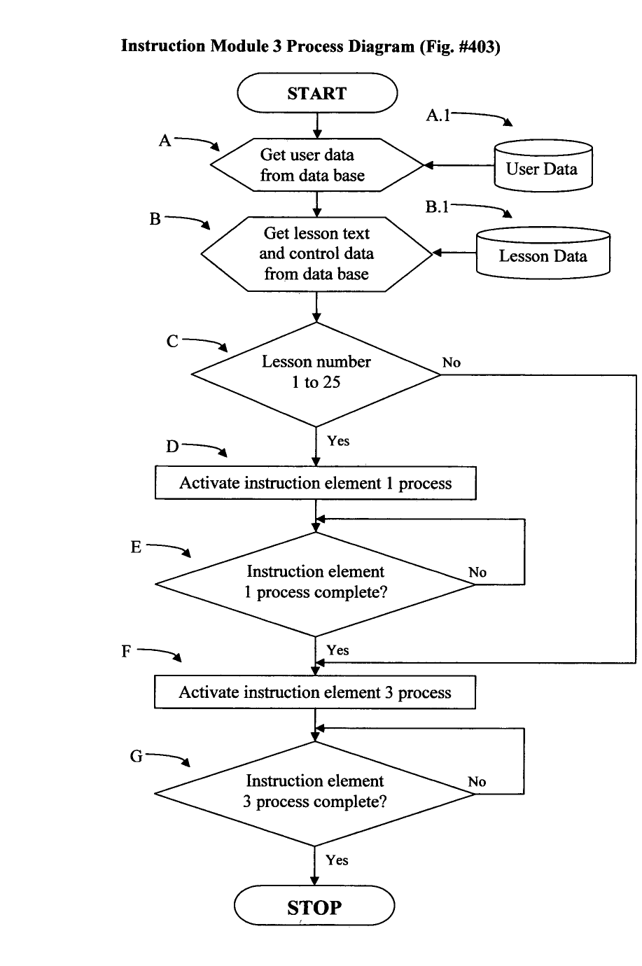

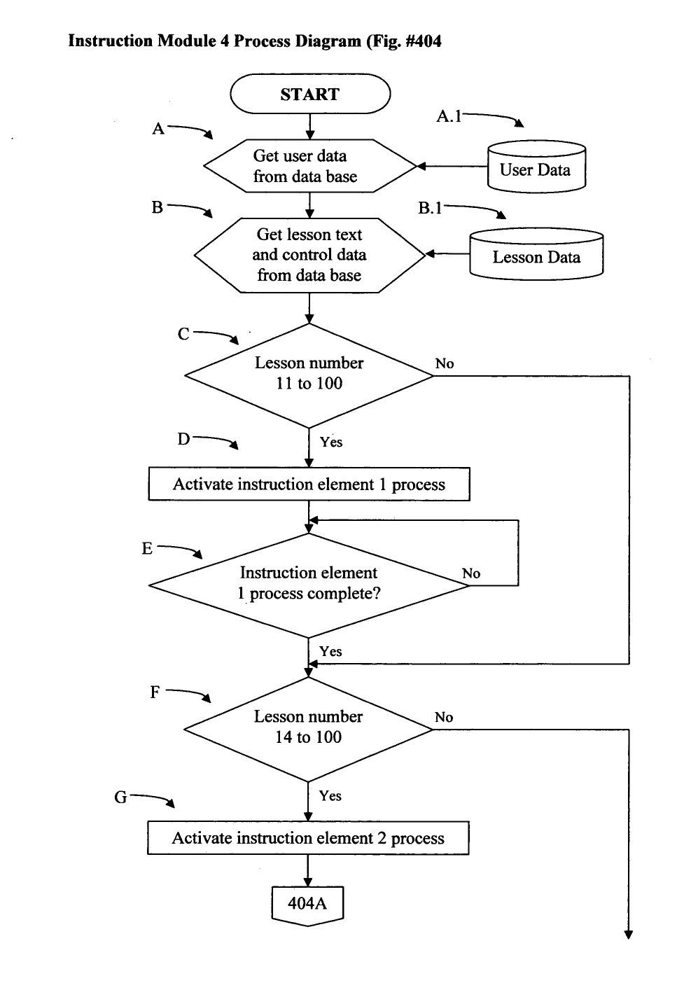

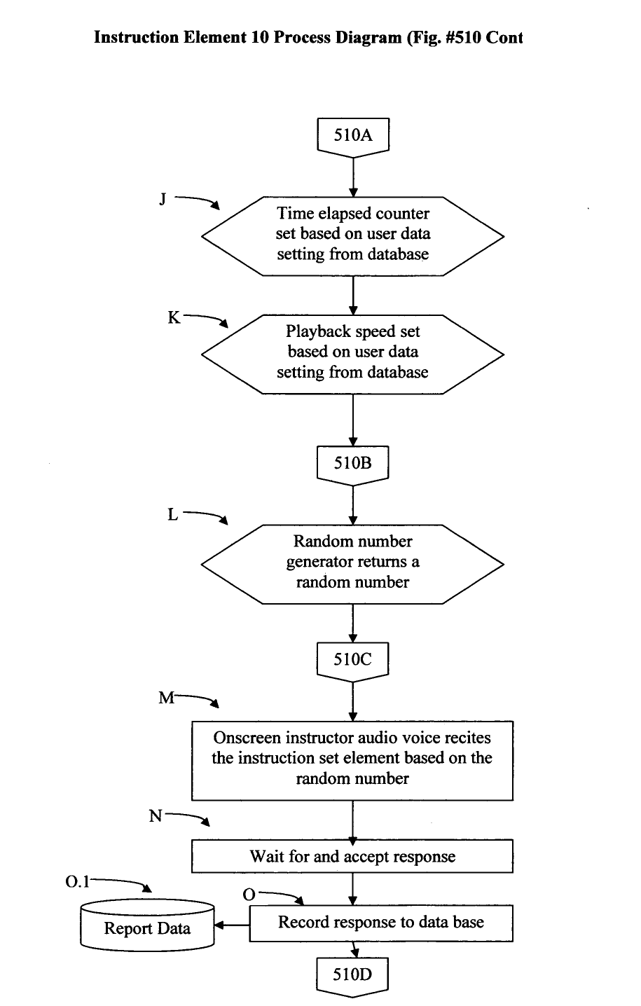

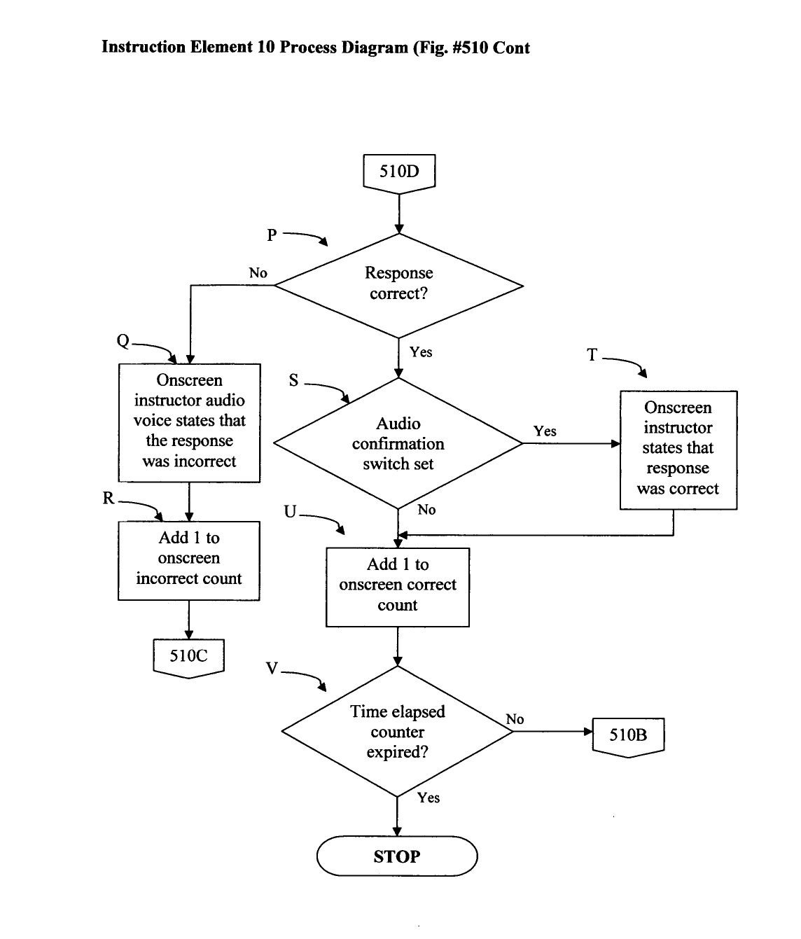

The invention is a learning system and method process that consists of a dynamic distributed processing approach that includes many differing and unique processes (FIGS. 101, 301-510) that are controlled by a set of multiple predefined instructional content control tables (FIGS. 550 & 560) and user defined instruction control configuration (FIG. 211-291) that produces an instruction delivery system that:

A) In accordance with an aspect of the invention, is entirely automated, once the user defined instruction control configuration is entered, requiring only start up of the learning system to deliver all instruction content in its precise sequence regardless of how many subsequent times the learning system is started to complete all instruction, nor of the length of time the instruction system is used each time it is started.

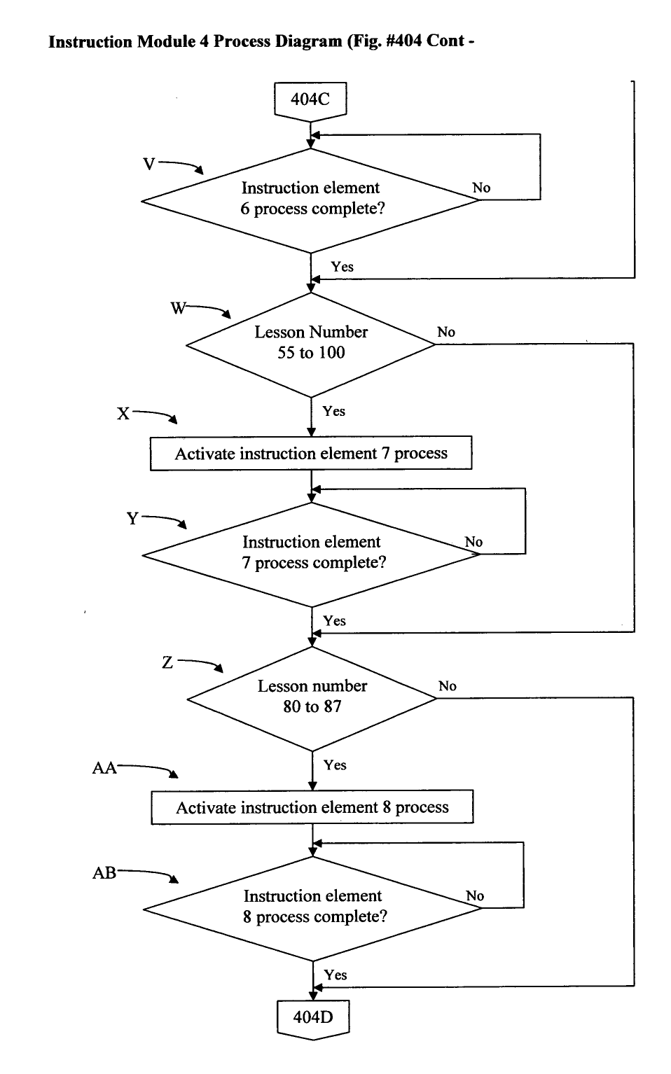

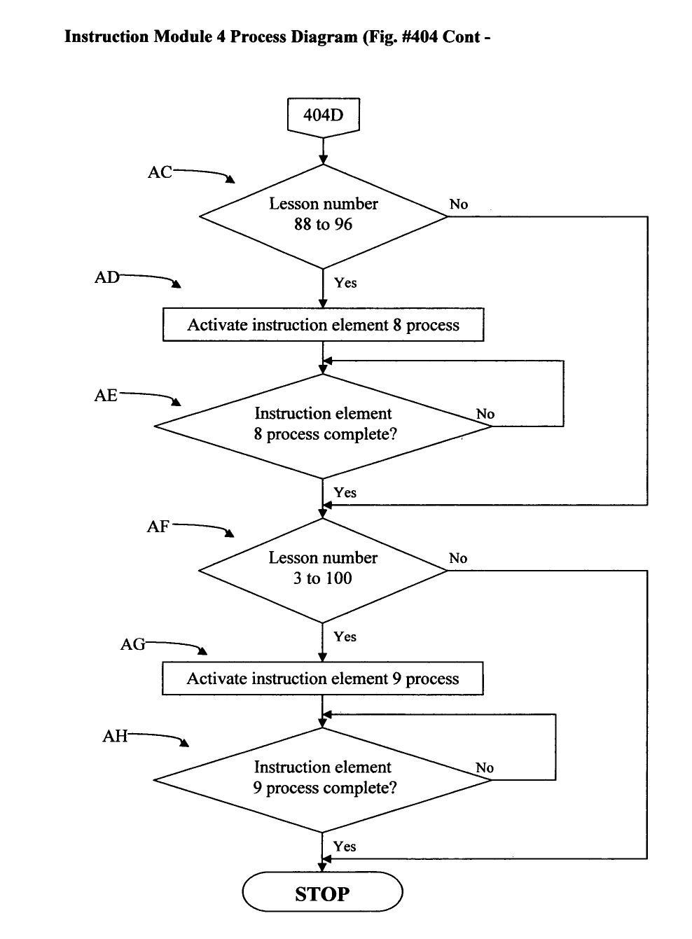

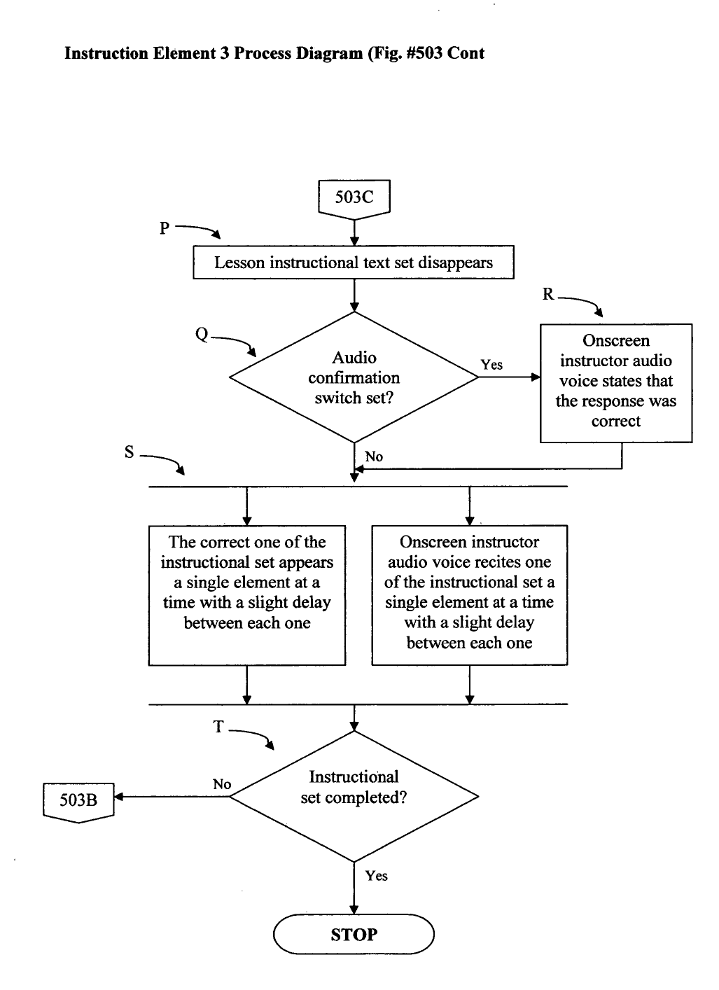

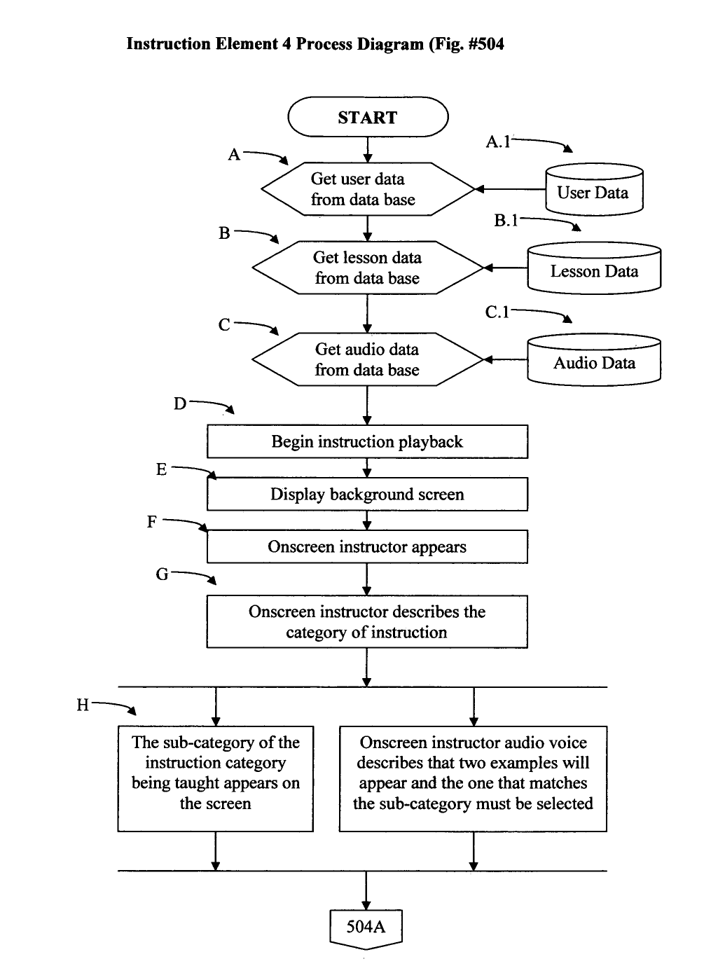

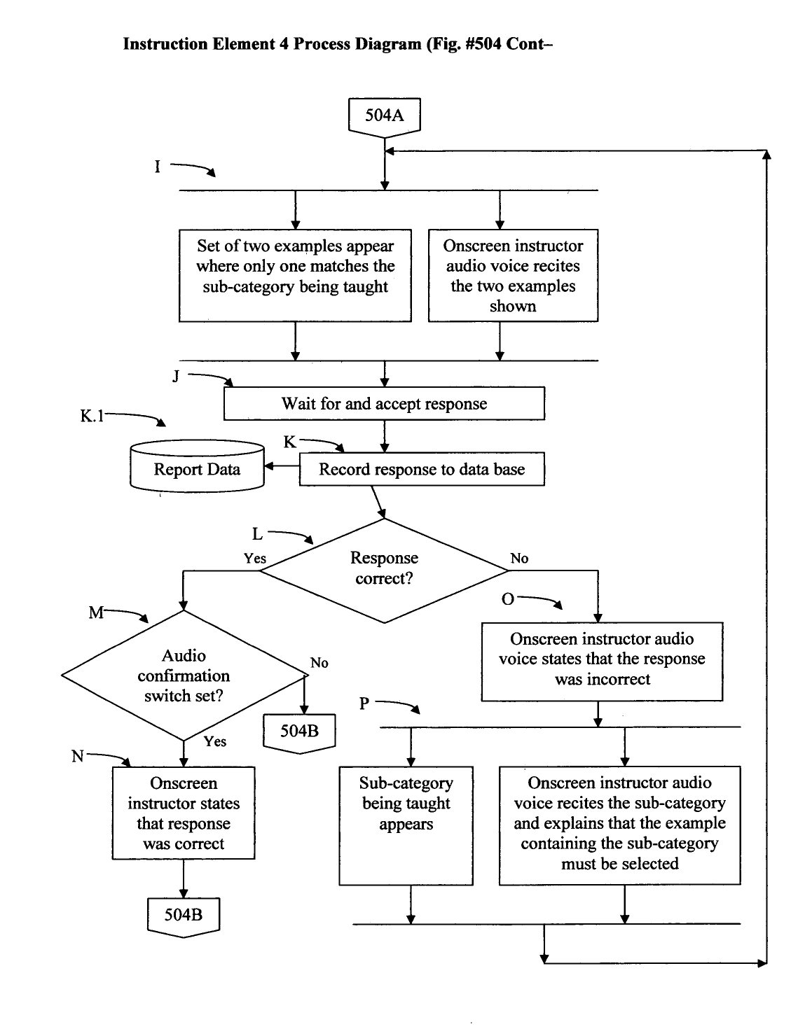

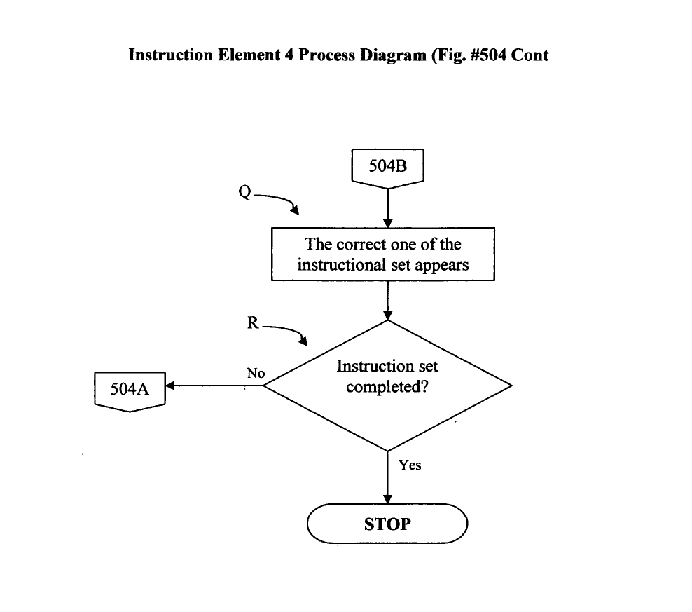

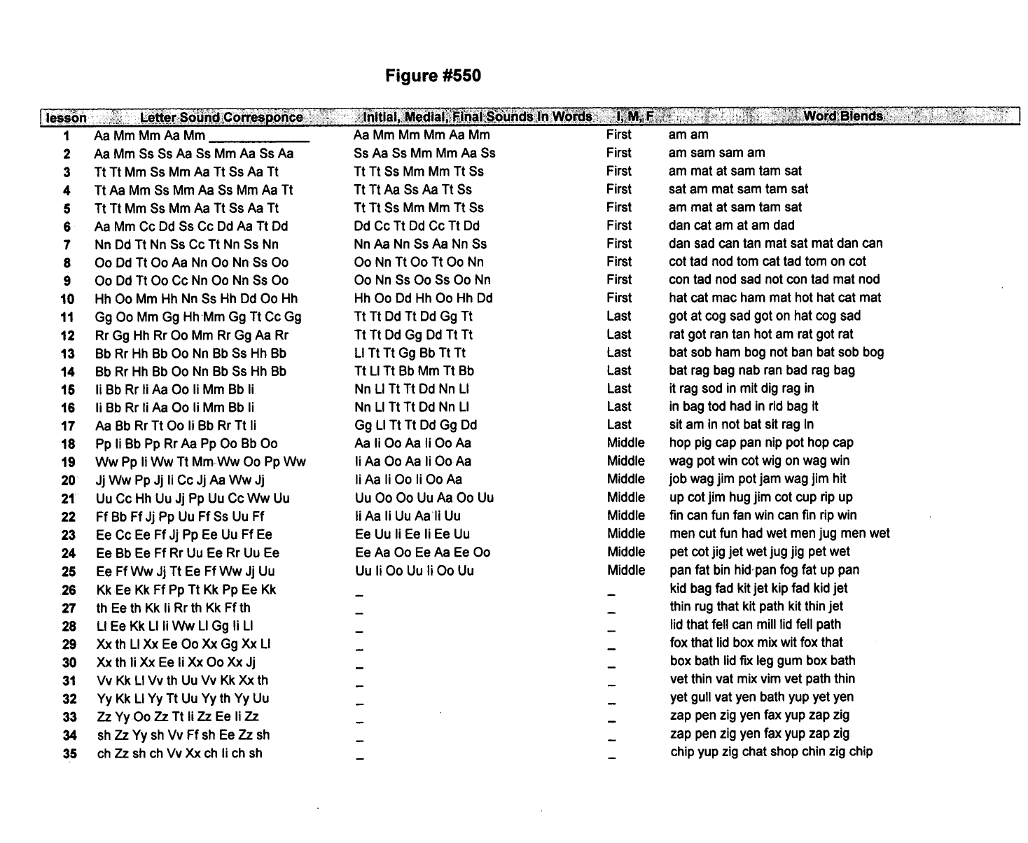

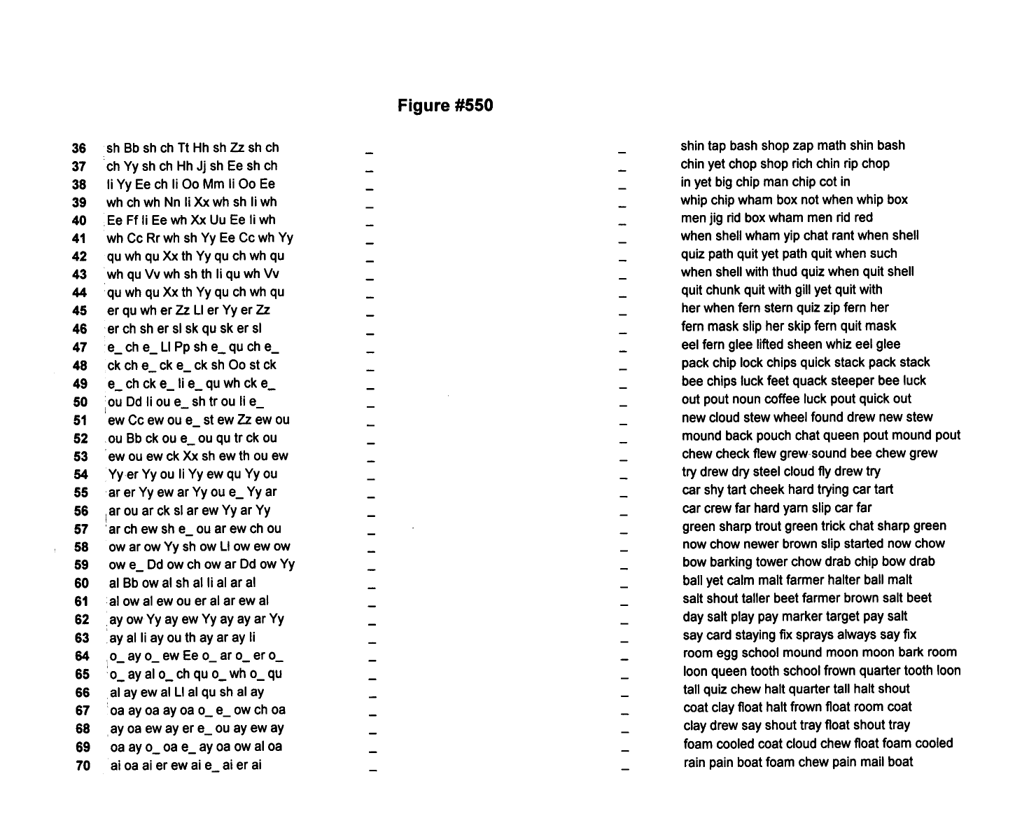

B) In accordance with yet another aspect of the invention, simulates actual classroom instruction through incorporation of:
1. A virtual teacher, illustrated in FIGS. 501-510, functioning as well if not better than a live teacher wherein the virtual teacher will:
   a. “re-teach” as many times as necessary for instruction acquisition by repeating the prescribed instruction every single time an incorrect discrimination response is given by the Student User as illustrated in one example on FIG. 501, Step N and further similar illustrations in FIGS. 502-510.
   b. Pronounces all verbal instruction with a precision and consistency of recitation not possible by live teachers by employing current state of the art voice recording and editing techniques as illustrated in FIG. 560.
2. In accordance with yet another aspect of the invention, instruction delivery process steps that deliver the prescribed instruction in a systematic process that is required for skill acquisition of a specific subject matter wherein the student user may only access the instruction in that predetermined systematic sequence, as illustrated in FIG. 401-406 and FIGS. 501-510, wherein correct discriminations must be made to advance through a lesson.
3. In accordance with yet another aspect of the invention, a lead, model, test instruction presentation sequence that first leads the student user by describing exactly what each new instructional content presentation is, immediately followed by a modeled example demonstration of the new instructional content described, then immediately followed by a test step wherein the student user is given the opportunity to demonstrate their understanding of the new instruction content with accurate discrimination responses, as illustrated in FIG. 501, Steps G through Step N, and similar illustrations in FIGS. 502-510. Upon any incorrect discrimination responses, the lead, model and test instructional sequence is repeated.

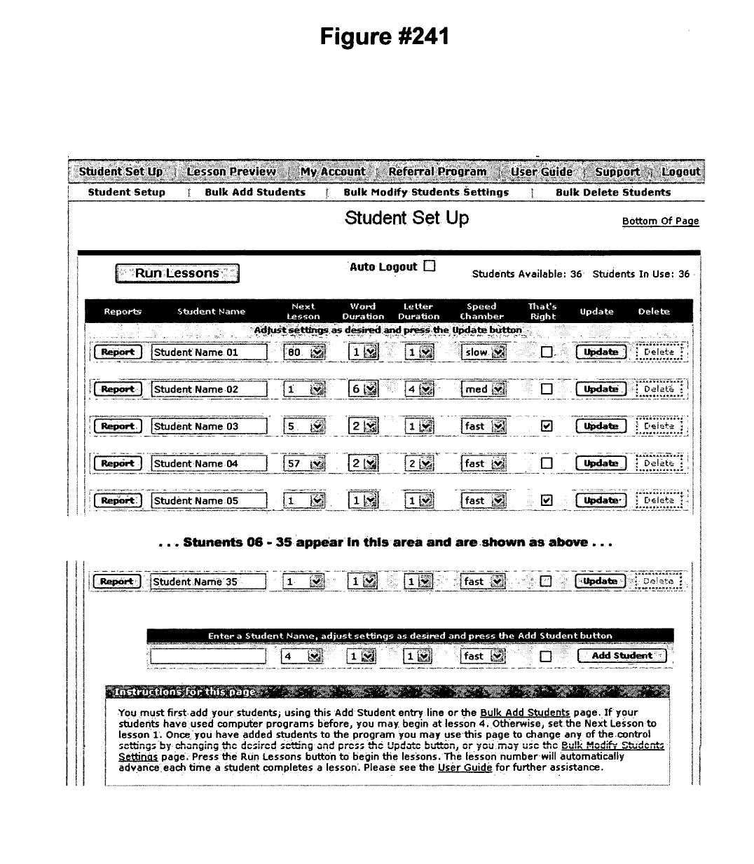

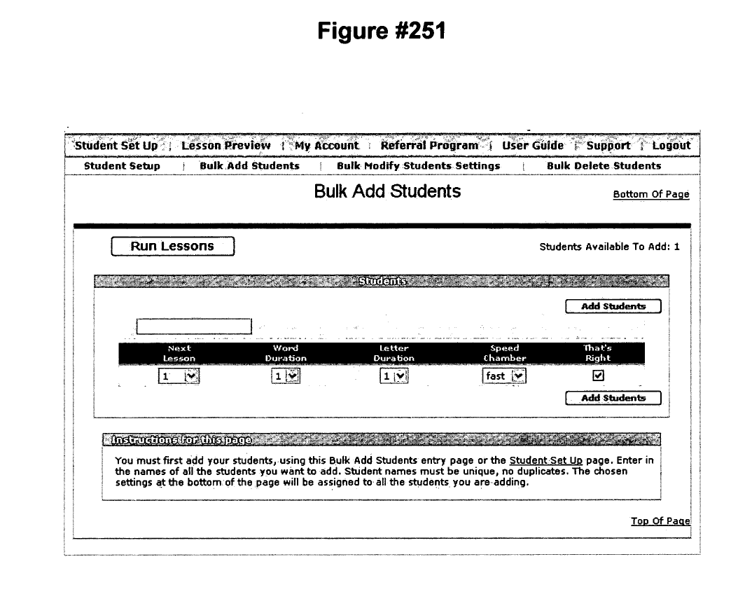

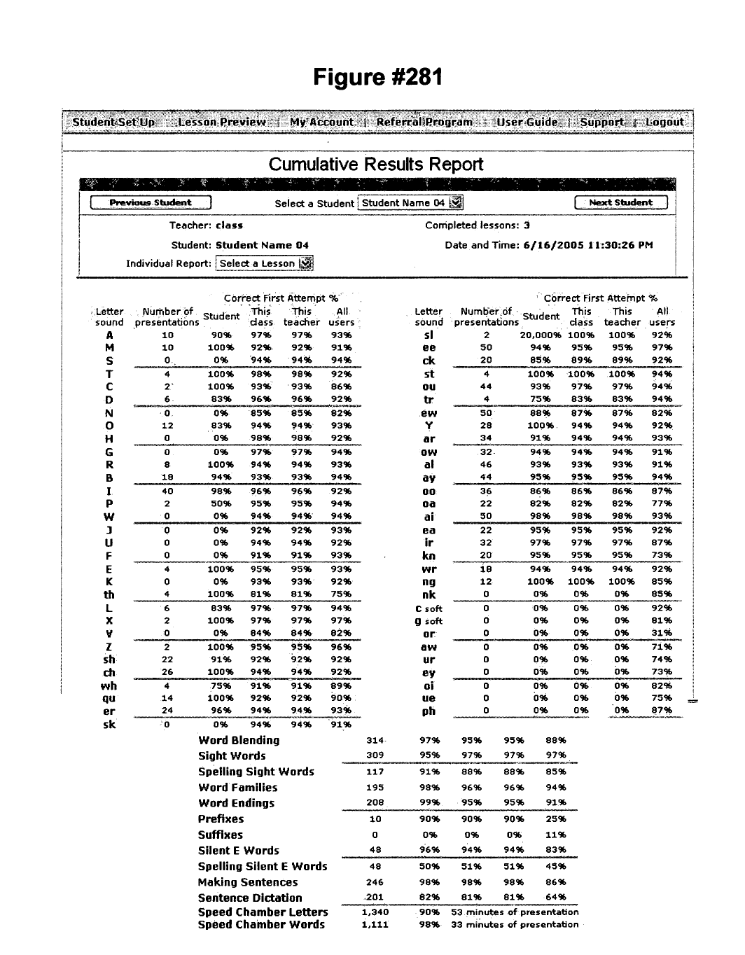

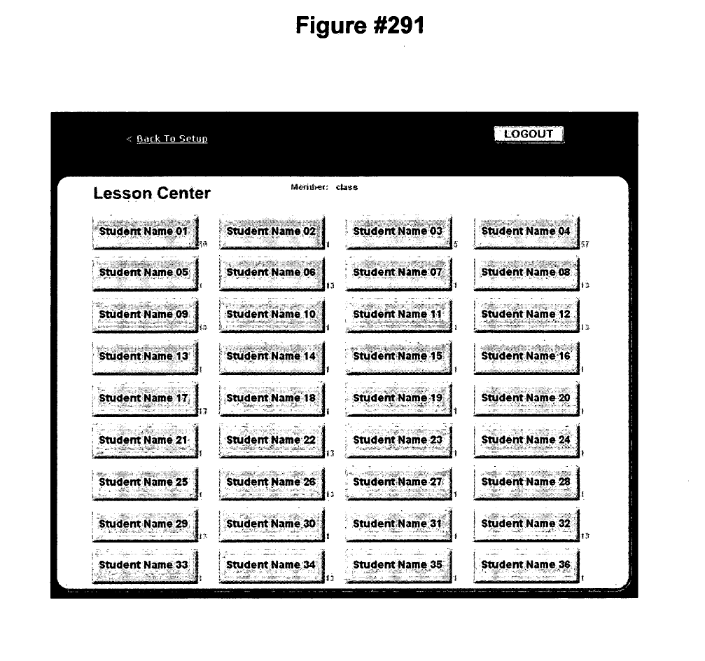

C) In accordance with yet another aspect of the invention, is tailored to the learning needs and learning style of each individual student user by incorporation of instruction delivery control mechanisms wherein:
1. Audible confirmations of correct discriminations may be provided to students who benefit from them and restricted from those who do not, as illustrated in FIG. 241, “That's Right” switch setting with switch processing in FIG. 501, Step Q and similar switch processing illustrations in FIGS. 502-510.
2. In accordance with yet another aspect of the invention, instruction lessons may be repeated for students who require additional instruction of a specific lesson content and repeated lessons omitted for those who do not, as illustrated in FIG. 241, “Next Lesson” setting.
3. In accordance with yet another aspect of the invention, instruction playback durations may be adjusted to longer time periods for students who require a longer instruction cycle to acquire a specific skill and shorter time periods for those who quickly acquire specific skills, as illustrated in FIG. 241, “Letter Duration” and “Word Duration” settings.
4. In accordance with yet another aspect of the invention, instruction playback play speed settings that may be adjusted for students who require instruction to be presented at a slower rate for effective skill acquisition and adjusted for students who require a faster rate of instruction presentation for effective skill acquisition, as illustrated in FIG. 241, “Speed Chamber” setting.
5. In accordance with yet another aspect of the invention, student users may be grouped together such that students at differing levels of acquired skill may be grouped together in the learning system to minimize the negative results that occur when students are engaged in instruction at the same time with others who are significant advanced or retarded skill levels as illustrated in FIG. 221.

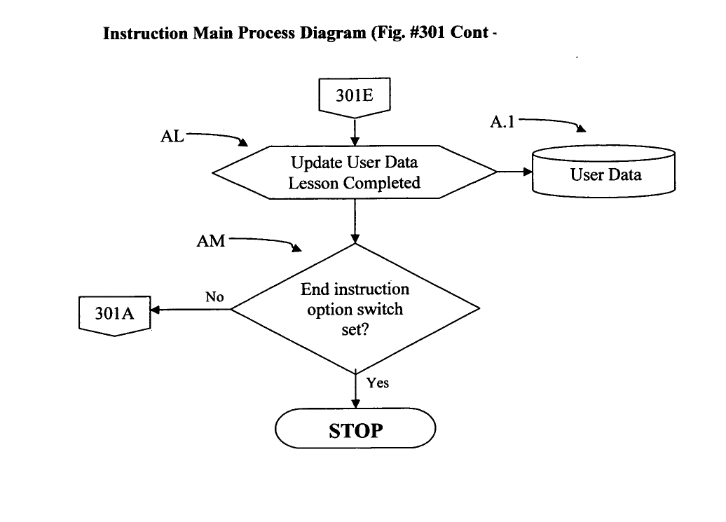

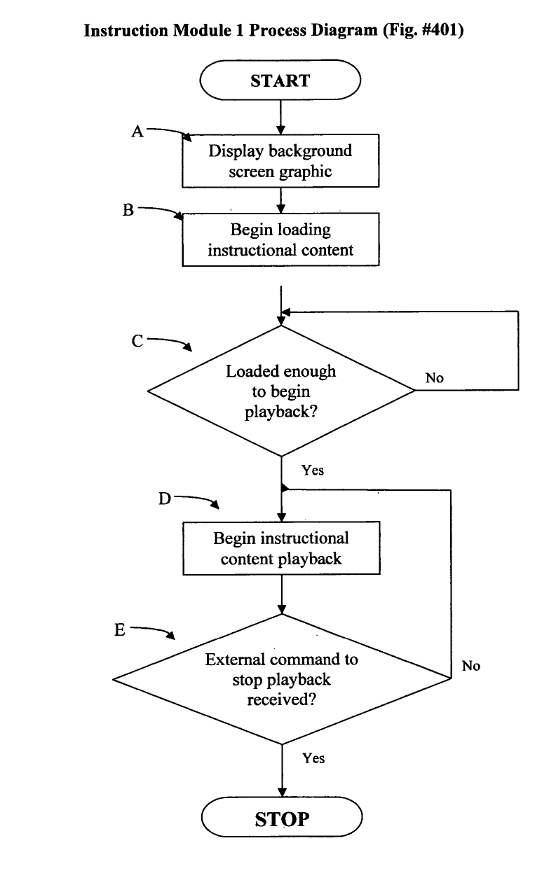

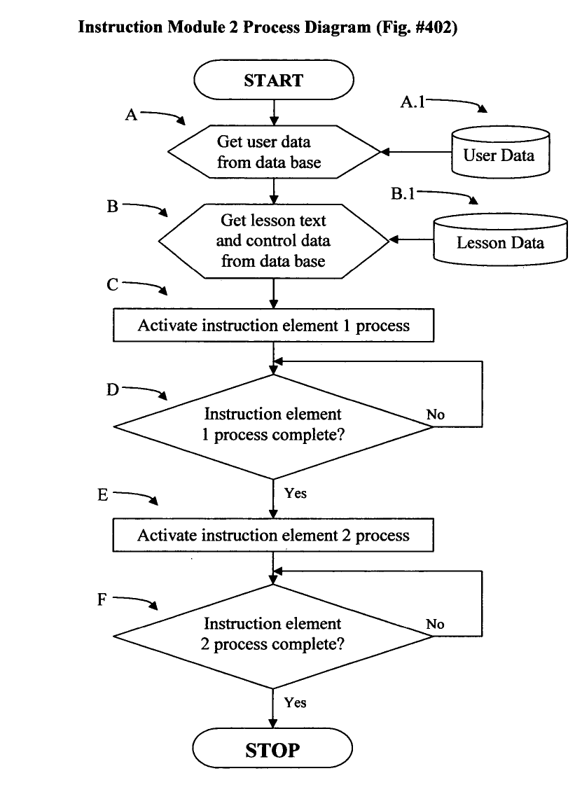

D) In accordance with yet another aspect of the invention, is an errorless learning system that produces evidence of demonstrated mastery of all instructional content by building into the invention, the following:
1. systematic instruction as described in B.2), above.
2. requiring all correct discriminations be made as described in B.1.a), above in order to advance to the next lesson as well as to advance to each next instructional element in any given lesson.
3. a lead, model, test instruction presentation process as described in B.3), above, and that never reveals what the correct discriminations are to the student user.
4. recording to a data storage device every single discrimination response made by each student user for each lesson as illustrated in FIGS. 501-510.
5. individual lesson results statistical reporting as illustrated in FIG. 271 that retrieves the entire discrimination response data collection for a specified lesson for a particular student user and presents the data in a manner that pinpoints every single instructional element that was incorrectly discriminated.
6. cumulative results over time statistical reporting as illustrated in FIG. 281 that retrieves the entire discrimination response data collection for a particular student user and presents the data in a manner that pinpoints mastery and deficiencies.

E) In accordance with yet another aspect of the invention, allows instruction delivery using a computing device to users who have never used a computing device before by building into the invention the lead, model, test presentation process as described in B.3) above, wherein exactly what each instructional element is and a demonstration of how it is done combined with creation of the lesson data and audio data for the first lesson in such a manner that how to use the computing device is presented using the same lead and model aspect of the invention.

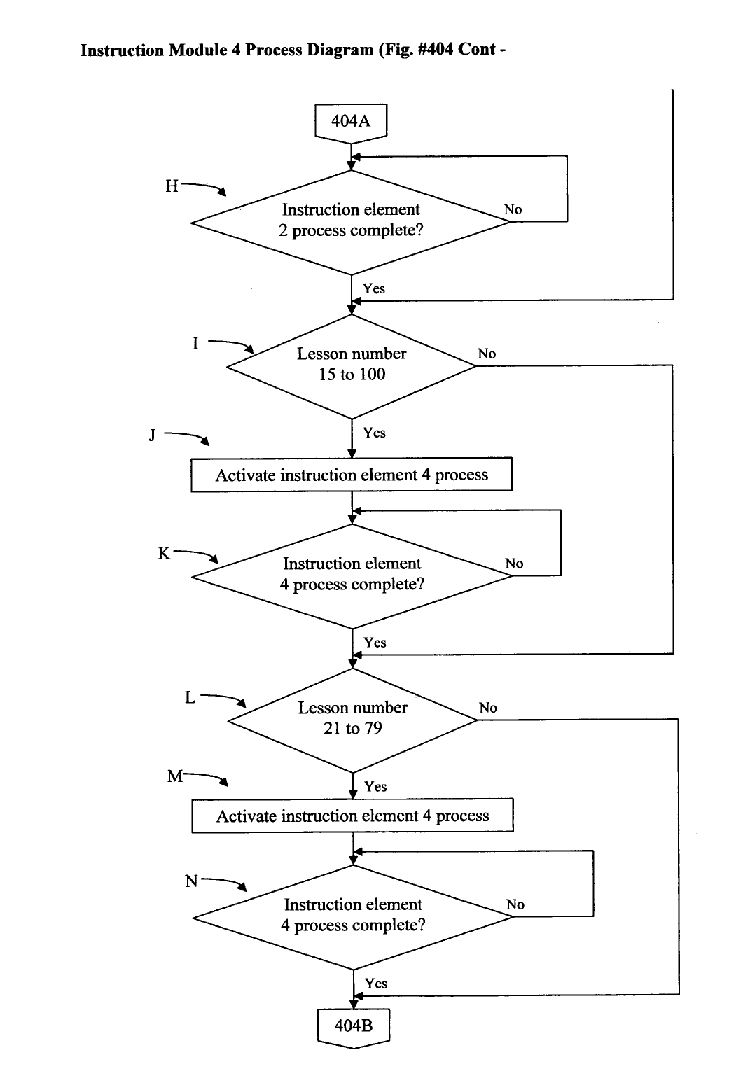

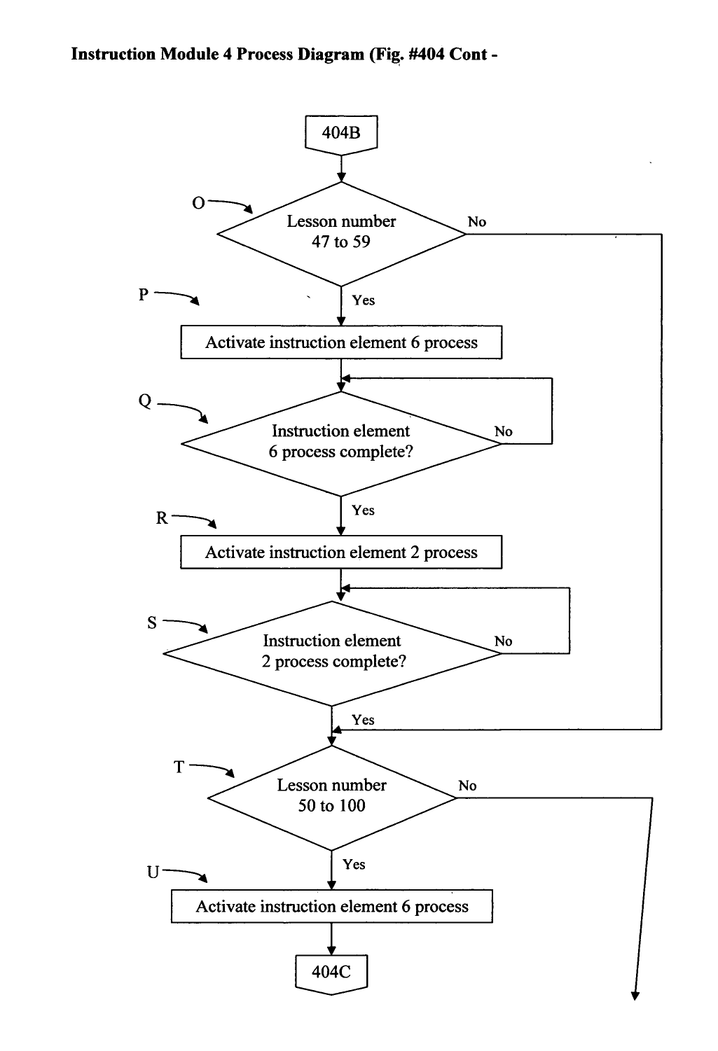

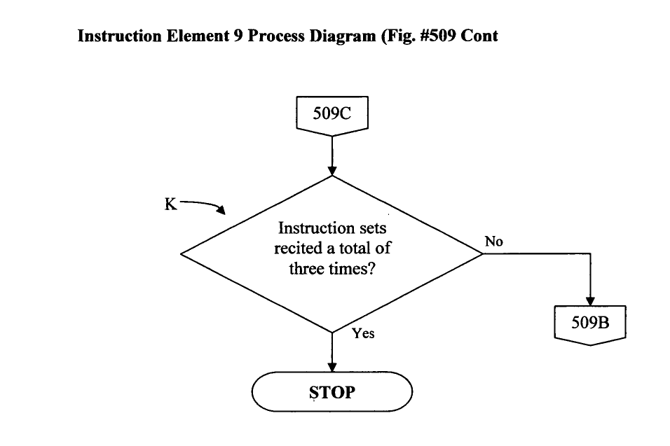

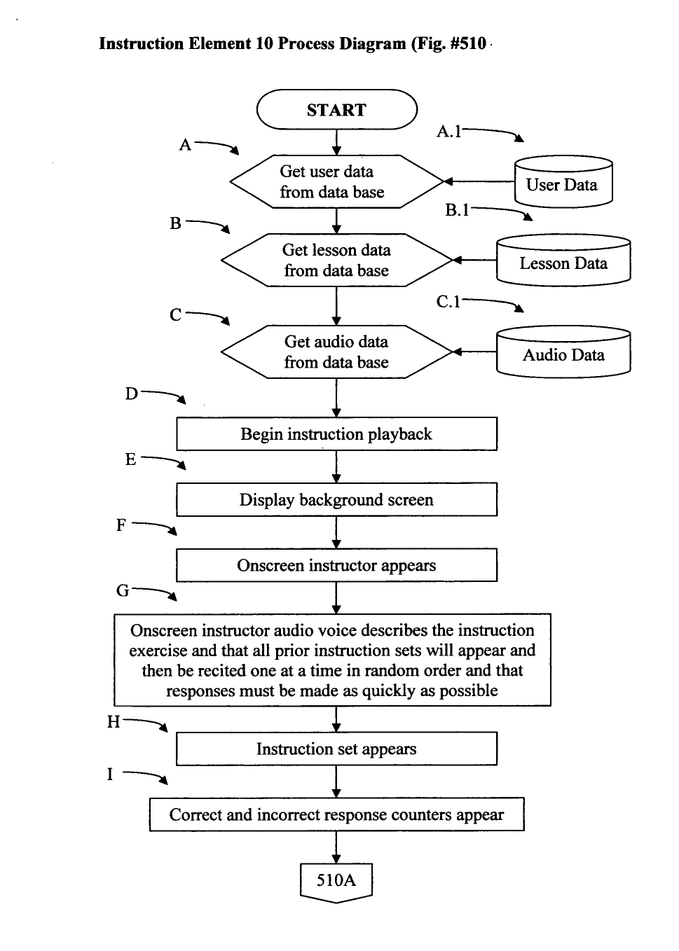

F) In accordance with yet another aspect of the invention, allows for the delivery over the internet of high resolution graphic movies of 30 minute play times or longer that are voiceover narrated, interactive and containing comprehensive instructional content resulting in very large file sizes that are able to begin playback within 15-20 seconds with continuous and uninterrupted playback on slow internet connection speeds of 56 K by the distributed processing, as illustrated in FIGS. 301-510, wherein, for example, in FIG. 301, Step C & Step D, one instruction module is activated while the next one is being loaded at the same time and further in FIG. 301, Step E, wherein anytime the next module is not loaded and ready for playback module 1 which has already been loaded is reactivated to maintain continuous and uninterrupted playback while subsequent modules complete their loading process.

G) In accordance with yet another aspect of the invention, in addition to delivering the subject matter predefined in the Lesson Data (FIG. 550) and Audio Data (FIG. 560), a learning system and method that provides for keyboarding skill development as illustrated in FIG. 502 Step J.

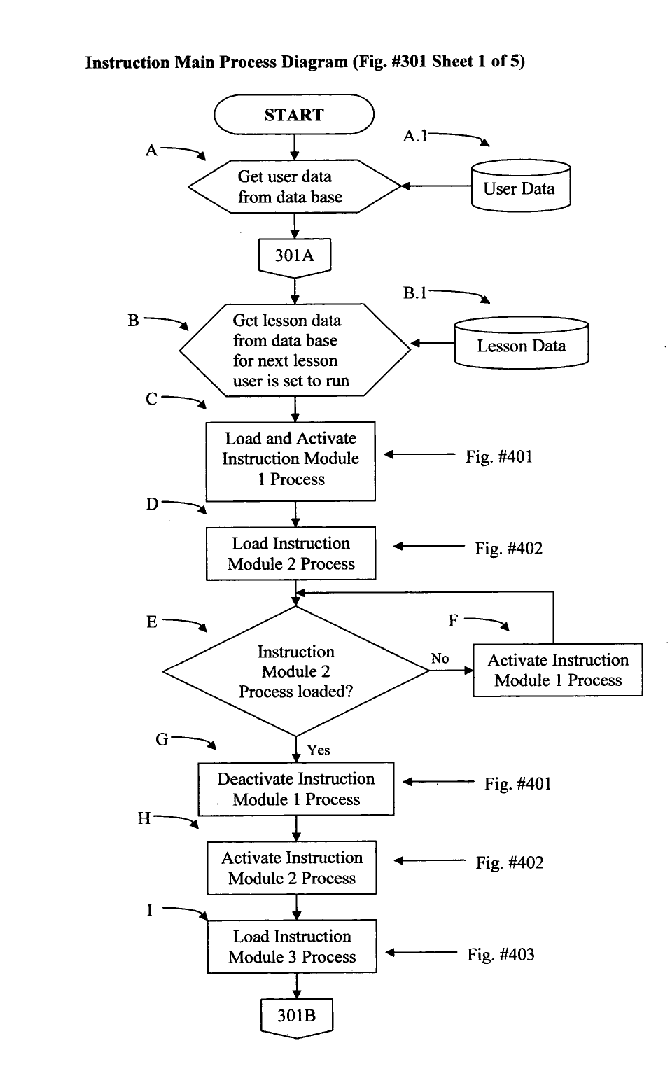

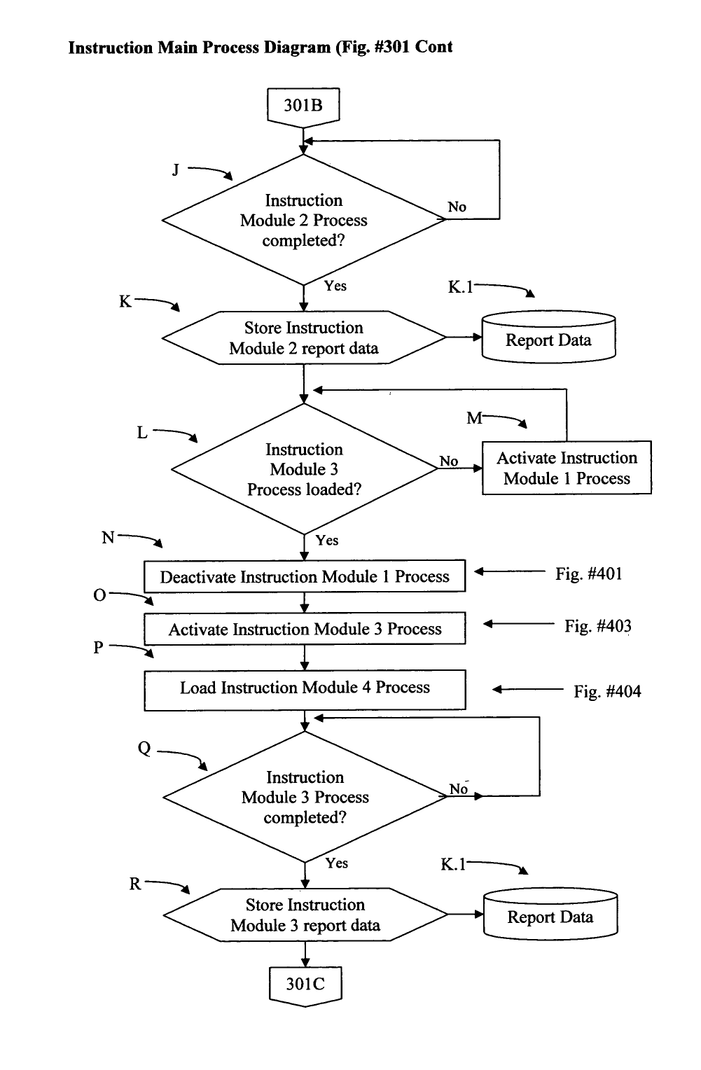

H) In accordance with yet another aspect of the invention, that the user is capable of completing the entire setup to deliver the entire instruction content in 2 simple steps by using the Instruction Control Process Bulk Add Students function (FIG. 251) to add all student user names at the same time and depress the “Add Students” button and then depress the “Run Lessons” button.

I) In accordance with yet another aspect of the invention, that no user training is required to utilize the learning system properly due to the aspect of the invention of 2 step setup detailed in H), above and the systematic instruction delivery of a predetermined Lesson Data and Audio Data content detailed in B.2), above.

Turning now to FIG. 101, a computer can be a desktop computer, a laptop computer or a variety of other handheld or wired or wireless devices that are capable of receiving, transmitting and generating data electronically, that possess the ability to store and or access data from an internal storage device such as a hard drive or other internal memory device within it or has the ability to accept and process other internal data reading or storage devices (internal CD-ROM drive, internal floppy disk drive, internal memory stick reader or similar data reading and storage device) within the computing system, or an external reading or storage device that the computing device has direct access to, whether online or offline, such as an external CD-ROM, external hard drive, external floppy disk, external memory stick reader, or other external storage devices, network server or similar storage device with similar capabilities.

FIG. 101 A Computer may include several components and may include a Central Processing Unit (CPU) 11, a memory 23, a persistent storage device 21, such as a hard disk drive, a tape drive an optical drive or the like and instructional processes 20. In a preferred embodiment, the instructional processes may be one or more software applications (training different auditory processing, phonological awareness and processing, spelling skills, reading skills, math skill, foreign language skills, or any other skill that may be taught through the use of visual and auditory stimuli) stored and accessed through a computing device which may include but is not limited to a stand alone computing device or a stand alone computing device that is connected to the Internet via any number of methods such as wired or wireless, which is connected to the Computer Monitor 10, which allows for the access, storage, creation and transfer of data electronically that can then be accessed and viewed on the system Computer Monitor 10. The CPU 11, can be connected to the internet highway 18, an internal or an external server 19, or other transfer device that allows for the transmission and or receipt of data and allows for direct access to utilize the instructional processes as well as the receipt of updates and enhancements to the instructional processes from one computing system to another or may act as a stand alone system for access exclusively on and from the individual computing system device.

The Computer may further include one or more input devices such as a keyboard 13, a mouse pointing device 15, a joystick, a sound recording device 22 or the like, a display screen 10 such as a typical cathode ray tube, a flat panel display or other viewing device and one or more output devices such as a speaker for producing sounds 12 or a printer 14 for producing printed output. The input and output devices permit a user of the computer to interact with the instructional processes so that the user's skills in whatever subject matter are being taught with the instruction processes are improved. The Computer may also execute a browser software application in order to interact with the instructional processes as described above and download one or more updates to the instructional processes.

A Printing Device 14 can be connected to a computing system either wired or wireless whereby data is transmitted from the Computing System Device to the printing device and the printing device is capable of receiving the data transmitted so it can then be transferred (printed) on to a piece of paper or film for review that does not require the computing device for viewing once it has been printed onto the paper or film.

Server Database (Server Computer System 19) is an electronic device whereby data is stored and transmitted which can be accessed by any user with a Computing System Device capable of connecting to the Server Computer System that is granted or otherwise has the ability to access the device and the data contained on the Server Computer System to view, gather or interact with such information or data that is exclusive to that individual or group of servers containing the data.

In general, instruction in accordance with the invention may be computer-based that provides opportunities for a variety of different individuals to access and participate in the instruction with alternative media that can be provided in a variety of locations and environments using the Users Computer Processor/CPU 11, such as stand-alone computers, networked computers or client/server web-based systems. In an example of one of the embodiments of the invention as a reading instruction program, the invention is designed be implemented over a computer network, including the Internet 18, a LAN, a WAN or the like wherein the user interacts with a Server Computer System 19 using a browser application and all updates/changes to the instructional processes, user data, lesson data, audio data and report data are automatically made available to all Users any time said updates/changes are completed and uploaded to the Server Computer System by the inventor.

The Instruction Control Process (FIGS. 211-291) is the process within the invention wherein the users of the learning system define all of the control parameters required to engage the learning system. The Instruction Control Process control parameters when established determine the events that will occur within the Instruction Main Process (FIG. 301), Instruction Module Processes (FIGS. 401-409) and Instruction Element Processes (FIGS. 401-409) when they are activated by the Instruction Control Process. Instruction Control Process is accessed via a login User Name and Password from a computing system device (FIG. 101) which is connected to either the Internet (FIG. 101-18), LAN, WAN or other data transmission protocol such that data communication may be maintained between the users Computer System (FIG. 101-11) and a remotely located Server Computer System (FIG. 101-19). Further, someone skilled in art can readily see how the invention can be applied to a computing device wherein the learning system instructional content and instructional processes reside on a persistent storage device (FIG. 101-21) within the users computing system wherein external data communication connections would not be required.

The Instruction Control Process (FIGS. 211-291) must be used in a sequential manner the first time the learning system is being accessed such that all required control parameters can be established to begin instruction delivery. Upon first access to learning system users are required to add Teacher or Parent IDs as well as multiple Student User ID's, for each Teacher or Parent, for all Student Users who will be using the learning system.

FIG. 211 is an illustration detailing the Instruction Control Process method used to recall the user account information set up screen wherein the login password, name, address, and other user contact information may be modified as well as where the user subscription information is shown, such as Teacher or Parent ID, first and last name, mailing address, phone, email, the type of learning system account, the last date the account was accessed, the date the subscription expires, the number of Student Users in use and maximum number of Student Users available on the User account.

FIG. 221 is an illustration detailing the Instruction Control Process method used to add the Teacher or Parent IDs to the learning system. Also, in the illustration a Teacher or Parent ID password, E-mail address and a count of the number of Student Users that are assigned to the Teacher or Parent. After entering Teacher or Parent IDs subsequent recall of this Instruction Control Process method presents a list of all Teacher or Parent IDs and other fields previously added along with the last date each Teacher or Parent accessed the learning system and the number of active students for each Teacher or Parent. Each Teacher or Parent's settings may be changed or deleted. This method is the learning system method for managing all learning system Teacher or Parents and their individual Student User assignments.

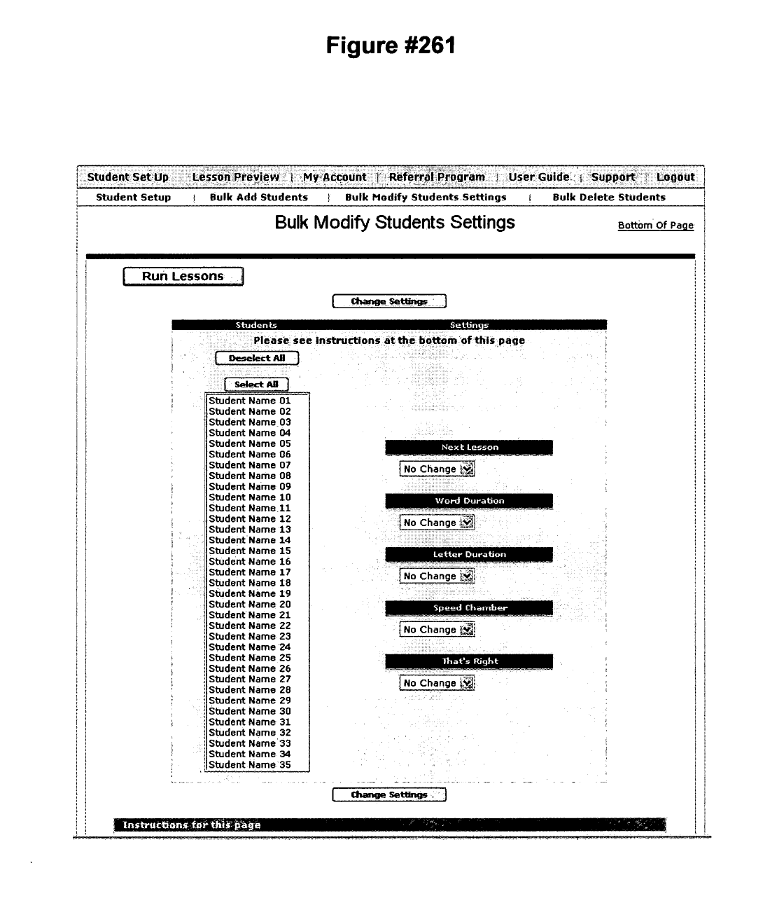

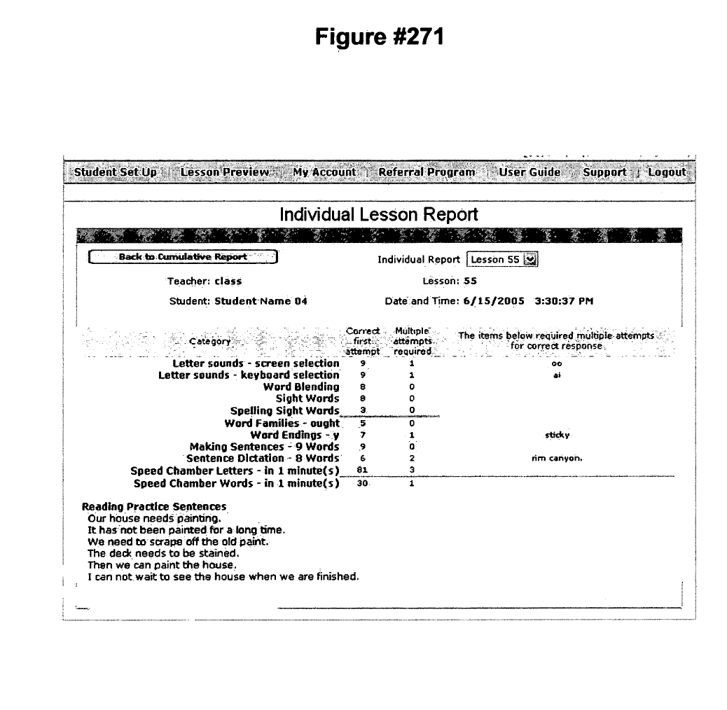

FIG. 231 is an illustration detailing the Instruction Control Process method used to transfer Student Users from one Teacher or Parent to another Teacher or Parent in the learning system. This method of the invention is provided so that Student User instructional lesson historical discrimination response Report Data that has been recorded to the computing system data storage device is maintained while providing the ability to reassign a Student User to another Teacher or Parent.

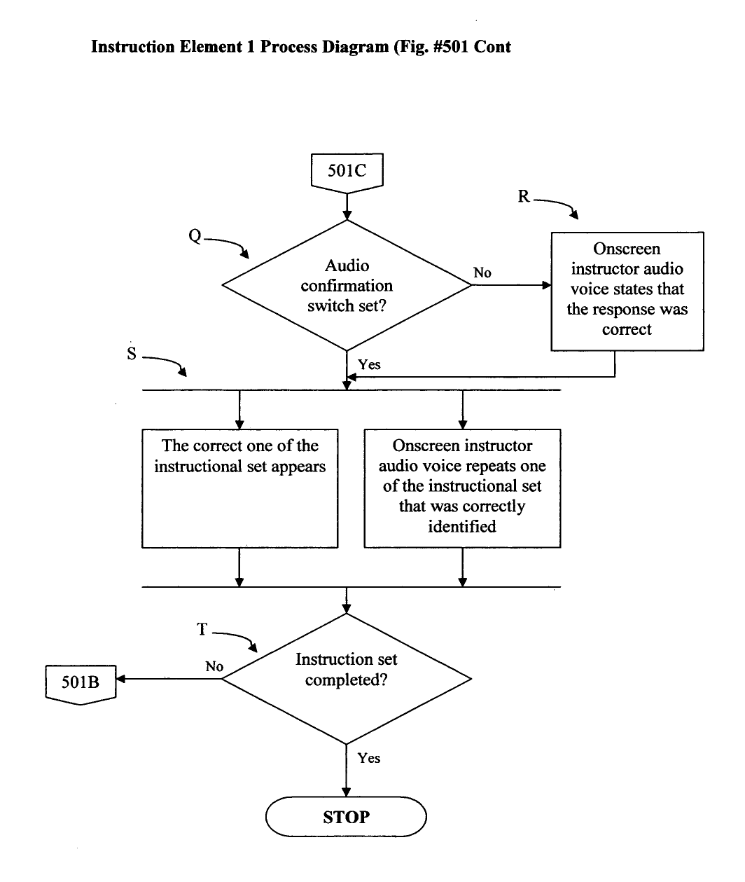

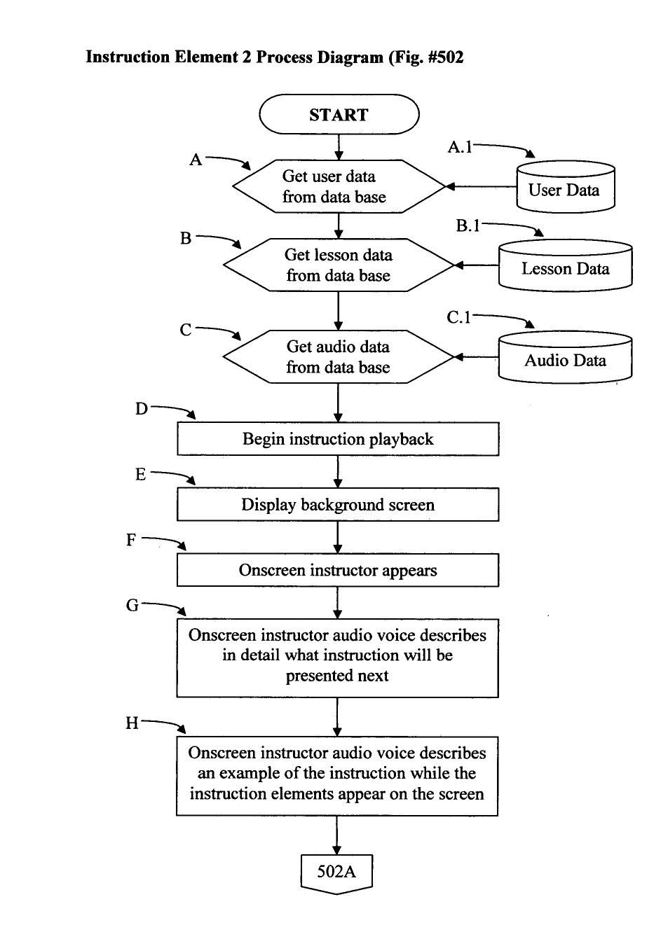

FIG. 241 is an illustration detailing the Instruction Control Process method used to define all of the Student Users that will be permitted to use the learning system for the Teacher or Parent that has accessed the learning system, as well as to define separate learning system control parameters for each Student User. The control parameters for each Student User consist of a learning system lesson number which is the next lesson that will execute when that particular Student User engages the learning system, a playback time in minutes setting that controls the duration of playback in one section of Instruction Module Process 5 (FIG. 405), a playback time in minutes setting that controls the duration of playback in a second section of Instruction Module Process 5, a playback speed setting that controls the playback speed in Instruction Module Process 5, a control switch setting that determines if the Onscreen Instructor Auditory Stimulus recites a confirmation after each correct Student User discrimination response while executing an instructional lesson. After entering Student User IDs subsequent recall of this Instruction Control Process method presents a list of all Student User IDs and other fields previously added. Each Teacher or Parent's settings may be changed or deleted. Further illustrated is an “Auto Logout” switch setting which if set will cause the learning system Instruction Main Process to terminate playback at the completion of a lesson in Step AM of FIG. 301. For each Student User a report access method is provided. (FIG. 271 and FIG. 281) Further, a “Run Lessons” button is illustrated which when depressed transfers processing to the Lesson Center (FIG. 291).

FIG. 251 is an illustration detailing the Instruction Control Process method used to add Student Users wherein groups of Student User instruction system ID's (names) and their corresponding lesson control settings may be set up all at one time. This method allows the Teacher or Parent to set up and configure large groups of Student Users with the least number of keystrokes possible providing for dramatically reduced set up time requirements of the learning system. Further, a “Run Lessons” button is illustrated which when depressed transfers processing to the Lesson Center (FIG. 291).

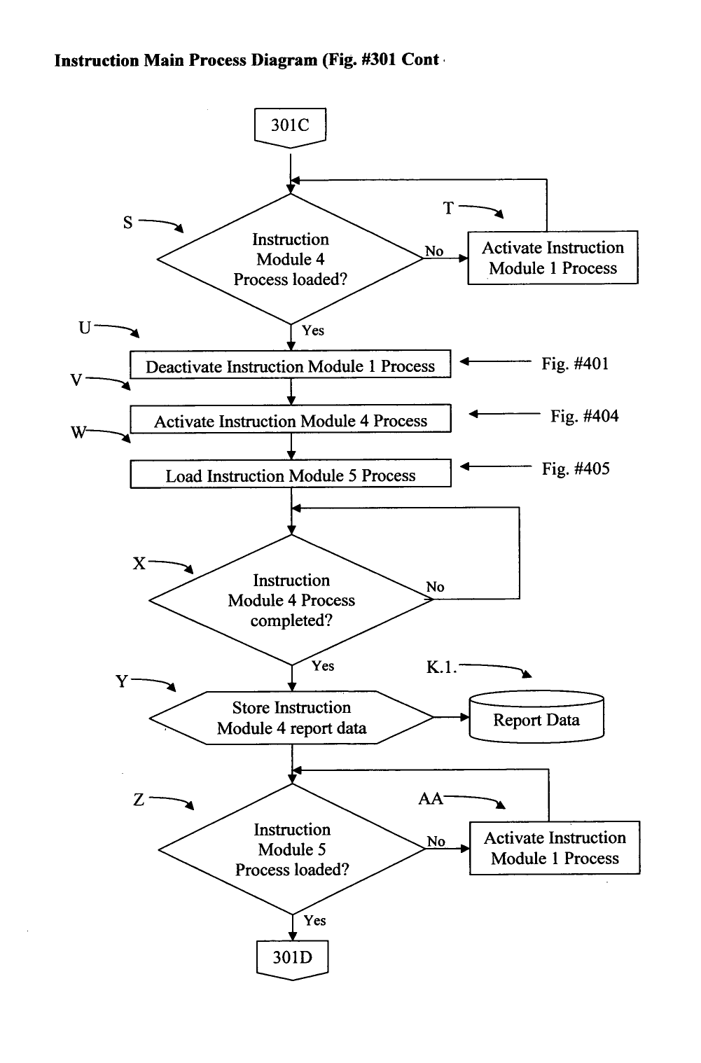

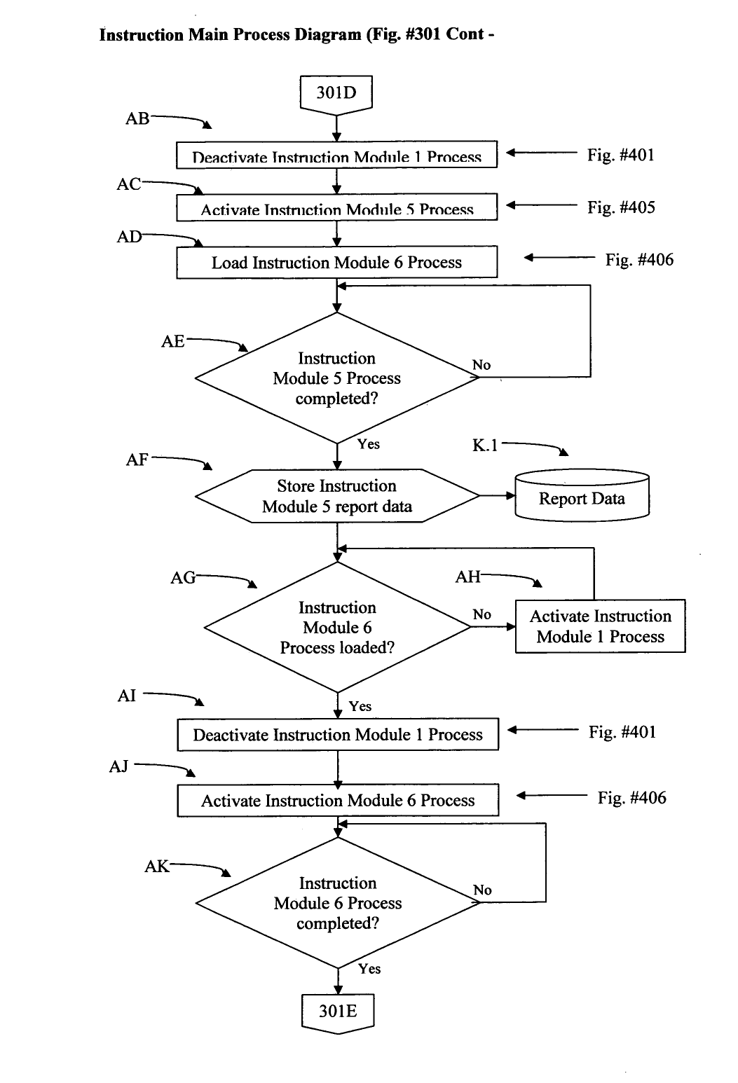

FIG. 261 is an illustration detailing the Instruction Control Process method used to modify Student Users wherein groups of Student User instruction system ID's (names) and their corresponding lesson control settings may be set up all at one time. This method allows the Teacher or Parent to modify the configuration of large groups of Student Users with the least number of keystrokes possible providing for dramatically reduced modification time requirements of the learning system. Further, a “Run Lessons” button is illustrated which when depressed transfers processing to the Lesson Center (FIG. 291).

FIG. 271 is an illustration detailing the Instruction Control Process method used to recall individual lesson report function wherein a Student Users' discrimination response results data may be recalled and viewed for any one single lesson completed at a prior time. The discrimination response historical results data were stored at the time of lesson completion on the computing system data storage device which is recalled, evaluated and calculated to produce data values representing; each instructional category description along with each category's total count of all of the correct discriminations made, a total count of all of the incorrect discriminations made, an itemized list of all Lesson Data Elements that correspond to each of the incorrect discriminations made, during execution of all Element Processes (FIGS. 501-510) that were executed while completing the prescribed instructional lesson which is then formatted for viewing.

FIG. 281 is an illustration detailing the Instruction Control Process method used to recall individual lesson cumulative results over time report function wherein a Student Users' discrimination response results data may be recalled and viewed for all lessons completed at a prior time. The discrimination response historical results data were stored at the time the lessons were completed on the computing system data storage device all of which are recalled, evaluated and calculated to produce data values representing; each instructional category description along with a total count of the number of times the category was presented to the Student User of which this count is used to calculate a percentage of the correct discriminations made for each category of instruction as well as comparative percentages for all Student Users assigned to the Teacher or Parent and a comparative percentage of all Student Users who have ever used the learning system, all of which is then formatted for viewing. Further, the corresponding Teacher or Parent ID, Student User ID, total number of completed lessons as well as the current date and time this report has been accessed, are as well all formatted for viewing. “Previous Student” and “Next Student” buttons are provided which when depressed will retrieve either the previous or next Student Users' discrimination response results data and re-executes the Instruction Control Process of this FIG. 281.

FIG. 291 is an illustration detailing the Instruction Control Process Lesson Center function wherein all Student User instructional system IDs for a Teacher or Parent's account are displayed on a single screen which each student uses to start their prescribed lesson. Each Student User locates the button with their Student User instructional system ID listed on it which is then pressed to start the lesson. A “Back To Setup” link is provided which when depressed exits the Lesson Center and transfers processing to FIG. 241. A “Logout” button is provided which when depressed exits the Lesson Center and the learning processing stops. This method provides the capability to pinpoint precise Student User mastery and/or deficiency. The Lesson Center is activated from the “Run Lessons” button. (FIGS. 241, 251 and 261)

FIG. 301 is a diagram that illustrates the Instruction Main Process wherein the Instruction Module Process (FIG. 401-406) are activated depending on the Instruction Main Process conditions as well as conditions found in the User Data defined in Step A and Lesson Data defined in Step B (Also FIG. 550). The Instruction Main Process which is activated by the Control Process “Run Lessons” feature of FIGS. 241, 251, 261 in the instruction system and is the main instructional process that activates and/or deactivates Instruction Module Processes (FIGS. 401 to 406) that in turn activate and/or deactivate Instruction Element Processes (FIGS. 501-510) to control the delivery of instruction during the execution of particular lesson number. Further, this process illustrates the distributed processing technique of the invention such that continuous and uninterrupted playback may continue regardless of the communication connection speed between the User's Computing Device and the Internet Highway (FIG. 101-18). Further, this process illustrates the modular instructional system of the invention such that the Instruction Processes (FIGS. 301, 401-406 & 501-510) may be dynamically utilized by the instructional Lesson Data (FIG. 550) contains control settings that are accessed by the Instruction Process.

In step A of FIG. 301, the User Data is retrieved from the data base so that the instruction process has the necessary information to deliver the correct lesson number and has the correct file reference information needed to properly record the lesson response data to the correct data base files for this user. User data (hereinafter referred to as “User Data”) includes a reference I.D. that identifies this system user and is unique among the data base of all system users (hereinafter referred to as “System User”), a set of multiple reference I.D.s that identifies the student users (hereinafter referred to as “Student User”) assigned to this system user which are individually unique among the data base of all student users assigned to this system user, a lesson number indicator for each of the student users which specifies the next lesson that the instruction process is to deliver to each individual student user upon next activation of the instruction process, an indicator settings for each of the student users which specifies the number of minutes of playback time and the playback speed accessed by and for instruction element 10 process, an indicator setting for each of the student users which specifies the audio confirmation on off switch setting status accessed by and for all instructional element processes.

A.1 specifies an electronic data storage device capable of recording and retaining digital information for subsequent retrieval which stores and maintains the User Data for this System User and all Student Users.

In Step B, the lesson data is retrieved from the data base so that the instruction process has the necessary information to deliver the correct instructional content for the prescribed lesson number specified for the Student User that has activated the instructional process. Lesson data (hereinafter referred to as “Lesson Data”) includes separately for each of the lessons; the lesson number, all instructional content that is displayed on the users' electronic viewing device being employed (hereinafter referred to as “Screen”), preset counters for each individual instructional element.

B.1 specifies an electronic data storage device capable of recording and retaining digital information for subsequent retrieval of the Lesson Data which stores and maintains the Lesson Data for all lessons in the instructional system which includes lesson number, all instructional content that is displayed on the Screen by all Instruction Element Processes as well as additional lesson control parameters that are accessed at various points by all Instruction Processes.

In Step C, Instruction Module 1 Process (FIG. 401) is loaded and also issued an activation command. Also, this step is performed so that as soon as the module is loaded playback will begin. Also, Instruction Module 1 Process (FIG. 401) remains in an idle state unless an activation command was issued. Further, this step is performed so that the Student User receives playback on the Screen as soon as possible.

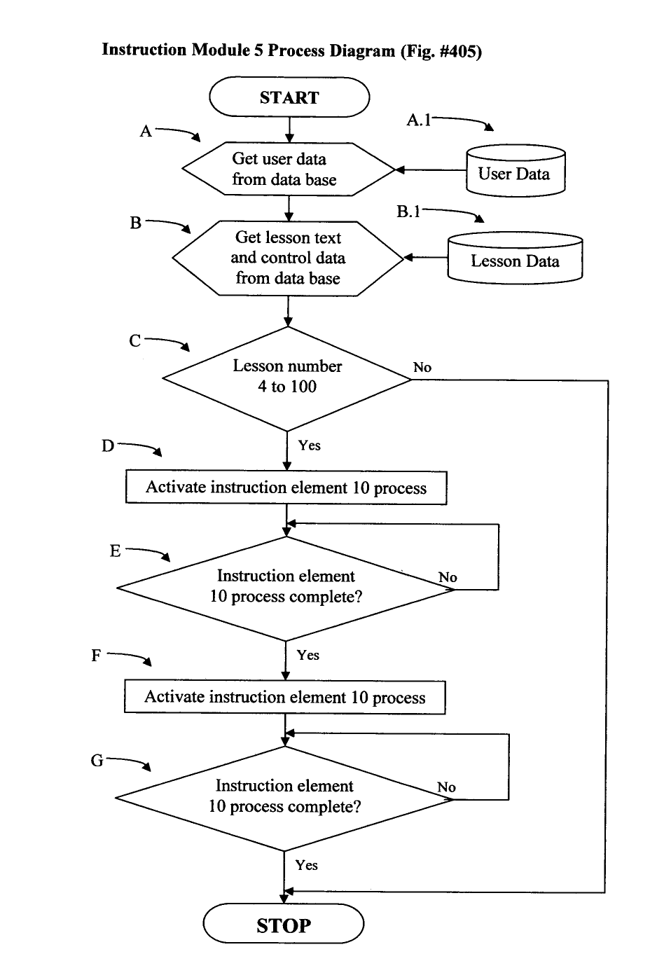

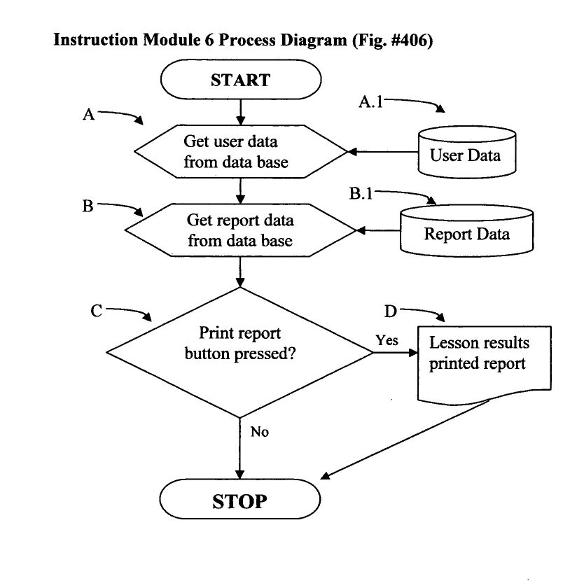

In Step D, Instruction Module 2 Process (FIG. 402) loading is initiated. This step is performed so that Instruction Module 2 Process is ready to begin playback when Instruction Module 1 Process (FIG. 401) playback has completed.

In Step E, an evaluation is made to determine if Instruction Module 2 Process (FIG. 402) is completely loaded and ready for playback. If not, processing transfers to Step F. If so, processing is transferred to Step G.

In Step F, processing is transferred back to Step E. This step is performed so that Step E is performed again.

In Step G, a deactivation command is sent to Instruction Module 1 Process (FIG. 401). This step is performed to stop the playback in preparation for Step H so that only one process playback is seen on the Screen at any one time.

In Step H, an activation command is issued to Instruction Module 2 Process (FIG. 402) so playback will begin.

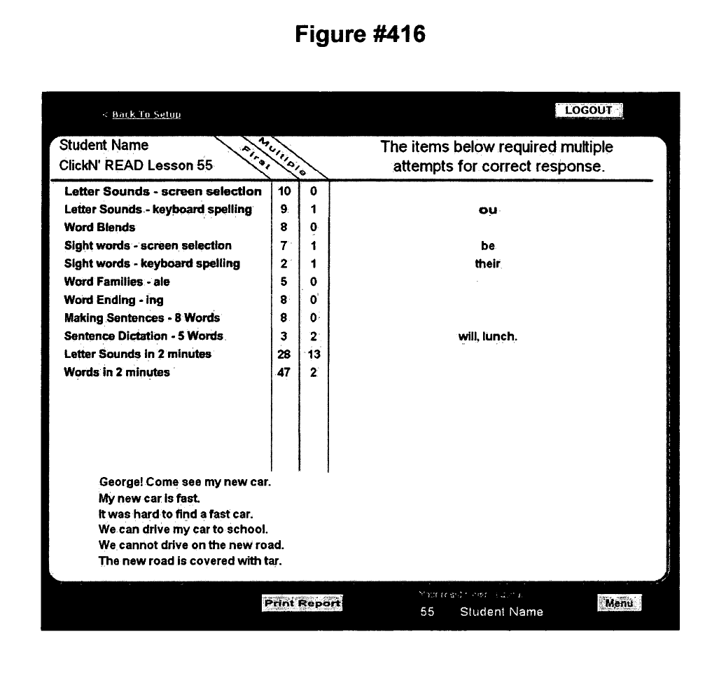

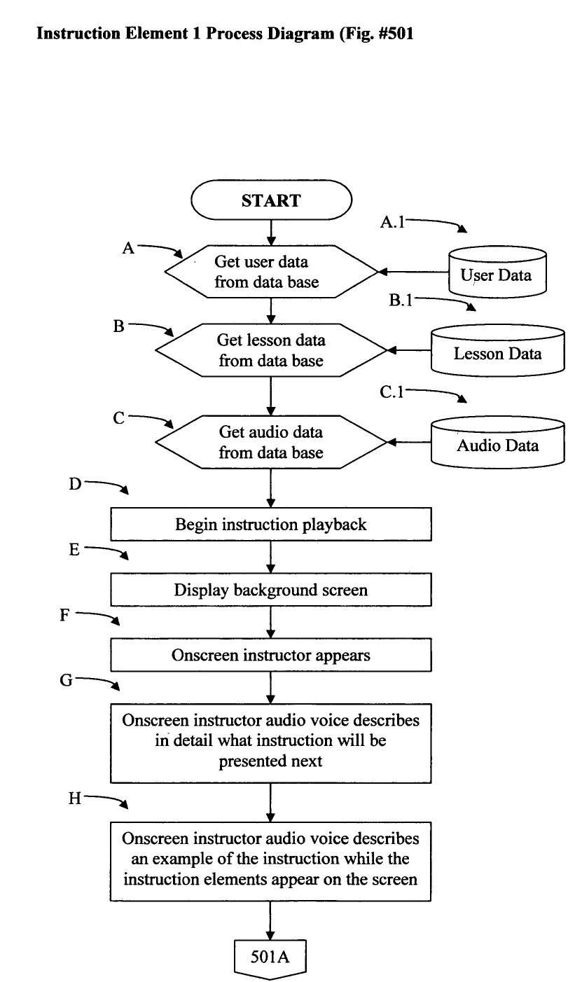

In Step I, Instruction Module 3 Process (FIG. 403) loading is initiated. This step is performed so that Instruction Module 3 Process is ready to begin playback when Instruction Module 2 Process (FIG. 402) playback has completed.

In Step J, an evaluation is made to determine if Instruction Module 2 Process (FIG. 402) playback has completed. If not, processing transfers to Step J. If so, processing is transferred to Step K.

In Step K, the Student User discrimination response data collected in Instruction Module 2 Process (FIG. 402) is recorded to the Report Data database.

In Step K.1 specifies an electronic data storage device capable of recording and retaining digital information for subsequent retrieval of the Report Data, (hereinafter referred to as “Report Data”) which includes lesson number, all Student User discrimination response data collected in all lessons as well as all Student User lesson control settings as they were set at the time the particular lesson was executed by the Student User.

In Step L, an evaluation is made to determine if Instruction Module 2 Process (FIG. 402) is completely loaded and ready for playback. If not, processing transfers to Step M. If so, processing is transferred to Step N.

In Step M, an activation command is issued to Instruction Module 1 Process (FIG. 401) to reactivate playback. This step is performed to ensure continuous and uninterrupted playback on the Student User's Screen while Instruction Module 3 Process (FIG. 403) loading completes. Processing transfers to Step L.

In Step N, is as previously described in Diagram 301, Step G.

In Step O, is as previously described in Diagram 301, Step H, except Instruction Module 3 Process (FIG. 403) is activated.

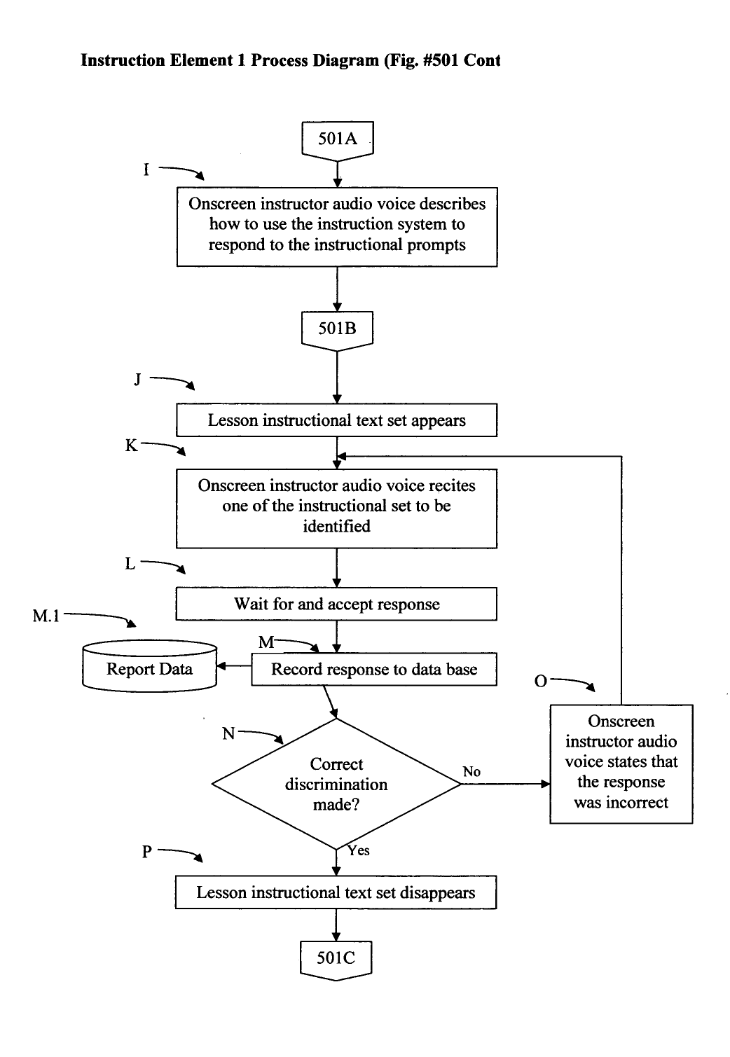

In Step P, is as previously described in Diagram 301, Step I except Instruction Module 4 Process (FIG. 404) is loaded.

In Step Q, an evaluation is made to determine if Instruction Module 3 Process (FIG. 403) playback has completed. If not, processing transfers to Step Q. If so, processing is transferred to Step R.

In Step R, is as previously described in Diagram 301, Step K except Instruction Module 3 Process (FIG. 403) response data is stored.

In Step S, an evaluation is made to determine if Instruction Module 4 Process (FIG. 404) is completely loaded and ready for playback. If not, processing transfers to Step T. If so, processing is transferred to Step U.

In Step T, an activation command is issued to Instruction Module 1 Process (FIG. 401) to reactivate playback. This step is performed to ensure continuous and uninterrupted playback on the Student User's Screen while Instruction Module 4 Process (FIG. 404) loading completes. Processing transfers to Step S.

In Step U, is as previously described in Diagram 301, Step G.

In Step V, is as previously described in Diagram 301, Step H, except Instruction Module 4 Process (FIG. 404) is activated.

In Step W, is as previously described in Diagram 301, Step I, except Instruction Module 5 Process (FIG. 405) is loaded.

In Step X, an evaluation is made to determine if Instruction Module 4 Process (FIG. 404) playback has completed. If not, processing transfers to Step X. If so, processing is transferred to Step Y.

In Step Y, is as previously described in Diagram 301, Step K except Instruction Module 4 Process (FIG. 404) response data is stored.

In Step Z, an evaluation is made to determine if Instruction Module 5 Process (FIG. 405) is completely loaded and ready for playback. If not, processing transfers to Step AA. If so, processing is transferred to Step AB.

In Step AA, an activation command is issued to Instruction Module 1 Process (FIG. 401) to reactivate playback. This step is performed to ensure continuous and uninterrupted playback on the Student User's Screen while Instruction Module 5 Process (FIG. 405) loading completes. Processing transfers to Step Z.

In Step AB, is as previously described in Diagram 301, Step G.

In Step AC, is as previously described in Diagram 301, Step H, except Instruction Module 5 Process (FIG. 405) is activated.

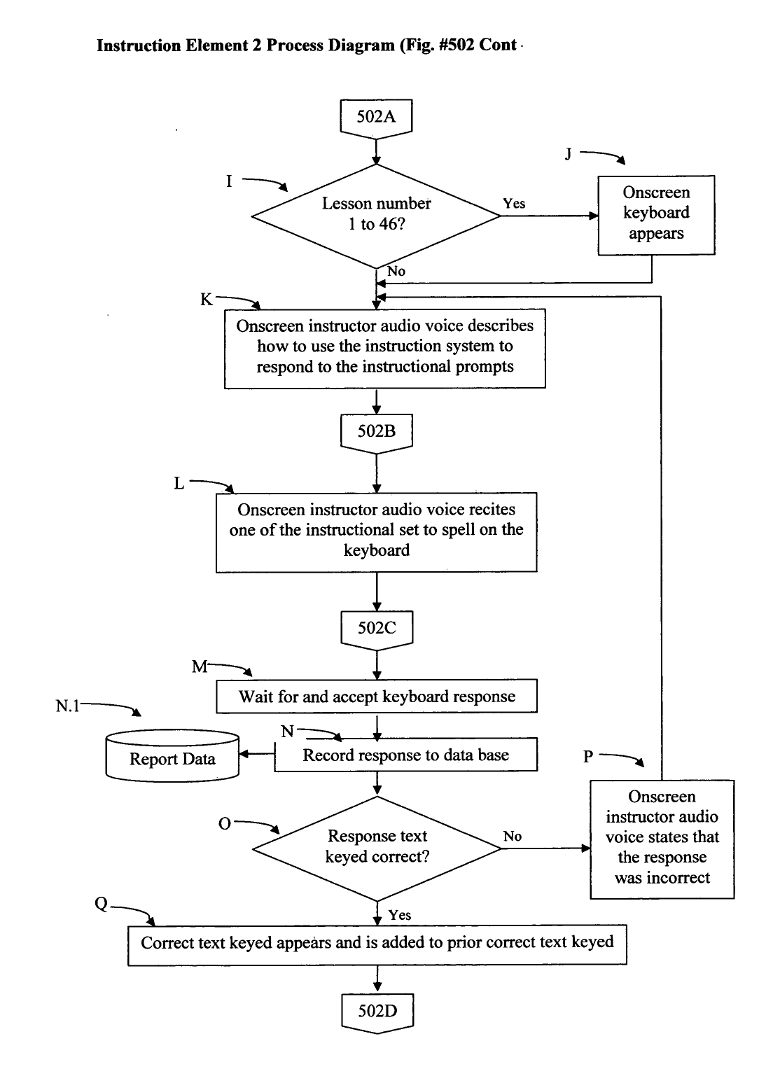

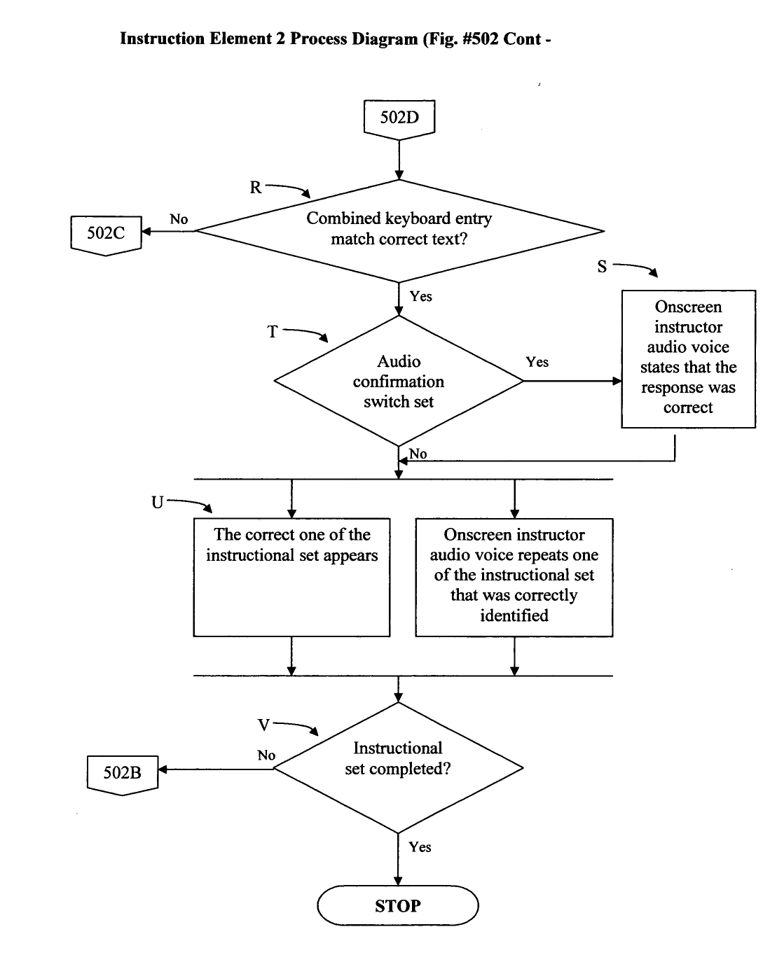

In Step AD, is as previously described in Diagram 301, Step I except Instruction Module 6 Process (FIG. 406) is loaded.

In Step AE, an evaluation is made to determine if Instruction Module 5 Process (FIG. 405) playback has completed. If not, processing transfers to Step AE. If so, processing is transferred to Step AF.

In Step AF, is as previously described in Diagram 301, Step K except Instruction Module 5 Process (FIG. 405) response data is stored.

In Step AG, an evaluation is made to determine if Instruction Module 6 Process (FIG. 406) is completely loaded and ready for playback. If not, processing transfers to Step AH. If so, processing is transferred to Step AI.

In Step AH, an activation command is issued to Instruction Module 1 Process (FIG. 401) to reactivate playback. This step is performed to ensure continuous and uninterrupted playback on the Student User's Screen while Instruction Module 6 Process (FIG. 406) loading completes. Processing transfers to Step AG.

In Step AI, is as previously described in Diagram 301, Step G.

In Step AJ, is as previously described in Diagram 301, Step H, except Instruction Module 6 Process (FIG. 406) is activated.

In Step AK, an evaluation is made to determine if Instruction Module 6 Process (FIG. 406) playback has completed. If not, processing transfers to Step AK. If so, processing is transferred to Step AL.

In Step AL, the end of the Instructional Process has been reached. Upon Instructional Process completion the User Data is updated to indicate that a particular one of the lessons in the set of lessons has been successfully completed by this Student User. The User Data updated includes the I.D. of the Student User who has completed the lesson, the lesson number that has been completed, the date and time that the lesson was executed and the next lesson to execute setting for this Student User is incremented by one.

In Step AM, an evaluation is made to determine if the Auto Logout Option Switch (FIG. 241) is set in the “on” position. If not, processing transfers to Process Connector 301A. If so, processing stops.

FIG. 401 is a diagram illustrating Instruction Module 1 Process which is activated by the Instruction Main Process (FIG. 301) at the start of its' processing and then again anytime a subsequent Instruction Module Process (FIG. 401-406) is not fully loaded and ready to begin playback. Instruction Module 1 Process contains a high resolution animated movie that appears on the Screen to provide a visually stimulating environment that engages the users' attention while the next instructional learning environment is being loaded. This module provides for near immediate visual presentation of the lesson process regardless of internet connection speeds while also serving as a “pre-loader” function should any subsequent instructional module not be fully loaded and ready to begin playback when the currently running instructional module completes. This module and its function allows for continuous and uninterrupted lesson playback regardless of internet connection speeds.

In step A, a high resolution animated image appears on the Screen to provide a visually stimulating environment that engages the Student Users' attention.

In Step B, loading of the Instructional Content for Instructional Module 1 Process begins.

In Step C, an evaluation is made to determine if Instruction Module 1 Process is completely loaded and ready for playback. This step is performed so that instruction playback may begin at the optimal time such that continuous and uninterrupted playback is maintained while at the same time not requiring the Student User to have to wait for all instruction content to load before playback begins. If not enough has loaded to begin playback, processing transfers to Step C. Otherwise processing proceeds to Step D.

In Step D, the instructional content playback begins.

In Step E, an evaluation is made to determine if an external command to deactivate playback has been received from the Instruction Main Process (FIG. 301). If a deactivation command has not been received processing transfers to Step D. Otherwise processing stops.

FIG. 402 is a diagram illustrating Instruction Module 2 Process which is activated by the Instruction Main Process (FIG. 301) at the appropriate time wherein the Instruction Element 1 Process (FIG. 501) and Instruction Element 2 Process (FIG. 502) are activated to process the instructional content prescribed in the Lesson Data for any given lesson. Instruction Module 2 Process acts as the instruction process execution control mechanism for the Instruction Element Processes activate by this module. This process execution control mechanism is required to maintain continuous and uninterrupted playback of the instructional content.

In step A, the User Data is retrieved from the data base so that the instruction process has the necessary information to deliver the correct lesson number and has the correct file reference information needed to properly record the Student User discrimination response data to the correct Report Data database files for the Student User that has activated the learning system. User data (hereinafter referred to as “User Data”) includes a reference I.D. that identifies this system user and is unique among the data base of all system users (hereinafter referred to as “System User”), a set of multiple reference I.D.s that identifies the Student Users (hereinafter referred to as “Student User”) assigned to this System User which are individually unique among the data base of all Student Users assigned to this system user, a lesson number indicator for each of the Student Users which specifies the next lesson that the instruction process is to deliver to each individual Student User upon next activation of the instruction process, an indicator settings for each of the Student Users Which specifies the number of minutes of playback time and the playback speed accessed by and for Instruction Element 10 Process (FIG. 510), an indicator setting for each of the Student Users which specifies the audio confirmation on/off switch setting status accessed by and for all Instructional Element Processes (FIG. 501-510).

A.1 specifies an electronic data storage device capable of recording and retaining digital information for subsequent retrieval which stores and maintains the User Data for this System User and all Student Users.

In Step B, the Lesson Data (FIG. 550) is retrieved from the data base so that the instruction process has the necessary information to deliver the correct instructional content for the prescribed lesson number specified for the Student User that has activated the instructional process. Lesson data (hereinafter referred to as “Lesson Data”) includes separately for each of the lessons; the lesson number, all instructional content that is displayed on the users' electronic viewing device being employed (hereinafter referred to as “Screen”), preset counters for each individual instructional element.

B.1 specifies an electronic data storage device capable of recording and retaining digital information for subsequent retrieval of the Lesson Data (FIG. 550) which stores and maintains the Lesson Data for all lessons in the instructional system which includes lesson number, all instructional content that is displayed on the Screen by all Instruction Element Processes as well as additional lesson control parameters that are accessed at various points by all Instruction Processes.

In Step C, an activation command is issued to Instruction Element 1 Process so playback will begin. (FIG. 510)

In Step D, an evaluation is made to determine if Instruction Element 1 Process (FIG. 501) playback has completed. If not, processing transfers to Step D. If so, processing is transferred to Step E. This step is performed so that this Instruction Module Process does not proceed to its next step until the Instruction Element Process currently active has completed playback.

In Step E, an activation command is issued to Instruction Element 2 Process so playback will begin. (FIG. 521)

In Step F, an evaluation is made to determine if Instruction Element 2 Process (FIG. 502) playback has completed. If not, processing transfers to Step F. If so, processing stops. This step is performed so that this Instruction Module Process does not proceed to its next step until the instruction element Process currently active has completed playback.

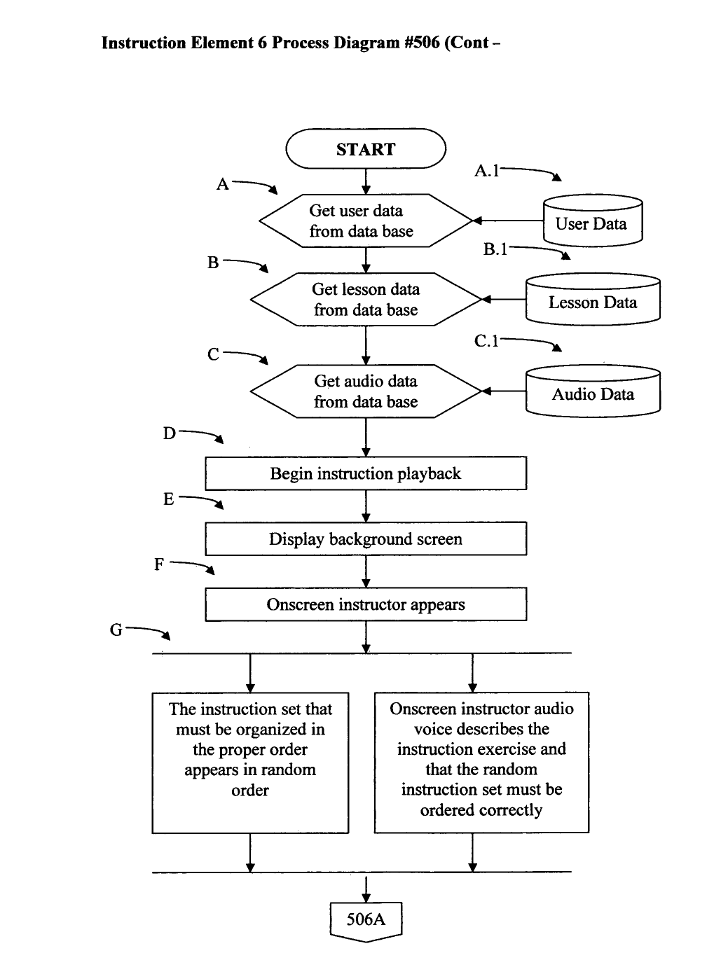

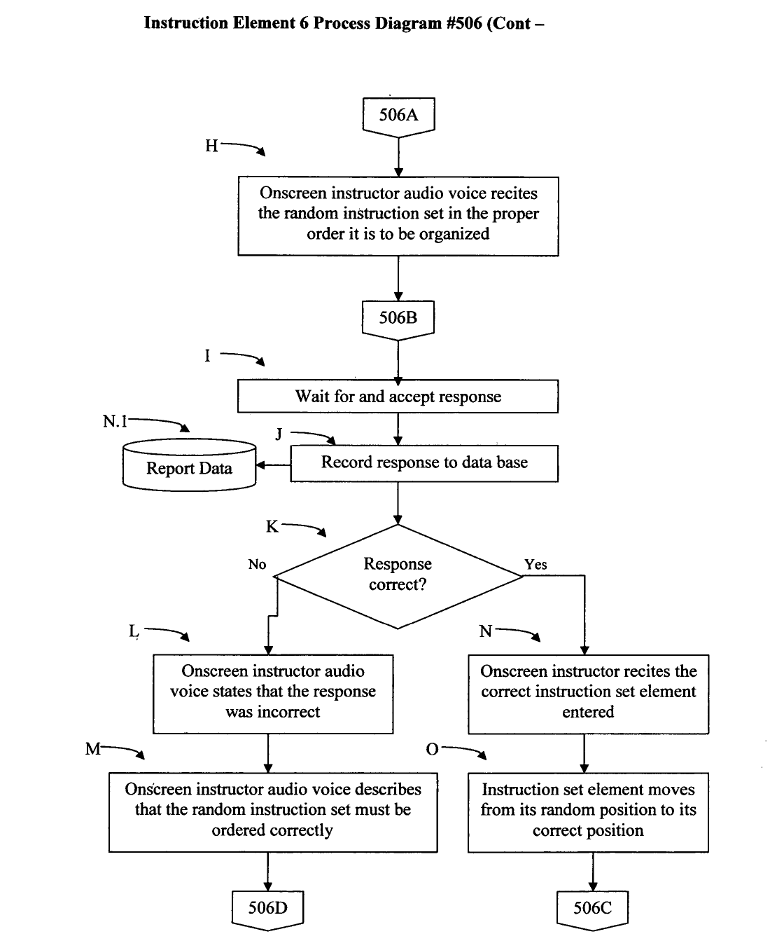

FIG. 403 is a diagram illustrating Instruction Module 3 Process which is activated by the Instruction Main Process (FIG. 201) at the appropriate time, wherein the Instruction Element 1 Process (FIG. 501) and Instruction Element 3 Process (FIG. 503) are activated to process the instructional content prescribed in the Lesson Data (FIG. 550) for any given lesson. Instruction Module 3 Process acts as the instruction process execution control mechanism for the Instruction Element Processes activate by this module. This process execution control mechanism is required to maintain continuous and uninterrupted playback of the instructional content.

In step A, the User Data is retrieved from the data base so that the instruction process has the necessary information to deliver the correct lesson number and has the correct file reference information needed to properly record the lesson response data to the correct data base files for this user. User data (hereinafter referred to as “User Data”) includes a reference I.D. that identifies this system user and is unique among the data base of all system users (hereinafter referred to as “System User”), a set of multiple reference I.D.s that identifies the Student Users (hereinafter referred to as “Student User”) assigned to this system user which are individually unique among the data base of all Student Users assigned to this system user, a lesson number indicator for each of the Student Users which specifies the next lesson that the instruction process is to deliver to each individual student user upon next activation of the instruction process, an indicator settings for each of the Student Users which specifies the number of minutes of playback time and the playback speed accessed by and for Instruction Element 10 Process (FIG. 510), an indicator setting for each of the Student Users which specifies the audio confirmation on off switch setting status accessed by and for all instructional element processes.

A.1 specifies an electronic data storage device capable of recording and retaining digital information for subsequent retrieval which stores and maintains the User Data for this System User and all Student Users.

In Step B, the Lesson Data (FIG. 550) is retrieved from the data base so that the instruction process has the necessary information to deliver the correct instructional content for the prescribed lesson number specified for the Student User that has activated the instructional process. Lesson data (hereinafter referred to as “Lesson Data”) includes separately for each of the lessons; the lesson number, all instructional content that is displayed on the users' electronic viewing device being employed (hereinafter referred to as “Screen”), preset counters for each individual instructional element.

B.1 specifies an electronic data storage device capable of recording and retaining digital information for subsequent retrieval of the Lesson Data (FIG. 550) which stores and maintains the Lesson Data for all lessons in the instructional system which includes lesson number, all instructional content that is displayed on the Screen by all Instruction Element Processes as well as additional lesson control parameters that are accessed at various points by all Instruction Processes.

In Step C, the User Data for the Student User retrieved in Step A, specifically the next lesson number setting is evaluated to determine if it is in the range of lessons 1 to 25. If it is in that range, processing proceeds to Step D. Otherwise, processing proceeds to Step F. This step is performed to allow the User Data and Lesson Data (FIG. 550) control settings to dynamically determine the Instruction Module Process steps that are executed.

In Step D, an activation command is issued to Element 1 Process so playback will begin. (FIG. 521)

In Step E, an evaluation is made to determine if Instruction Element 1 Process (FIG. 501) playback has completed. If not, processing transfers to Step E. If so, processing is transferred to Step F. This step is performed so that this Instruction Module Process does not proceed to its next step until the Instruction Element Process currently active has completed playback.

In Step F, an activation command is issued to Instruction Element 3 Process so playback will begin. (FIG. 513 & FIG. 523)

In Step G, an evaluation is made to determine if Instruction Element 3 Process (FIG. 503) playback has completed. If not, processing transfers to Step G. If so, processing stops.

FIG. 404 is a diagram illustrating Instruction Module 4 Process which is activated by the Instruction Main Process (FIG. 201) at the appropriate time, wherein the Instruction Element Processes 1, 2, and 4-9 (FIG. 501, 502, 504-509) are activated to process the instructional content prescribed in any given lesson. Instruction Module 4 Process acts as the instruction process execution control mechanism for the Instruction Element Processes activate by this module. This process execution control mechanism is required to maintain continuous and uninterrupted playback of the instructional content.

In step A, the User Data is retrieved from the data base so that the instruction process has the necessary information to deliver the correct lesson number and has the correct file reference information needed to properly record the lesson response data to the correct data base files for this user. User data (hereinafter referred to as “User Data”) includes a reference I.D. that identifies this system user and is unique among the data base of all system users (hereinafter referred to as “System User”), a set of multiple reference I.D.s that identifies the Student Users (hereinafter referred to as “Student User”) assigned to this system user which are individually unique among the data base of all Student Users assigned to this system user, a lesson number indicator for each of the Student Users which specifies the next lesson that the instruction process is to deliver to each individual student user upon next activation of the instruction process, an indicator settings for each of the Student Users which specifies the number of minutes of playback time and the playback speed accessed by and for instruction element 10 process, an indicator setting for each of the Student Users which specifies the audio confirmation on off switch setting status accessed by and for all instructional element processes.

A.1 specifies an electronic data storage device capable of recording and retaining digital information for subsequent retrieval which stores and maintains the User Data for this System User and all Student Users.

In Step B, the Lesson Data (FIG. 550) is retrieved from the data base so that the instruction process has the necessary information to deliver the correct instructional content for the prescribed lesson number specified for the Student User that has activated the instructional process. Lesson data (hereinafter referred to as “Lesson Data”) includes separately for each of the lessons; the lesson number, all instructional content that is displayed on the users' electronic viewing device being employed (hereinafter referred to as “Screen”), preset counters for each individual instructional element.

B.1 specifies an electronic data storage device capable of recording and retaining digital information for subsequent retrieval of the Lesson Data (FIG. 550) which stores and maintains the Lesson Data for all lessons in the instructional system which includes lesson number, all instructional content that is displayed on the Screen.

In Step C, the User Data for the Student User retrieved in Step A, specifically the next lesson number setting is evaluated to determine if it is in the range of lessons 11 to 100. If it is in that range, processing proceeds to Step D. Otherwise, processing proceeds to Step F. This step is performed to allow the User Data and Lesson Data (FIG. 550) control settings to dynamically determine the Instruction Module Process steps that are executed.

In Step D, an activation command is issued to Element 1 Process so playback will begin. (FIG. 531)

In Step E, an evaluation is made to determine if Instruction Element 1 Process (FIG. 501) playback has completed. If not, processing transfers to Step E. If so, processing is transferred to Step F. This step is performed so that this Instruction Module Process does not proceed to its next step until the Instruction Element Process currently active has completed playback.

In Step F, the User Data for the Student User retrieved in Step A, specifically the next lesson number setting is evaluated to determine if it is in the range of lessons 14 to 100. If it is in that range, processing proceeds to Step G. Otherwise, processing proceeds to Step I This step is performed to allow the User Data and Lesson Data (FIG. 550) control settings to dynamically determine the Instruction Module Process steps that are executed.

In Step G, an activation command is issued to Element 2 Process so playback will begin. (FIG. 512)

In Step H, an evaluation is made to complete if Instruction Element 2 Process (FIG. 502) playback has completed. If not, processing transfers to Step H. If so, processing is transferred to Step I. This step is performed so that this Instruction Module Process does not proceed to its next step until the Instruction Element Process currently active has completed playback.

In Step I, the User Data for the Student User retrieved in Step A, specifically the next lesson number setting is evaluated to determine if it is in the range of lessons 15 to 100. If it is in that range, processing proceeds to Step J. Otherwise, processing proceeds to Step L. This step is performed to allow the User Data and Lesson Data (FIG. 550) control settings to dynamically determine the Instruction Module Process steps that are executed.

In Step J, an activation command is issued to Element 4 Process so playback will begin. (FIG. 514 & FIG. 524)

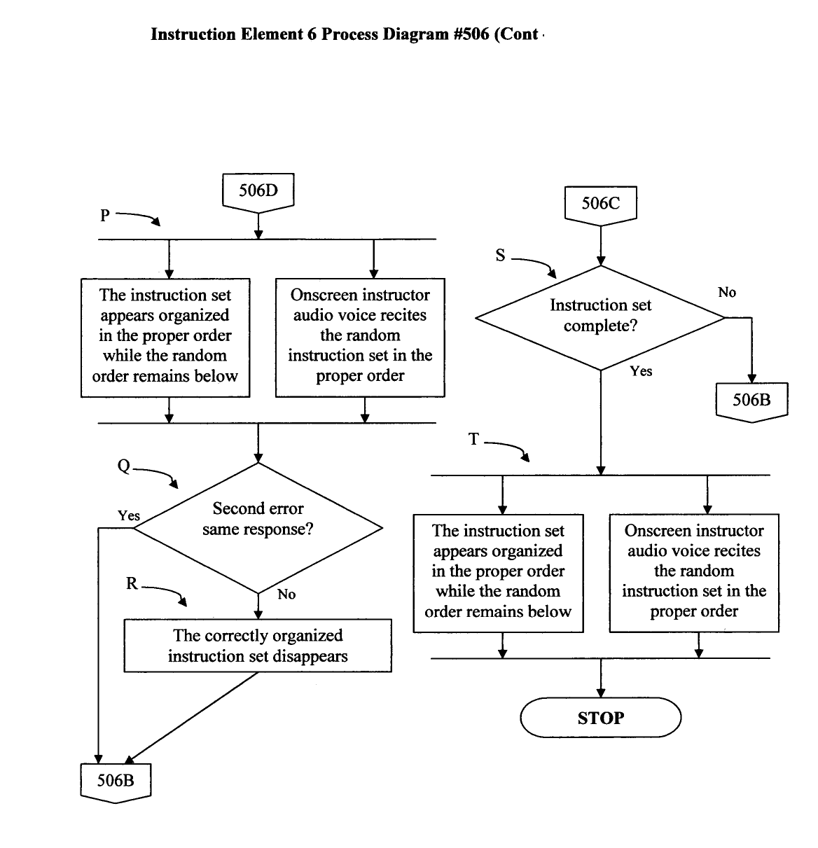

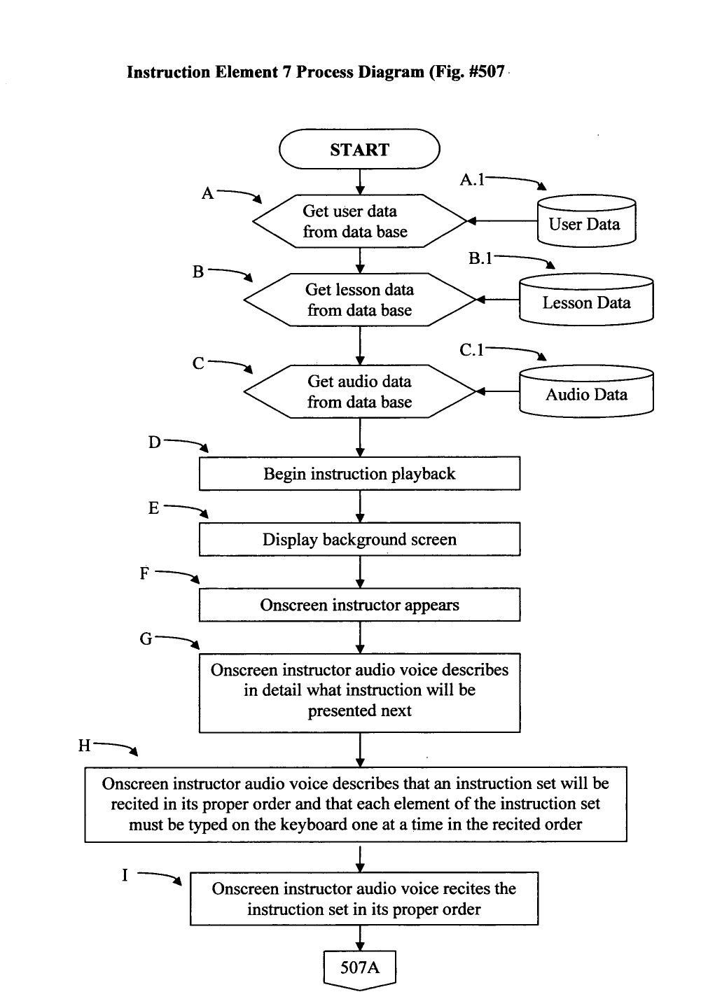

In Step K, an evaluation is made to determine if Instruction Element 4 Process playback (FIG. 504) has completed. If not, processing transfers to Step K. If so, processing is transferred to Step L. This step is performed so that this Instruction Module Process does not proceed to its next step until the Instruction Element Process currently active has completed playback.

In Step L, the User Data for the Student User retrieved in Step A, specifically the next lesson number setting is evaluated to determine if it is in the range of lessons 21 to 79. If it is in that range, processing proceeds to Step M. Otherwise, processing proceeds to Step O. This step is performed to allow the User Data and Lesson Data (FIG. 550) control settings to dynamically determine the Instruction Module Process steps that are executed.

In Step M, an activation command is issued to Element 4 Process so playback will begin. (FIG. 524 & FIG. 544)

In Step N, an evaluation is made to determine if Instruction Element 4 Process (FIG. 504) playback has completed. If not, processing transfers to Step N. If so, processing is transferred to Step O. This step is performed so that this Instruction Module Process does not proceed to its next step until the Instruction Element Process currently active has completed playback.

In Step O, the User Data for the Student User retrieved in Step A, specifically the next lesson number setting is evaluated to determine if it is in the range of lessons 47 to 59. If it is in that range, processing proceeds to Step P. Otherwise, processing proceeds to Step T. This step is performed to allow the User Data and Lesson Data (FIG. 550) control settings to dynamically determine the Instruction Module Process steps that are executed.

In Step P, an activation command is issued to Element 5 Process so playback will begin. (FIG. 515)

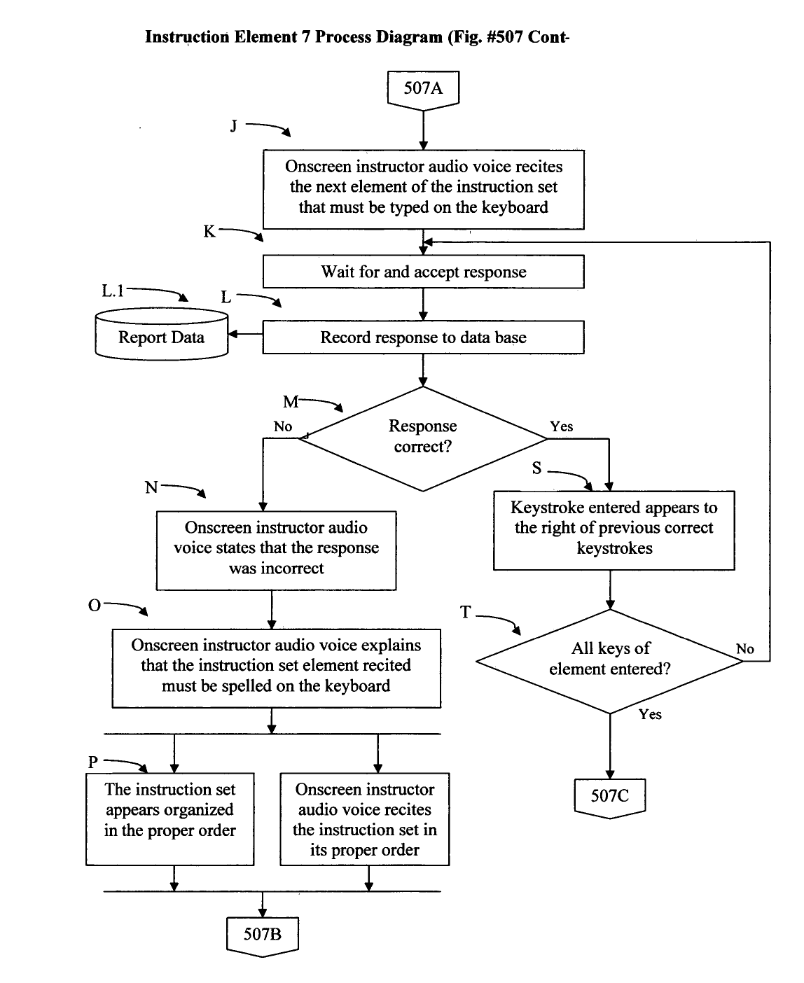

In Step Q, an evaluation is made to determine if Instruction Element 6 Process (FIG. 506) playback has completed. If not, processing transfers to Step Q. If so, processing is transferred to Step R. This step is performed so that this Instruction Module Process does not proceed to its next step until the Instruction Element Process currently active has completed playback.

In Step R, an activation command is issued to Element 2 Process so playback will begin.

In Step S, an evaluation is made to determine if Instruction Element 2 Process (FIG. 502) playback has completed. If not, processing transfers to Step S. If so, processing is transferred to Step T. This step is performed so that this Instruction Module Process does not proceed to its next step until the Instruction Element Process currently active has completed playback.

In Step T, the User Data for the Student User retrieved in Step A, specifically the next lesson number setting is evaluated to determine if it is in the range of lessons 50 to 100. If it is in that range, processing proceeds to Step U. Otherwise, processing proceeds to Step W. This step is performed to allow the User Data and Lesson Data (FIG. 550) control settings to dynamically determine the Instruction Module Process steps that are executed.

In Step U, an activation command is issued to Element 6 Process so playback will begin. (FIG. 516 & FIG. 526)

In Step V, an evaluation is made to determine if Instruction Element 6 Process (FIG. 506) playback has completed. If not, processing transfers to Step V. If so, processing is transferred to Step W. This step is performed so that this Instruction Module Process does not proceed to its next step until the Instruction Element Process currently active has completed playback.

In Step W, the User Data for the Student User retrieved in Step A, specifically the next lesson number setting is evaluated to determine if it is in the range of lessons 55 to 100. If it is in that range, processing proceeds to Step X. Otherwise, processing proceeds to Step Z. This step is performed to allow the User Data and Lesson Data (FIG. 550) control settings to dynamically determine the Instruction Module Process steps that are executed.

In Step X, an activation command is issued to Element 7 Process so playback will begin. (FIG. 517)

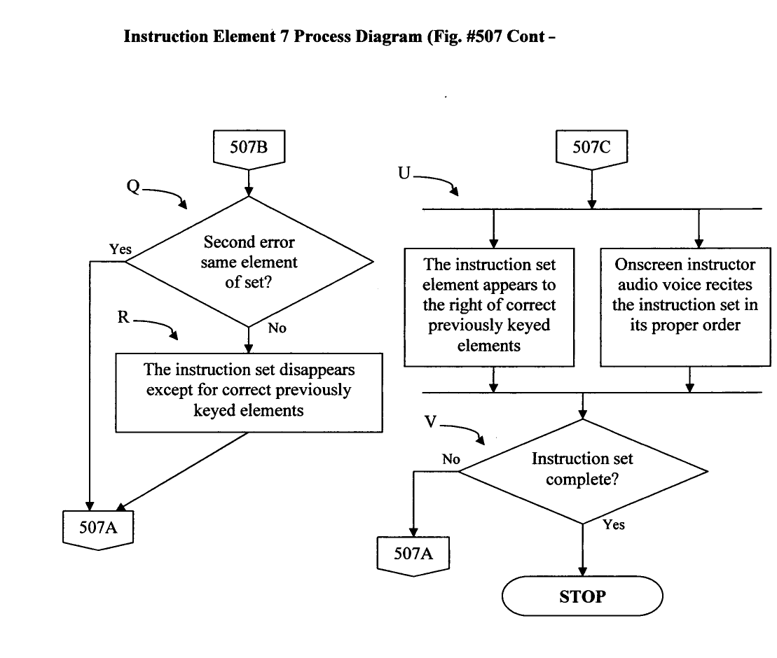

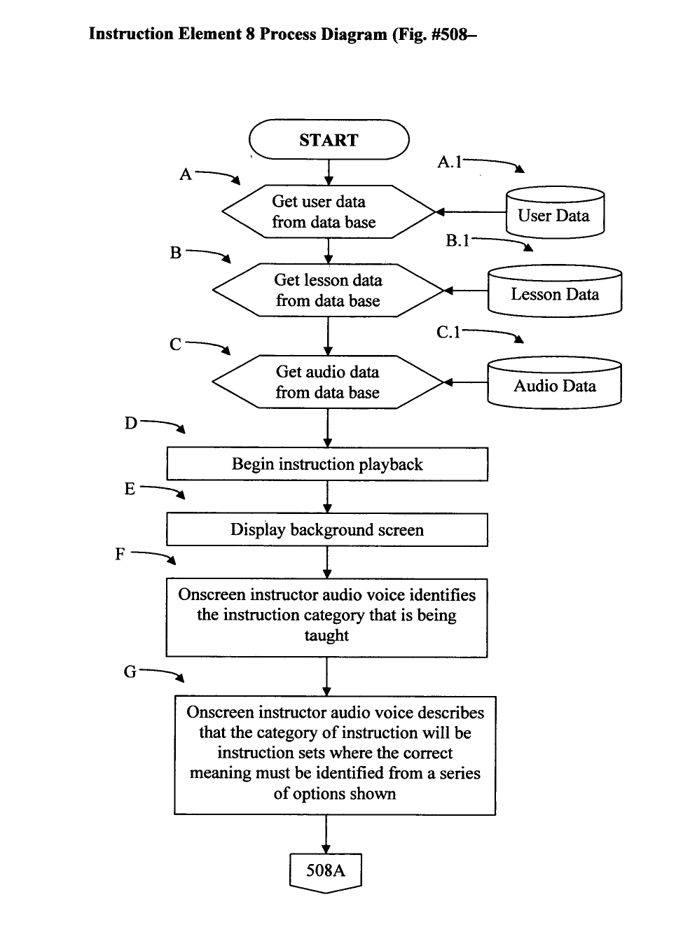

In Step Y, an evaluation is made to determine if Instruction Element 7 Process (FIG. 507) playback has completed. If not, processing transfers to Step Y. If so, processing is transferred to Step Z. This step is performed so that this Instruction Module Process does not proceed to its next step until the Instruction Element Process currently active has completed playback.

In Step Z, the User Data for the Student User retrieved in Step A, specifically the next lesson number setting is evaluated to determine if it is in the range of lessons 80 to 87. If it is in that range, processing proceeds to Step AA. Otherwise, processing proceeds to Step AC. This step is performed to allow the User Data and Lesson Data (FIG. 550) control settings to dynamically determine the Instruction Module Process steps that are executed.

In Step M, an activation command is issued to Element 8 Process so playback will begin. (FIG. 518 & FIG. 528)

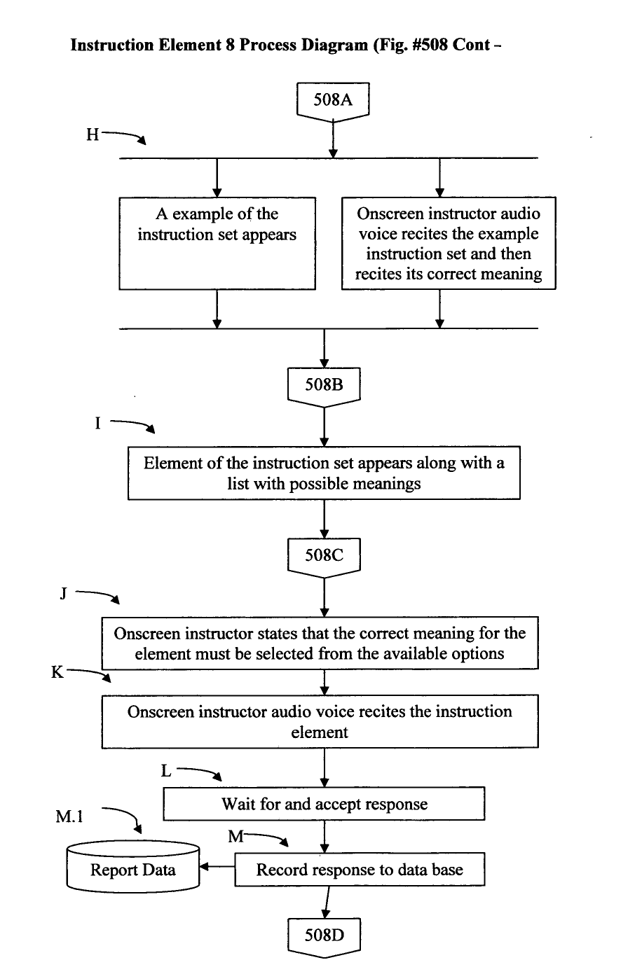

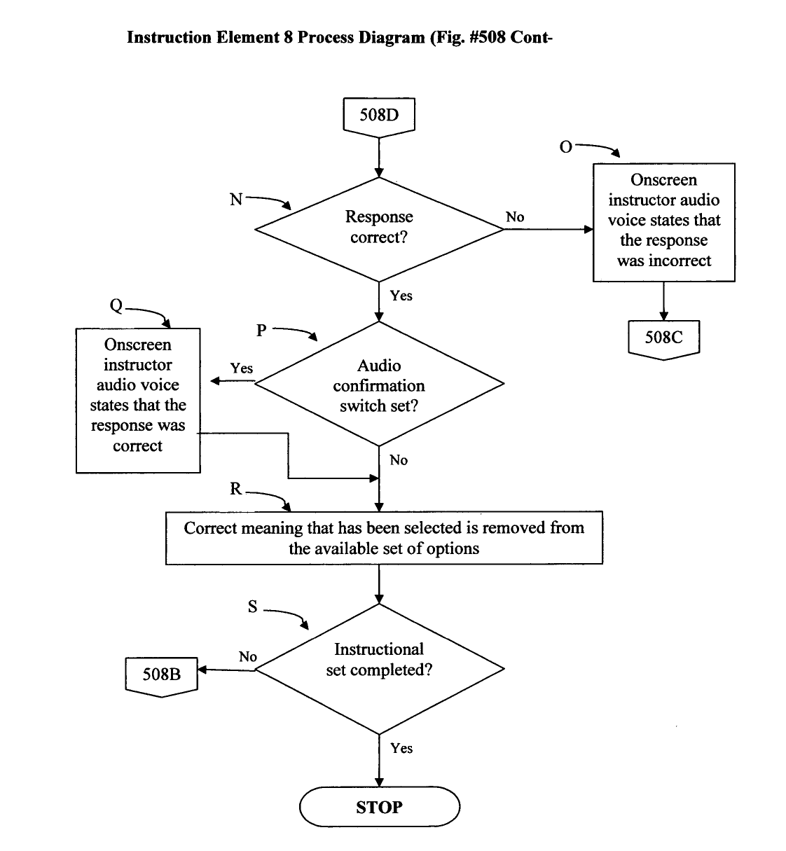

In Step AB, an evaluation is made to determine if Instruction Element 8 Process (FIG. 508) playback has completed. If not, processing transfers to Step AB. If so, processing is transferred to Step AC. This step is performed so that this Instruction Module Process does not proceed to its next step until the Instruction Element Process currently active has completed playback.

In Step AC, the User Data for the Student User retrieved in Step A, specifically the next lesson number setting is evaluated to determine if it is in the range of lessons 88 to 96. If it is in that range, processing proceeds to Step AD. Otherwise, processing proceeds to Step AF. This step is performed to allow the User Data and Lesson Data (FIG. 550) control settings to dynamically determine the Instruction Module Process steps that are executed.

In Step AD, an activation command is issued to Element 8 Process so playback will begin. (FIG. 538 & FIG. 548)

In Step AE, an evaluation is made to determine if Instruction Element 8 Process (FIG. 508) playback has completed. If not, processing transfers to Step AE. If so, processing is transferred to Step AF. This step is performed so that this Instruction Module Process does not proceed to its next step until the Instruction Element Process currently active has completed playback.

In Step AF, the User Data for the Student User retrieved in Step A, specifically the next lesson number setting is evaluated to determine if it is in the range of lessons 3 to 100. If it is in that range, processing proceeds to Step AG. Otherwise, processing stops. This step is performed to allow the User Data and Lesson Data (FIG. 550) control settings to dynamically determine the Instruction Module Process steps that are executed.

In Step AG, an activation command is issued to Element 9 Process so playback will begin. (FIG. 519)

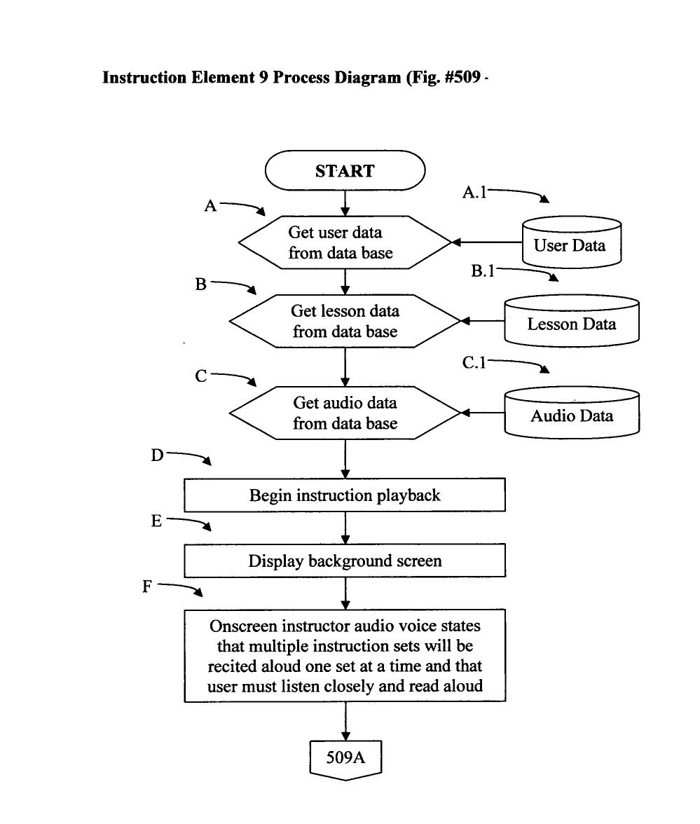

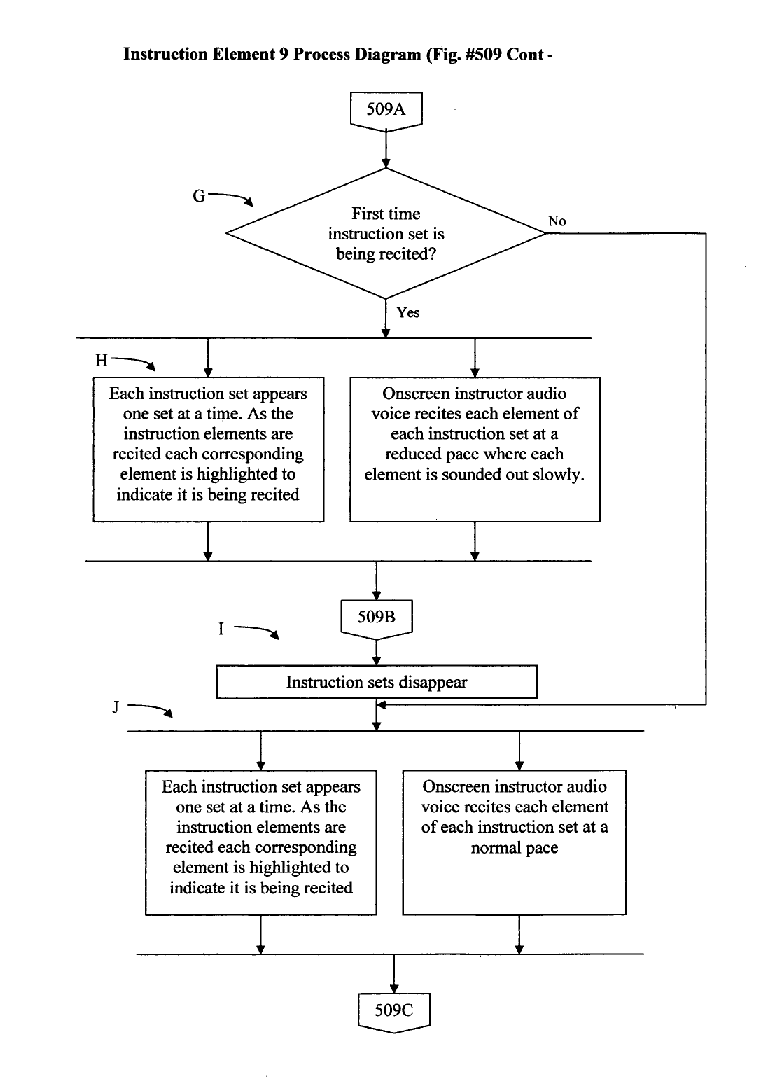

In Step AH, an evaluation is made to determine if Instruction Element 9 Process (FIG. 509) playback has completed. If not, processing transfers to Step AH. If so, processing stops. This step is performed so that this Instruction Module Process does not proceed to its next step until the Instruction Element Process currently active has completed playback.

FIG. 405 is a diagram illustrating Instruction Module 5 Process which is activated by the Instruction Main Process (FIG. 201) at the appropriate time wherein the Instruction Element 10 Process (FIG. 510) is activated to process the instructional content prescribed in any given lesson. Instruction Module 5 Process acts as the instruction process execution control mechanism for the Instruction Element Processes activate by this module. This process execution control mechanism is required to maintain continuous and uninterrupted playback of the instructional content.

In step A, the User Data is retrieved from the data base so that the instruction process has the necessary information to deliver the correct lesson number and has the correct file reference information needed to properly record the lesson response data to the correct data base files for this user. User data (hereinafter referred to as “User Data”) includes a reference I.D. that identifies this system user and is unique among the data base of all system users (hereinafter referred to as “System User”), a set of multiple reference I.D.s that identifies the Student Users (hereinafter referred to as “Student User”) assigned to this system user which are individually unique among the data base of all Student Users assigned to this system user, a lesson number indicator for each of the Student Users which specifies the next lesson that the instruction process is to deliver to each individual student user upon next activation of the instruction process, an indicator settings for each of the Student Users which specifies the number of minutes of playback time and the playback speed accessed by and for instruction element 10 process, an indicator setting for each of the Student Users which specifies the audio confirmation on off switch setting status accessed by and for all instructional element processes.

A.1 specifies an electronic data storage device capable of recording and retaining digital information for subsequent retrieval which stores and maintains the User Data for this System User and all Student Users.

In Step B, the Lesson Data (FIG. 550) is retrieved from the data base so that the instruction process has the necessary information to deliver the correct instructional content for the prescribed lesson number specified for the Student User that has activated the instructional process. Lesson data (hereinafter referred to as “Lesson Data”) includes separately for each of the lessons; the lesson number, all instructional content that is displayed on the users' electronic viewing device being employed (hereinafter referred to as “Screen”), preset counters for each individual instructional element.

B.1 specifies an electronic data storage device capable of recording and retaining digital information for subsequent retrieval of the Lesson Data (FIG. 550) which stores and maintains the Lesson Data for all lessons in the instructional system which includes lesson number, all instructional content that is displayed on the Screen by the computing device.

In Step C, the User Data for the Student User retrieved in Step A, specifically the next lesson number setting is evaluated to determine if it is in the range of lessons 4 to 100. If it is in that range, processing proceeds to Step D. Otherwise, processing stops. This step is performed to allow the User Data and Lesson Data (FIG. 550) control settings to dynamically determine the Instruction Module Process steps that are executed.

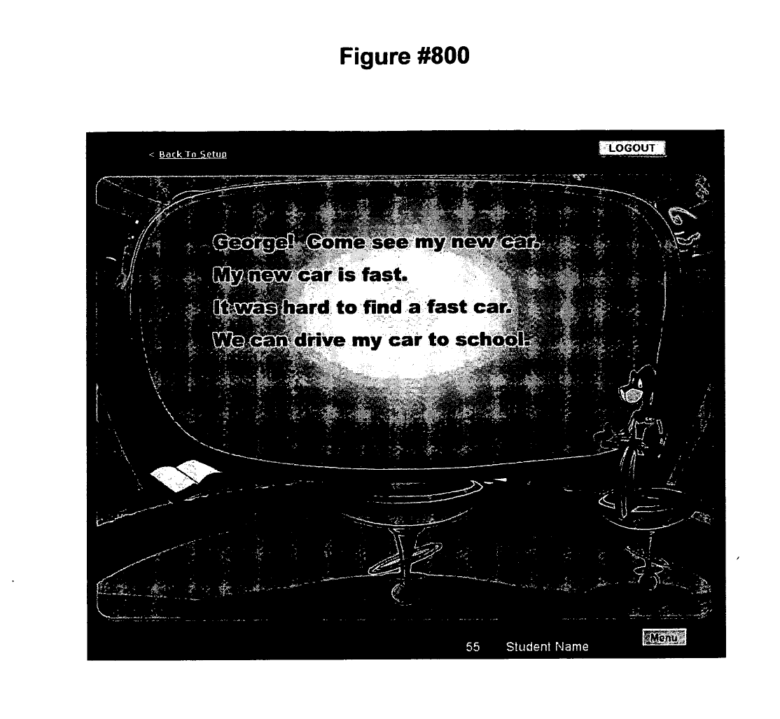

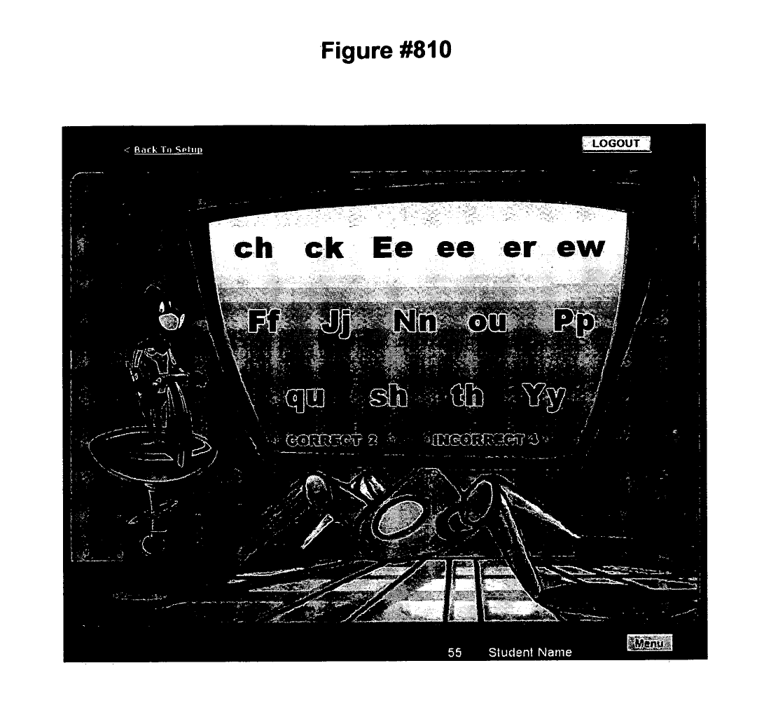

In Step D, an activation command is issued to Element 10 Process so playback will begin. (FIG. 810)

In Step E, an evaluation is made to determine if Instruction Element 10 Process (FIG. 510) playback has completed. If not, processing transfers to Step E. If so, processing is transferred to Step F. This step is performed so that this Instruction Module Process does not proceed to its next step until the Instruction Element Process currently active has completed playback.

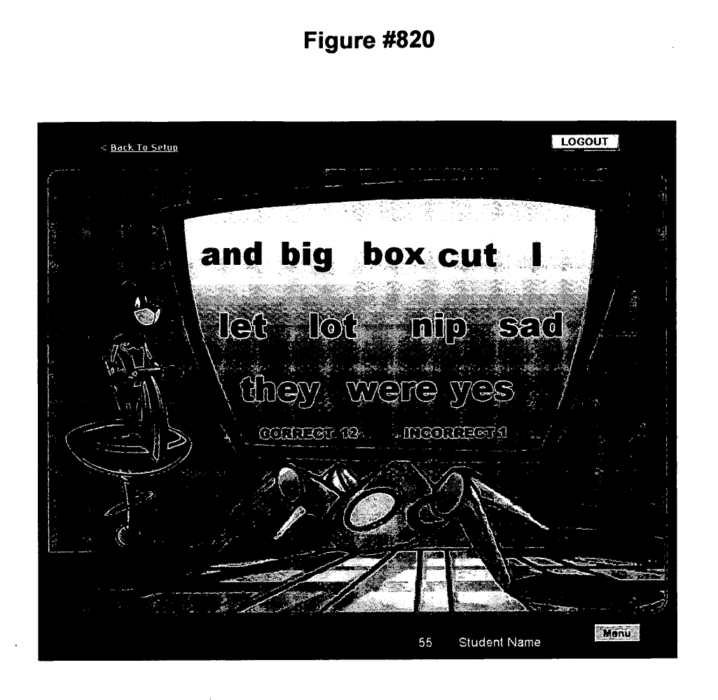

In Step F, an activation command is issued to Element 10 Process so playback will begin. (FIG. 820)

In Step G, an evaluation is made to determine if Instruction Element 10 Process (FIG. 510) playback has completed. If not, processing transfers to Step G. If so, processing stops. This step is performed so that this Instruction Module Process does not proceed to its next step until the Instruction Element Process currently active has completed playback.

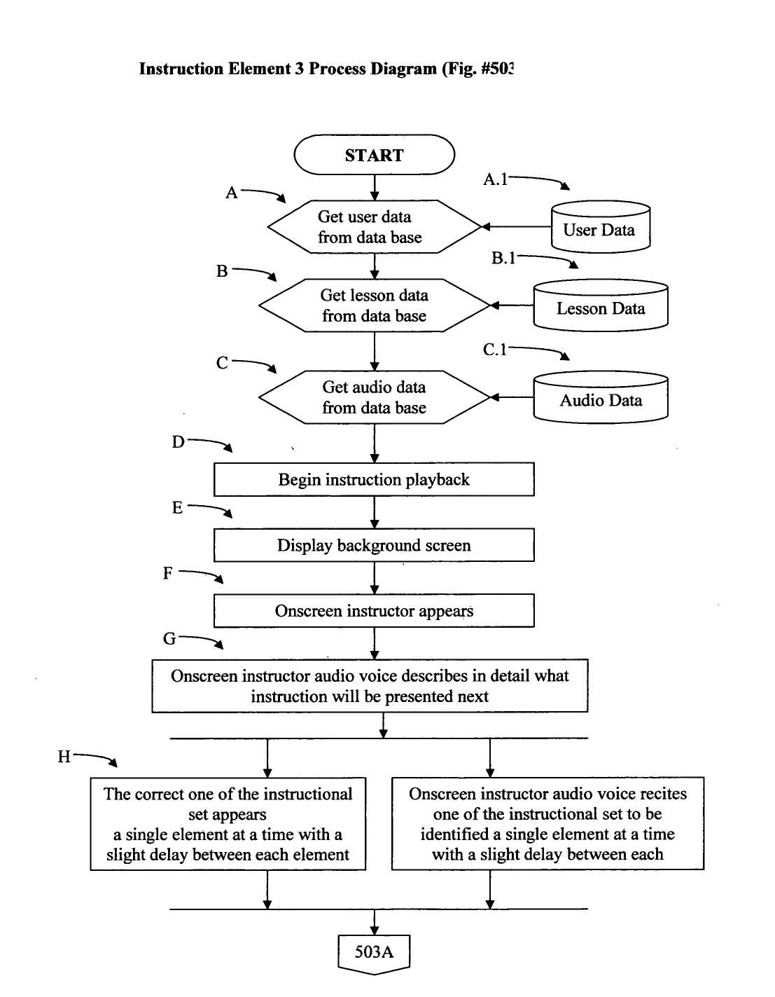

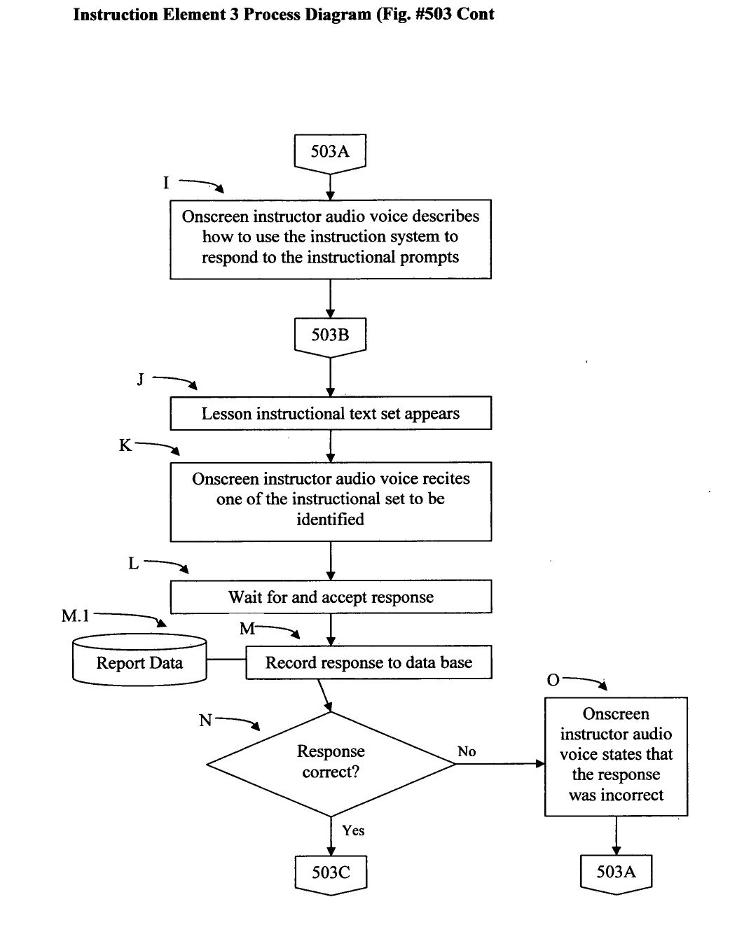

FIG. 406 is a diagram illustrating Instruction Module 6 Process which is activated at the end of the instruction system by the Instruction Main Process (FIG. 301) for each lesson executed wherein the Student User discrimination response data accumulated in the Report Data database is recalled and displayed on the Screen for Student User lesson performance analysis. Instruction Module 6 Process retrieves all recorded student discrimination responses for the lesson that was just executed by the student and then evaluates and calculates the data to produce data values representing; a total count of all of the correct discriminations made, a total count of all of the incorrect discriminations made, an itemized list of all Lesson Data (FIG. 550) Elements that correspond to each of the incorrect discriminations made, during all areas of the lesson the student just completed and this combined data is formatted and displayed on the computer screen (FIG. 416) where after a print report button is provided, which if depressed, transmits the formatted report to the computing System Printing device.

In step A, the User Data is retrieved from the data base so that the instruction process has the necessary information to deliver the correct lesson number and has the correct file reference information needed to properly record the lesson response data to the correct data base files for this user. User data (hereinafter referred to as “User Data”) includes a reference I.D. that identifies this system user and is unique among the data base of all system users (hereinafter referred to as “System User”), a set of multiple reference I.D.s that identifies the Student Users (hereinafter referred to as “Student User”) assigned to this system user which are individually unique among the data base of all Student Users assigned to this system user, a lesson number indicator for each of the Student Users which specifies the next lesson that the instruction process is to deliver to each individual student user upon next activation of the instruction process, an indicator settings for each of the Student Users which specifies the number of minutes of playback time and the playback speed accessed by and for instruction element 10 process, an indicator setting for each of the Student Users which specifies the audio confirmation on off switch setting status accessed by and for all instructional element processes.

A.1 specifies an electronic data storage device capable of recording and retaining digital information for subsequent retrieval which stores and maintains the User Data for this System User and all Student Users.

In Step B, the Report Data is retrieved from the database so that the Instruction Process has the necessary information to deliver the correct Student User discrimination response recorded data for the lesson number currently being processed needed to properly provide an accurate lesson performance report both on the computing system Screen and printing devices.

B.1 specifies an electronic data storage device capable of recording and retaining digital information for subsequent retrieval of the Report Data, (hereinafter referred to as “Report Data”) which includes lesson number, all Student User discrimination response data collected in all lessons as well as all Student User lesson control settings as they were set at the time the particular lesson was executed by the Student User.

In Step C, an evaluation is made to determine if the Student User has depressed the “print report” button that appears on the Screen. If so, processing transfers to Step D. Otherwise processing stops.

In Step D, The Report Data retrieved in Step B, is evaluated and calculated to produce data values representing; a total count of all of the correct discriminations made, a total count of all of the incorrect discriminations made, an itemized list of all Lesson Data (FIG. 550) Elements that correspond to each of the incorrect discriminations made, during execution of all Element Processes that were executed while completing the prescribed instructional lesson and this combined data is formatted and transmitted to the computing System Printing device. (FIG. 416) At completion of this step, processing stops.

FIG. 501 is a diagram illustrating Instruction Element 1 Process wherein Instruction Element 1 Processing is performed based on conditions found in the User Data and Lesson Data (FIG. 550), and is activated by either Instruction Module 2 Process (FIG. 402), Instruction Module 3 Process (FIG. 403) or Instruction Module 4 Process (FIG. 403) depending on the instruction criteria prescribed for a particular lesson number.

In step A, the User Data is retrieved from the data base so that the instruction process has the necessary information to deliver the correct lesson number and has the correct file reference information needed to properly record the lesson response data to the correct data base files for this user. User data (hereinafter referred to as “User Data”) includes a reference I.D. that identifies this system user and is unique among the data base of all system users (hereinafter referred to as ‘System User’), a set of multiple reference I.D.s that identifies the student users (hereinafter referred to as “Student User”) assigned to this system user which are individually unique among the data base of all student users assigned to this system user, a lesson number indicator for each of the student users which specifies the next lesson that the instruction process is to deliver to each individual student user upon next activation of the instruction process, an indicator settings for each of the student users which specifies the number of minutes of playback time and the playback speed accessed by and for instruction element 10 process, an indicator setting for each of the student users which specifies the audio confirmation on off switch (FIG. 241) setting status accessed by and for all instructional element processes.

A.1 specifies an electronic data storage device capable of recording and retaining digital information for subsequent retrieval which stores and maintains the User Data for this System User and all Student Users.

In Step B, the Lesson Data (FIG. 550) is retrieved from the data base so that the instruction process has the necessary information to deliver the correct instructional content for the prescribed lesson number specified for the Student User that has activated the instructional process. Lesson data (hereinafter referred to as “Lesson Data”) includes separately for each of the lessons; the lesson number, all instructional content that is displayed on the users' electronic viewing device being employed (hereinafter referred to as “Screen”), preset counters for each individual instructional element.

B.1 specifies an electronic data storage device capable of recording and retaining digital information for subsequent retrieval of the Lesson Data (FIG. 550).

In Step C, the audio data is retrieved from the data base so that the instruction process has the necessary information to deliver the correct audio content for the prescribed lesson number specified for the Student User that has activated the instructional process. Audio data (hereinafter referred to as “Audio Data”) includes separately for each of the 100 lessons, the lesson number, all prerecorded audio content that is recited by the onscreen instructor, and heard by the users' electronic audio listening device being employed.

C.1 specifies an electronic data storage device capable of recording and retaining prerecorded digital audio information for subsequent retrieval of the Audio Data.

In Step D, instruction playback begins. This step is required as all Instruction Element Processes once loaded into the user system remain in an idle state until they are activated by an associated Instruction Module Process. This mechanism is employed as part of the overall Instructional System Process design such that continuous and uninterrupted instruction process playback may be maintained by employment of Distributed Processing (See Distributed Processing definition contained in the Instruction Main Process).

In Step E, a high resolution animated image appears on the Screen to provide a visually stimulating environment that engages the users' attention.

In Step F, a high resolution animated image of an onscreen instructor (hereinafter referred to as “Instructor”) appears to provide a visually stimulating simulation of an actual instructor that engages the users' attention and provides for visual identification of who is reciting the auditory stimuli.

In Step G, Instructor auditory stimuli describes what instruction will be presented to the Student User during the Instruction Element 1 Process. The specific auditory stimulus for any given lesson that activates Instruction Element 1 Process is dictated by the Lesson Data (FIG. 550) and Audio Data for each respective lesson. This step is performed to “lead” the Student User by identifying the category of instruction such that the Student User is properly prepared to receive and understand the discriminative stimuli presented in subsequent Step H wherein a specific example of the category of instruction is modeled.

In Step H, Instructor auditory stimuli describes an example of the specific type of instruction that will follow. This step is performed to “model” for the Student User a specific sample of the instruction such that the Student User is properly prepared to receive and understand the discriminative stimuli presented in subsequent Steps wherein multiple instruction sets are displayed on the Screen, with instructor recitation and subsequent Student User response to discriminative stimuli. Step H takes the Student User through the stimulus and response sequence as a simulation example that is easily emulated.

In Step I, Instructor auditory stimuli describes how to use the electronic computing system devices to respond to the instructional prompts. This step is performed both as a reminder and indicator to the Student User that the instruction process is now transitioning from the Lead and Model lesson introductory steps to the Test instructional process where Student User responses will be required and as a specific statement of the manner in which to respond to Instructional Element 1 Process in particular, the latter of which is specified by the lesson and audio data base content for any one particular lesson.

In Step J, the instructional text set appears on the Screen. In Instruction Element 1 Process the multiple instruction sets that are presented across the lessons are unique from all other Instruction Element Processes in that they are a set wherein each element of the set is separate from all other elements of the set, their only relationship to one another is that they all belong to a certain category of subject skill being taught.

In Step K, the Instructor auditory stimuli recites the auditory representation of one of the instruction set elements presented in step J. The specific instruction set elements recited is specified and controlled by the contents of the Lesson Data (FIG. 550) and Audio Data prescribed for the given lesson that is activated by this Instruction Element 1 Process.

In Step L, the instruction process stops and waits for and is reactivated by a Student User response generated by the use of the computing system device to select one of the instruction set elements displayed on the Screen.

In Step M, the response generated in Step L is recorded to the Report Data database wherein the data record contains the System and Student User I.D.'s as well as the lesson number and instructional set element number with which the particular response is associated. The response data is recorded in this fashion such that it may be retrieved at a later date to reconstruct an accurate representation of the Student User responses that occurred in Instruction Element 1 Process.

In Step M.1, specifies an electronic data storage device capable of recording and retaining digital information for subsequent retrieval of the Report Data, (hereinafter referred to as “Report Data”) which includes lesson number, all Student User discrimination response data collected in all lessons as well as all Student User lesson control settings as they were set at the time the particular lesson was executed by the Student User.

In Step N, the response received in Step L is compared to Lesson Data (FIG. 550) as specified with a given lesson that has activated Instruction Element 1 Process to determine if a correct discrimination has been made by the Student User. Throughout the entire instructional process Student Users must at all times provide correct discriminatory responses to advance in the instructional process and at no time during the process are the correct responses disclosed to the Student User. Correct discrimination responses are handled by Step P and incorrect discrimination responses are handled by Step O. This instructional system requirement of absolute discrimination ensures an errorless learning environment, mastery of skill acquisition and integrity of the accuracy of performance reporting.

In Step O, the incorrect discrimination response is processed in the following manner: First, the Instructor auditory stimulus immediately informs the Student User that the response was incorrect and that the Student User must re-attempt to provide accurate discrimination. Thus, if immediate feedback is provided skill acquisition adoption rates dramatically raise. The process then jumps back to Step K for continuation of the instruction process.

In Step P, the instruction set displayed on the Screen is removed. This step is performed to prepare the Screen for Step S wherein the correct discrimination is redisplayed separate from the full instruction set.

In Step Q, the audio confirmation switch setting (FIG. 241), for the Student User activating the lesson instructional system, which was retrieved from the User Data in Step A, is tested to determine if it is the “on” position. The audio confirmation option is provided to utilize the fact that scientific research has proven that if immediate feedback is provided skill acquisition adoption rates dramatically raise, in a manner that accommodates Student Users that require additional positive reinforcement while at the same time not overburdening Student Users who adequately advance without it. The audio confirmation “on” state is processed by Step R and the “off” state is processed by Step S.

In Step R, Instructor auditory stimuli recites that the correct discrimination was made. Instruction Element 1 Process proceeds to Step S.

In Step S, simultaneously the instruction set element correctly discriminated by the Student User in Step L appears on the Screen and the Instructor auditory stimuli recites the corresponding audible representation of the instruction set element. This step is performed not only to provide a visual auditory cue to the Student User that a correct discrimination was made, should the audio confirmation switch (FIG. 241) be set in the “off” state, but to provide an additional instructional stimulus and response for the same instruction set element to further reinforce skill acquisition as well as skill retention. It is a fact that scientific research has shown that multi-sensory feedback that re-illustrates a newly acquired skill results in accelerated skill mastery.

In Step T, determine if the instruction set is complete. Based on the information retrieved from the Lesson Data (FIG. 550), in Step B, Instruction Element 1 Process determines if the prescribed number of times each element of the instruction set is to be presented to the Student User for correct discrimination, for the given lesson that was activated by the Student User, has been completed. If the instruction set has been completed, processing stops. Otherwise, processing returns to Step J.

FIG. 502 is a diagram illustrating Instruction Element 2 Process wherein the Instruction Element 2 Process is performed based on conditions found in the User data and Lesson Data (FIG. 550) database and is activated by either Instruction Module 2 Process (FIG. 402), or Instruction Module 4 Process (FIG. 402) depending on the instruction criteria prescribed for a particular lesson number.

In step A, is as previously described in Diagram 501, Step A.

A.1 is as previously described in Diagram 501, A.1.

In Step B, is as previously described in Diagram 501, Step B.

B.1 is as previously described in Diagram 501, B.1.

In Step C, is as previously described in Diagram 501, Step C.

C.1 is as previously described in Diagram 501, C.1.

In Step D, is as previously described in Diagram 501, Step D.

In Step E, is as previously described in Diagram 501, Step E.

In Step F, is as previously described in Diagram 501, Step F.

In Step G, is as previously described in Diagram 501, Step G.

In Step H, is as previously described in Diagram 501, Step H.

In Step I, the User Data for the Student User retrieved in Step A, specifically the next lesson number setting is evaluated to determine if it is in the range of lessons 1 to 46. If it is in that range, processing proceeds to Step J. Otherwise, processing proceeds to Step K. This step is performed such that a graphic virtual simulation of a computer keyboard only appears for the first 46 lessons wherein after the Student User is expected to demonstrate the keyboard typing skills acquired during lessons 1 to 46 by keying correct discriminations on the actual computer system keyboard without the extra support of the virtual keyboard.

In Step J, the graphic virtual simulation of a computer keyboard appears on the screen which the Student User may employ for keying correct discrimination which operates by clicking on the simulated keyboard keys. Processing proceeds to Step K.

In Step K, is as previously described in Diagram 501, Step I.

In Step L, the Instructor auditory stimuli recites the auditory representation of one of the instruction set elements that the Student User is required to spell on the keyboard. The specific instruction set elements recited is specified and controlled by the contents of the Lesson Data (FIG. 550) and Audio Data prescribed for the given lesson that is activated this Instruction Element 2 Process.

In Step M, is as previously described in Diagram 501, Step L.

In Step N, is as previously described in Diagram 501, Step M.

In Step O, is as previously described in Diagram 501, Step N, except that correct discrimination responses are handled by Step Q and incorrect discrimination responses are handled by Step P.

In Step P, is as previously described in Diagram 501, Step O.

In Step Q, the correctly discriminated response for each keyboard key depression appears on the screen and is added to the prior correctly discriminated responses. This step is performed not only to provide a visual auditory cue to the Student User that a correct discrimination was made, but to provide an additional instructional stimulus and response for the same instruction set element to further reinforce skill acquisition as well as skill retention. It is a fact that scientific research has shown that multi-sensory feedback that re-illustrates a newly acquired skill results in accelerated skill mastery.

In Step R, all prior keyboard keystrokes, from the current instruction set element previously recited in Step L, are combined with the current keystroke and compared to Lesson Data (FIG. 550) as specified with a given lesson that has activated Instruction Element 2 Process to determine if the combined keystrokes match the correct current instruction set element which is evidence that a correct discrimination has been made by the Student User.

In Step S, is as previously described in Diagram 501, Step R.

In Step T, is as previously described in Diagram 501, Step Q.

In Step U, is as previously described in Diagram 501, Step S.

In Step V, is as previously described in Diagram 501, Step T.

FIG. 503 is a diagram illustrating Instruction Element 3 Process wherein the Instruction Element 3 Process is performed based on conditions found in the User Data and Lesson Data (FIG. 550) and is activated by Instruction Module 3 Process (FIG. 403) depending on the instruction criteria prescribed for a particular lesson number.

In step A, is as previously described in Diagram 501, Step A.

A.1 is as previously described in Diagram 501, A.1.

In Step B, is as previously described in Diagram 501, Step B.

B.1 is as previously described in Diagram 501, B.1.

In Step C, is as previously described in Diagram 501, Step C.

C.1 is as previously described in Diagram 501, C.1.

In Step D, is as previously described in Diagram 501, Step D.

In Step E, is as previously described in Diagram 501, Step E.

In Step F, is as previously described in Diagram 501, Step F.

In Step G, is as previously described in Diagram 501, Step G.

In Step H, the correct one of the instructional set appears on the Screen a single element at a time which then scrolls from left to right across the screen with a slight delay between each individual element such that the correct one of the whole instructional set is now in place together on the Screen after all individual elements have appeared and scrolled into place. Simultaneously, from the blended rapidly sequenced individually recited elements followed by a subsequent recitation of correct instructional set as a whole, as it sounds in its regular form. This step is performed to “model” for the Student User a specific sample of the instruction such that the Student User is properly prepared to receive and understand the discriminative stimuli presented in subsequent Steps wherein multiple instruction sets are displayed on the Screen, with instructor recitation and subsequent Student User response to discriminative stimuli. Step H takes the Student User through the stimulus and response sequence as a simulation example that is easily emulated.

In Step I, is as previously described in Diagram 501, Step I.

In Step J, is as previously described in Diagram 501, Step J.

In Step K, is as previously described in Diagram 501, Step K.

In Step L, is as previously described in Diagram 501, Step L.

In Step M, is as previously described in Diagram 501, Step M.

In Step N, is as previously described in Diagram 501, Step N.

In Step O, is as previously described in Diagram 501, Step O.

In Step P, is as previously described in Diagram 501, Step P.

In Step Q, is as previously described in Diagram 501, Step Q.

In Step R, is as previously described in Diagram 501, Step R.

In Step S, the correct one of the instructional set appears on the Screen a single element at a time which then scrolls from left to right across the screen with a slight delay between each individual element such that the correct one of the whole instructional set is now in place together on the Screen after all individual elements have appeared and scrolled into place. Simultaneously, from the blended rapidly sequenced individually recited elements followed by a subsequent recitation of correct instructional set as a whole, as it sounds in its regular form. This step is performed not only to provide a visual auditory cue to the Student User that a correct discrimination was made, should the audio confirmation switch (FIG. 241) be set in the “off” state, but to provide an additional instructional stimulus and response for the same instruction set element to further reinforce skill acquisition as well as skill retention. It is a fact that scientific research has shown that multi-sensory feedback that re-illustrates a newly acquired skill results in accelerated skill mastery.

In Step T, is as previously described in Diagram 501, Step T.

FIG. 504 is a diagram illustrating Instruction Element 4 Process wherein the Instruction Element 4 Process is performed based on conditions found in the User Data and Lesson Data (FIG. 550) and is activated by Instruction Module 4 Process (FIG. 404) depending on the instruction criteria prescribed for a particular lesson number.

In step A, is as previously described in Diagram 501, Step A.

A.1 is as previously described in Diagram 501, A.1.

In Step B, is as previously described in Diagram 501, Step B.

B.1 is as previously described in Diagram 501, B.1.

In Step C, is as previously described in Diagram 501, Step C.

C.1 is as previously described in Diagram 501, C.1.

In Step D, is as previously described in Diagram 501, Step D.

In Step E, is as previously described in Diagram 501, Step E.

In Step F, is as previously described in Diagram 501, Step F.

In Step G, Instructor auditory stimulus describes the category of instruction in that the category contains subcategories and further explains that one of the subcategories will be presented in the subsequent instructional process.

In Step H, the subcategory of the instruction category appears on the Screen and simultaneously the Instructor auditory stimulus describes that two elements of the instruction set will appear at the same time on the Screen where only one of the two elements contains the subcategory of the instruction category that is shown.

In Step I, one of the instruction set elements is displayed on the screen where the instruction set element contains a pair where only one of the pair contains usage of the subcategory of the instruction category and simultaneously the Instructor auditory stimulus recites the one of the pair that contains usage of the subcategory of the instruction category.

In Step J, is as previously described in Diagram 501, Step L.

In Step K, is as previously described in Diagram 501, Step M.

In Step L, is as previously described in Diagram 501, Step N.

In Step M, is as previously described in Diagram 501, Step Q.

In Step N, is as previously described in Diagram 501, Step R.

In Step O, is as previously described in Diagram 501, Step O.

In Step P, the subcategory of the instruction category appears on the Screen and simultaneously the Instructor auditory stimulus describes that two elements of the instruction set will appear at the same time on the Screen where only one of the two elements contains the subcategory of the instruction category that is shown.

In Step Q, is as previously described in Diagram 501, Step S.

In Step R, is as previously described in Diagram 501, Step T.

FIG. 506 is a diagram illustrating Instruction Element 6 Process wherein the Instruction Element 6 Process is performed based on conditions found in the User Data and Lesson Data (FIG. 550) and is activated by Instruction Module 4 Process (FIG. 404) depending on the instruction criteria prescribed for a particular lesson number.

In step A, is as previously described in Diagram 501, Step A.

A.1 is as previously described in Diagram 501, A.1.

In Step B, is as previously described in Diagram 501, Step B.

B.1 is as previously described in Diagram 501, B.1.

In Step C, is as previously described in Diagram 501, Step C.

C.1 is as previously described in Diagram 501, C.1.

In Step D, is as previously described in Diagram 501, Step D.

In Step E, is as previously described in Diagram 501, Step E.

In Step F, is as previously described in Diagram 501, Step F.

In Step G, the instruction set elements are displayed on the Screen in a random order and simultaneously the Instructor auditory stimulus describes that the randomly displayed instruction set must be ordered into its proper order.

In Step H, the instructor auditory stimulus recites the instruction set elements as they would be recited in their proper order.

In Step I, is as previously described in Diagram 501, Step L.

In Step J, is as previously described in Diagram 501, Step M.

In Step K, is as previously described in Diagram 501, Step N.

In Step L, is as previously described in Diagram 501, Step O.

In Step M, onscreen instructor auditory stimuli describes that the randomly displayed instruction set must be ordered into its proper order.

In Step N, the instructor auditory stimulus recites the correct instruction set element that the Student User identified in Step I. would be recited in their proper order.

In Step O, the instruction set element that the Student User identified in Step I moves from its random position on the Screen to its correct position displayed above the random set.

In Step P, the instruction set elements appear on the Screen organized in their proper order while the random order remains below, simultaneously the onscreen instructor audio stimuli recites the instruction set elements as they would be recited in their proper order.

In Step Q, an evaluation is performed to determine if the Student User has responded incorrectly twice in a row which if so processing transfers to Step I. If this was the first incorrect response processing transfers to Step R.

In Step R, the instruction set elements that appear on the Screen organized in their proper order are removed from the Screen and processing transfers to Step I.

In Step S, is as previously described in Diagram 501, Step T, except that processing transfers to Step I if the instruction set is not complete.

In Step T, the instruction set elements appear on the Screen organized in their proper order while the random order remains below, simultaneously the onscreen instructor audio stimuli recites the instruction set elements as they would be recited in their proper order and Instruction Element 6 processing stops.

FIG. 507 is a diagram illustrating Instruction Element 7 Process wherein the Instruction Element 7 Process is performed based on conditions found in the User Data and Lesson Data (FIG. 550) and is activated by Instruction Module 4 Process (FIG. 404) depending on the instruction criteria prescribed for a particular lesson number.

In step A, is as previously described in Diagram 501, Step A.

A.1 is as previously described in Diagram 501, A.1.

In Step B, is as previously described in Diagram 501, Step B.

B.1 is as previously described in Diagram 501, B.1.

In Step C, is as previously described in Diagram 501, Step C.

C.1 is as previously described in Diagram 501, C.1.

In Step D, is as previously described in Diagram 501, Step D.

In Step E, is as previously described in Diagram 501, Step E.

In Step F, is as previously described in Diagram 501, Step F.

In Step G, is as previously described in Diagram 501, Step G.

In Step H, the instructor auditory stimulus describes that an instruction set will be recited in its proper order and that each element of the instruction set must be typed on the keyboard one at a time in the same recited order.

In Step I, the instructor auditory stimuli recites the complete instruction set in its proper order.

In Step J, the instructor auditory stimuli recites the next element of the instruction set that must be typed on the keyboard.

In Step K, is as previously described in Diagram 501, Step L

In Step L, is as previously described in Diagram 501, Step M.

In Step M, is as previously described in Diagram 501, Step N.

In Step N, is as previously described in Diagram 501, Step O.

In Step O, the instructor auditory stimuli describes that the instruction set element that was recited in Step J must be spelled on the keyboard.

In Step P, simultaneously the complete instruction set appears on the Screen in its proper order while the onscreen instructor stimuli recites the complete instruction set in its proper order.

In Step Q, an evaluation is performed to determine if the Student User has responded incorrectly twice in a row which if so processing transfers to Step R. If this was the first incorrect response processing transfers to Step J.

In Step R, the complete instruction set elements that appear on the Screen is organized in their proper order are removed from the Screen except that the previously correctly typed elements remain and processing transfers to Step J.

In Step S, the keystroke that was entered in Step K appears to the right of the previously correctly keyed keystrokes that already displayed on the Screen.

In Step T, an evaluation is performed to determine if all keystrokes have been entered to complete the required keystrokes for this instruction set element, if so, processing transfers to Step U, if not processing Step K.

In Step U, simultaneously the complete instruction set appears on the Screen in its proper order while the onscreen instructor stimuli recites the complete instruction set in its proper order.

In Step V, is as previously described in Diagram 501, Step T.

FIG. 508 is a diagram illustrating Instruction Element 8 Process wherein the Instruction Element 8 Process is performed based on conditions found in the User Data and Lesson Data (FIG. 550) and is activated by Instruction Module 4 Process (FIG. 404) depending on the instruction criteria prescribed for a particular lesson number.

In step A, is as previously described in Diagram 501, Step A.

A.1 is as previously described in Diagram 501, A.1.

In Step B, is as previously described in Diagram 501, Step B.

B.1 is as previously described in Diagram 501, B.1.

In Step C, is as previously described in Diagram 501, Step C.

C.1 is as previously described in Diagram 501, C.1.

In Step D, is as previously described in Diagram 501, Step D.

In Step E, is as previously described in Diagram 501, Step E.

In Step F, the onscreen instructor auditory stimuli describes the category of instruction that is being taught.

In Step G, the onscreen instructor auditory stimuli describes that the category of instruction will be instruction sets where the correct meaning must be accurately discriminated from a series of options displayed.

In Step H, simultaneously, the instructor auditory stimulus recites an example instruction set element and then recites its correct meaning while the corresponding instruction set element is displayed on the Screen will be recited in its proper order and that each element of the instruction set must be typed on the keyboard one at a time in the same recited order.

In Step I, an element of instruction set along with a list of possible meanings is displayed on the Screen.

In Step J, the instructor auditory stimuli describes that the correct meaning for the instruction set element must be selected from the available options.

In Step K, the instructor auditory stimuli recites the instruction set element shown.

In Step L, is as previously described in Diagram 501, Step L.

In Step M, is as previously described in Diagram 501, Step M.

In Step N, is as previously described in Diagram 501, Step N.

In Step O, is as previously described in Diagram 501, Step O.

In Step P, is as previously described in Diagram 501, Step Q.

In Step Q, is as previously described in Diagram 501, Step R.

In Step R, the correct meaning that was selected in Step L is removed from the available set of optional meanings displayed on the Screen.

In Step S, is as previously described in Diagram 501, Step T.

FIG. 509 is a diagram illustrating Instruction Element 9 Process wherein the Instruction Element 9 Process is performed based on conditions found in the User Data and Lesson Data (FIG. 550) and is activated by Instruction Module 4 Process (FIG. 404) depending on the instruction criteria prescribed for a particular lesson number.

In step A, is as previously described in Diagram 501, Step A.

A.1 is as previously described in Diagram 501, A.1.

In Step B, is as previously described in Diagram 501, Step B.

B.1 is as previously described in Diagram 501, B.1.

In Step C, is as previously described in Diagram 501, Step C.

C.1 is as previously described in Diagram 501, C.1.

In Step D, is as previously described in Diagram 501, Step D.

In Step E, is as previously described in Diagram 501, Step E.

In Step F, the onscreen instructor auditory stimulus describes that multiple instruction sets will be recited one set at a time and that the Student User must listen closely and read along out loud.

In Step G, an evaluation is made to determine if this is the first time the instruction set is being recited. If it is the first time processing transfers to Step J. Otherwise, processing proceeds to Step H.

In Step H, simultaneously, each instruction set appears one at a time and as each element is recited the corresponding displayed element is highlighted in a contrasting color from the other elements on the Screen and the instructor auditory stimulus recites each element of each instruction set at a reduced pace where the element is sounded out slowly.

In Step I, instructions sets are removed from the Screen.

In Step J, simultaneously, each instruction set appears one at a time and as each element is recited the corresponding displayed element is highlighted in a contrasting color from the other elements on the Screen and the instructor auditory stimulus recites each element of each instruction set at a normal pace.

In Step K, an evaluation is made to determine if all instruction sets have been recited a total of three times. If so, processing transfers to Step I. Otherwise, processing stops.

FIG. 510 is a diagram illustrating Instruction Element 10 Process wherein the Instruction Element 10 Process is performed based on conditions found in the User Data and Lesson Data (FIG. 550) and is activated by Instruction Module 5 Process (FIG. 405) depending on the instruction criteria prescribed for a particular lesson number.

In step A, is as previously described in Diagram 501, Step A.

A.1 is as previously described in Diagram 501, A.1.

In Step B, is as previously described in Diagram 501, Step B.

B.1 is as previously described in Diagram 501, B.1.

In Step C, is as previously described in Diagram 501, Step C.

C.1 is as previously described in Diagram 501, C.1.

In Step D, is as previously described in Diagram 501, Step D.

In Step E, is as previously described in Diagram 501, Step E.

In Step F, is as previously described in Diagram 501, Step F.

In Step G, the onscreen instructor audio stimuli describes the instruction that will occur in that all prior instruction sets presented in previous lessons will be displayed in practiced and also explains that the instruction set elements will be recited one at a time and that the Student User must make as many correct responses as quickly as possible.

In Step H, is as previously described in Diagram 501, Step J.

In Step I, correct and incorrect responses counters are displayed on the Screen.

In Step J, a time elapsed counter is set based on the User Data setting for this Student User.

In Step K, instruction process playback speed setting is based on the User Data setting for this Student User.

In Step L, a random number generator returns a random number.

In Step M, an onscreen instructor audio stimulus recites the instruction set element based on the random number from Step L.

In Step N, is as previously described in Diagram 501, Step L.

In Step O, is as previously described in Diagram 501, Step M.

In Step P, is as previously described in Diagram 501, Step N, except that incorrect response transfers processing to Step Q and correct response transfers to Step S.

In Step Q, is as previously described in Diagram 501, Step O.

In Step R, a count of one is added to the onscreen incorrect counter.

In Step S, is as previously described in Diagram 501, Step Q.

In Step T, is as previously described in Diagram 501, Step R.

In Step U, a count of one is added to the onscreen correct counter.

In Step V, an evaluation is made to determine if the time elapsed counter set in Step J, has expired. If not, processing transfers to Step L. If so, processing stops.

### (i) DESCRIPTION OF A PREFERRED EMBODIMENT

The invention is particularly applicable to a computer-based training system for instruction delivery of virtually any subject area of instruction where the subject skills may be acquired through the prompting for, analyzing of and controlling the instruction delivery based on discrimination stimuli.

The following description will be for a reading program embodiment of the invention. However, someone skilled in art can readily see how the invention also can be applied to numbers, alphabetic characters, strings of characters, sentences, atomic symbols, shapes, and the like to construct an embodiment of the invention including but not limited to math, science, chemistry, history, geography foreign languages, or any other instructional content area.

In general, training in accordance with the invention may be computer-based that provides opportunities for a variety of different individuals to access and participate in the training with alternative media that can be provided in a variety of locations and environments using, for example, stand-alone computers, networked computers or client/server web-based systems. In accordance with the invention, the invention may be implemented over a computer network, including the web, the Internet, a LAN, a WAN or the like wherein the user interacts with a server computer using a browser application over the computer network. For purposes of illustration, an embodiment using a stand-alone computer wherein the user interacts with a server computer using a browser application over the computer network (FIG. 101) will be described.

The System Process (FIG. 101), the Control Process (FIG. 211-291), the Instruction Main Process (FIG. 301), the Instruction Module Processes (FIG. 401-406) and the Instruction Element Processes (FIG. 501-510) are all applied to a program that teaches the multiple reading skills of Alphabetic Principle, Phonemic Awareness, Fluency and Automaticity wherein multiple instruction sets of Lesson Data (FIG. 550) and Audio Data (FIG. 560) are audibly and visually presented on the computing system, where an onscreen instructor appears and recites the Audio Data simultaneously and in synchronization with the Lesson Data as it is being displayed on the computing system viewing device such that the invention simulates actually classroom instruction, the instructional system begins playback in under 15 seconds on 56 K dial up internet connections, the User is highly engage and motivated to participate in the instruction, the User is able to interact with the instruction in real time where every single user interaction is recorded and accumulated over the course of the entire instruction set of lessons, where the accumulated interaction data is presented as an accumulation of performance over time in a percentage correct interaction format to access comprehension, retention and to isolate skill areas that are deficient.

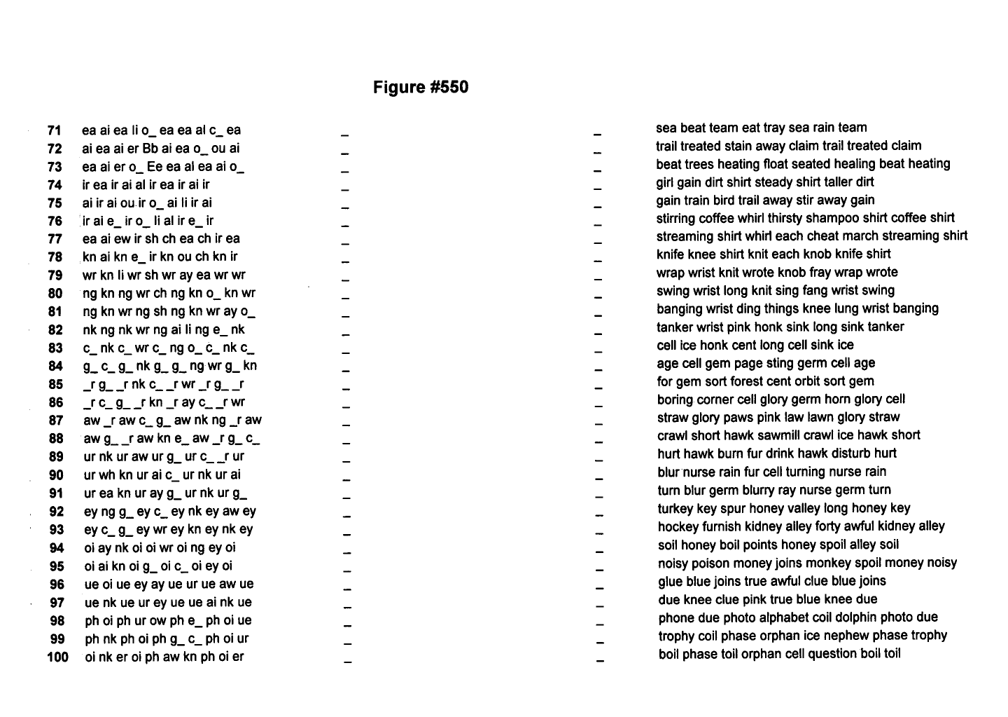

Instruction Element 1 Process (FIG. 501) is applied to a program that teaches the reading Alphabetic Principle skill of Letter Sound Correspondence wherein multiple instruction sets of graphemes (letter sound shapes), Lesson Data (FIG. 550) and Audio Data (FIG. 560) are visually and audibly presented on the computer screen and audio system, while the onscreen instructor recites one of the letter sounds where the user must then click on the corresponding grapheme letter pair that matches the letter sound recited (See FIG. 600).

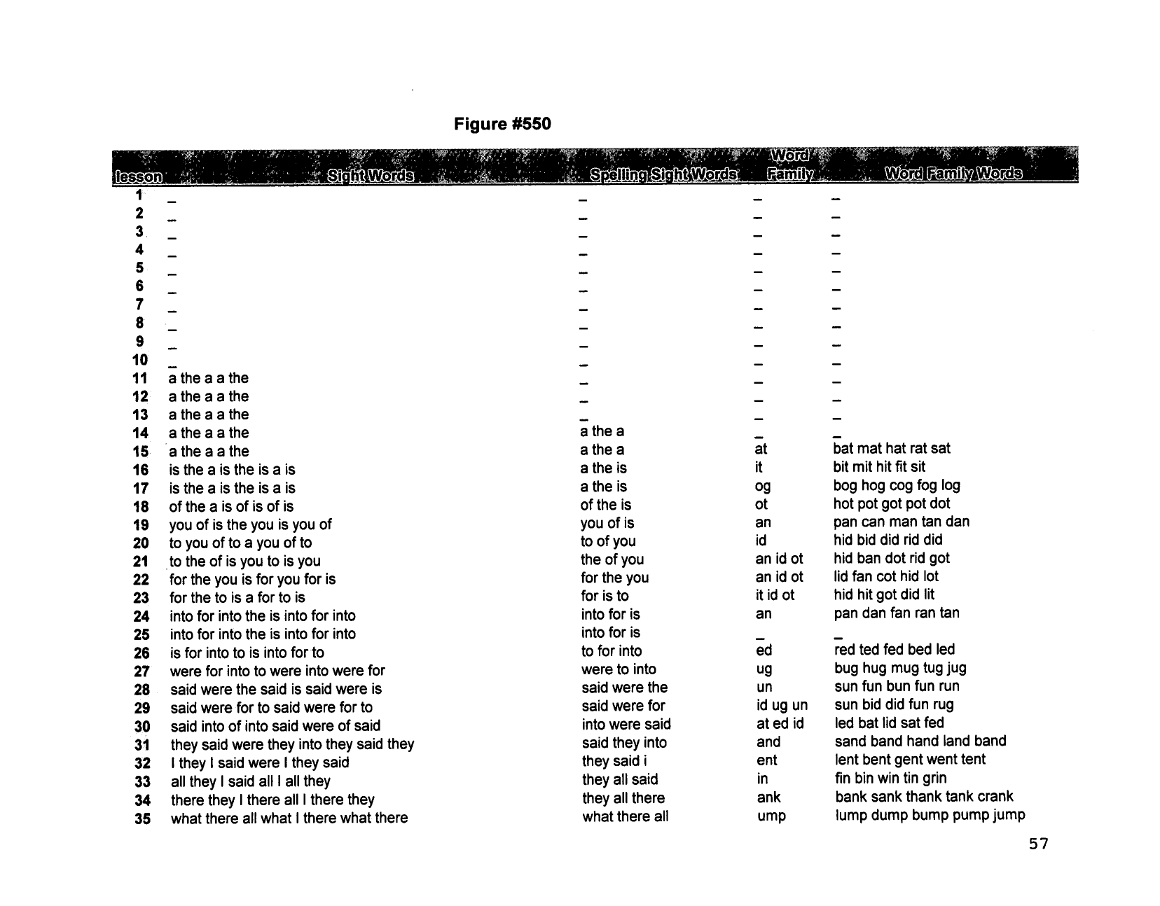

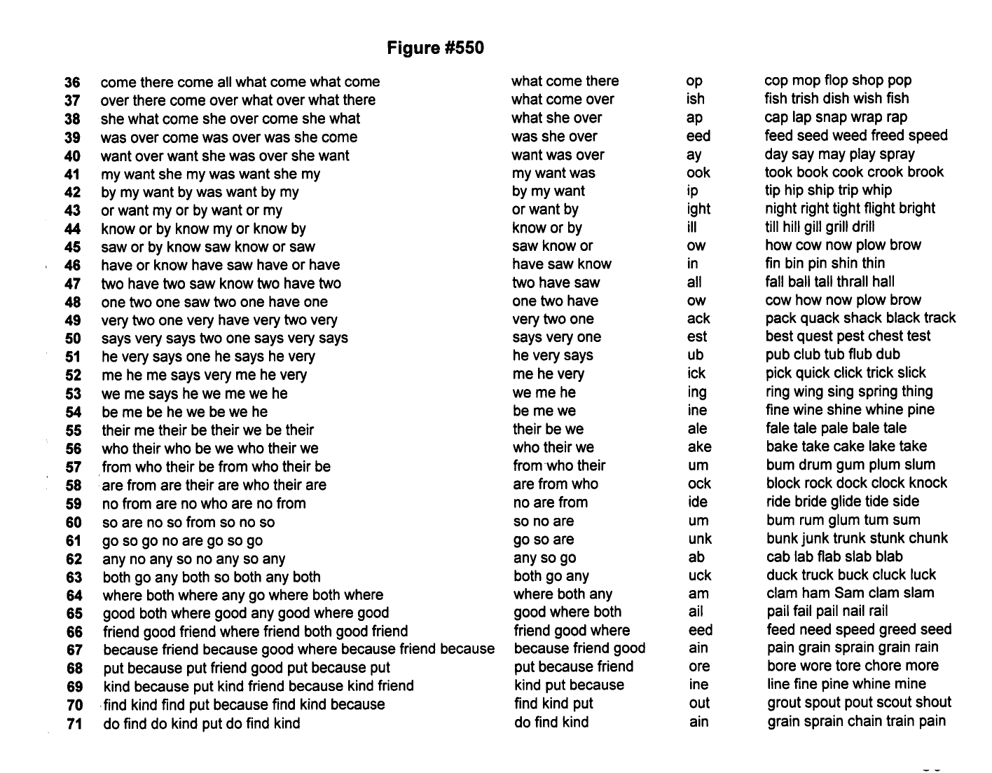

Instruction Element 1 Process (FIG. 501) is applied to a program that teaches the reading skill of Phonemic Awareness (Initial, Medial and Final Letter Sounds in words) wherein multiple instruction sets of graphemes (letter sound shapes), Lesson Data (FIG. 550) and Audio Data (FIG. 560), are visually and audibly presented on the computer screen and audio system, while the onscreen instructor recites a word that contains either the initial, medial or final letter sound of one of the graphemes displayed where the user must then click on the corresponding grapheme letter pair that is used in the word sound recited (See FIG. 610).

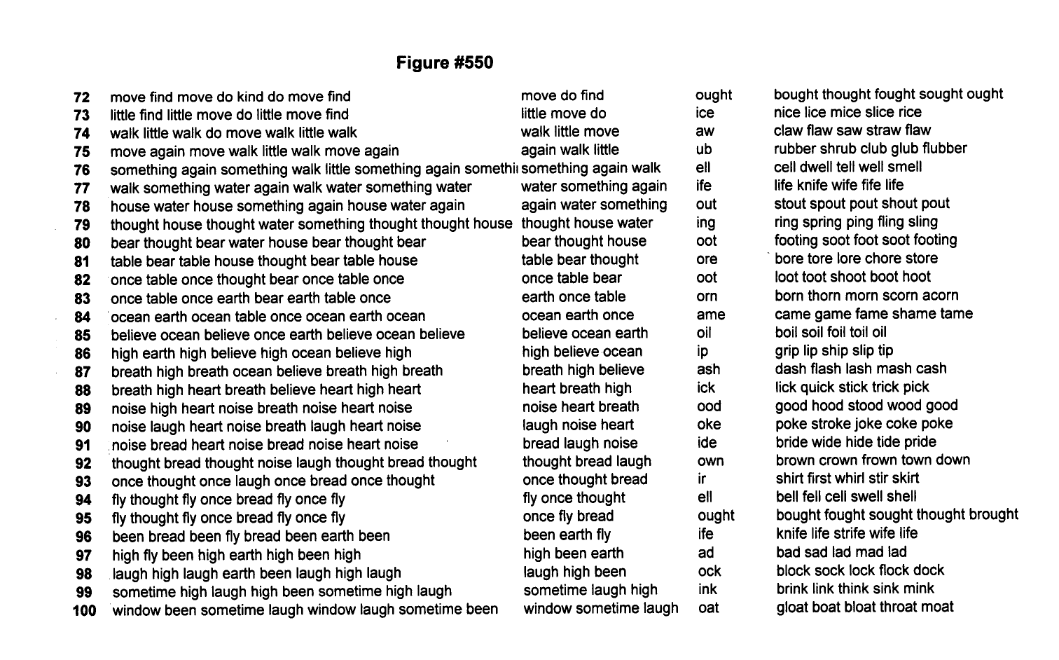

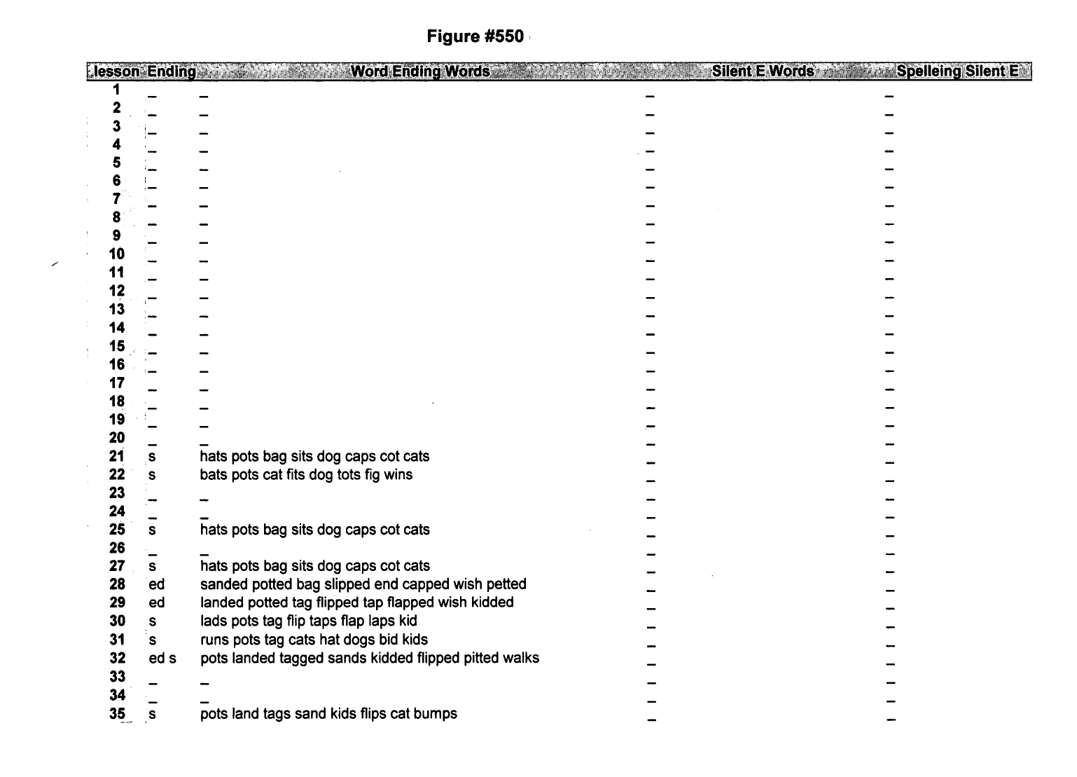

Instruction Element 1 Process (FIG. 501) is applied to a program that teaches the reading Alphabetic Principle skill of Sight Words Identification wherein multiple instruction sets of Sight Words, Lesson Data (FIG. 550) and Audio Data (FIG. 560), are visually and audibly presented on the computer screen and audio system, while the onscreen instructor recites one of the Sight Word sounds where the user must then click on the corresponding Sight Word displayed that matches the Sight Word sound recited (See FIG. 620).

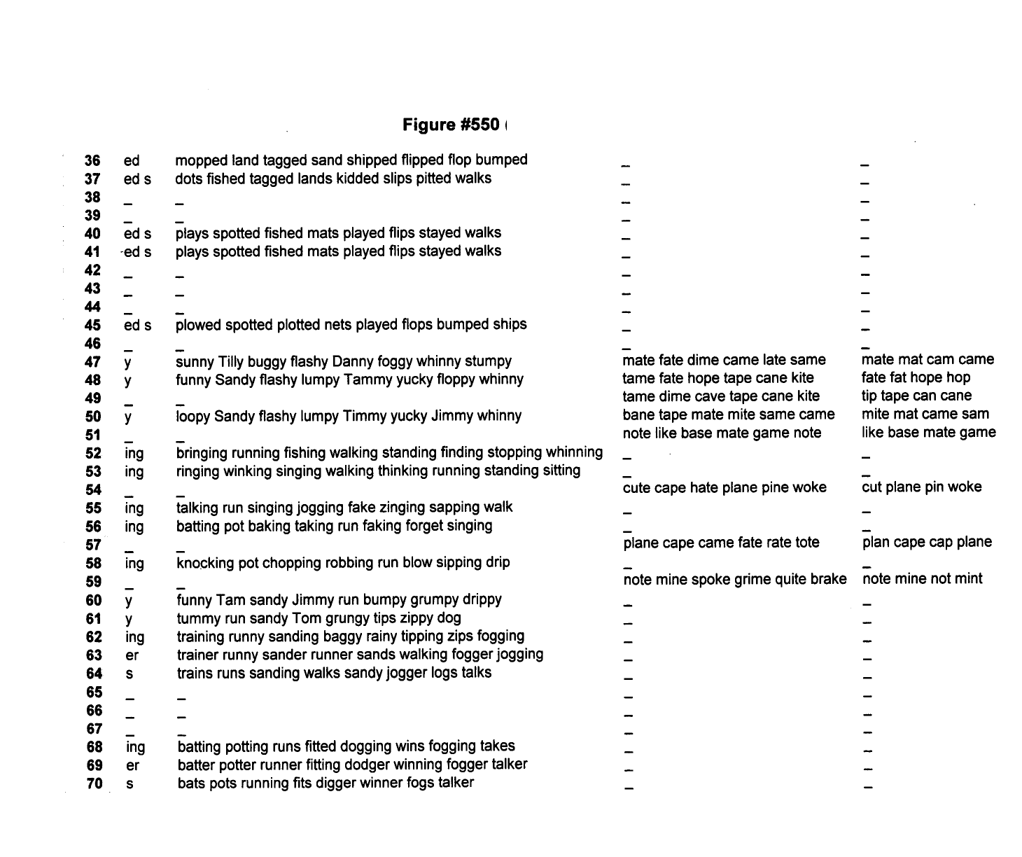

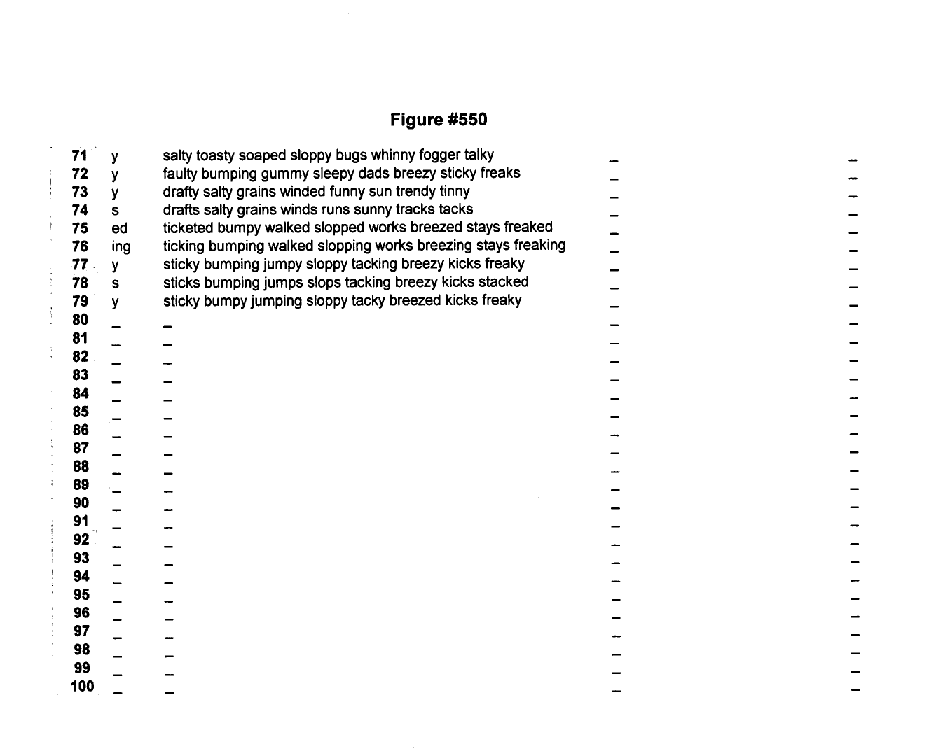

Instruction Element 2 Process (FIG. 502) is applied to a program that teaches the reading Alphabetic Principle skill of Spelling Letter Sound Correspondences wherein multiple instruction sets of the names of the graphemes (letter shapes), Audio Data (FIG. 560), are audibly presented on the computer audio system, and the onscreen instructor recites one of the letter sounds where the user must then spell on the computer system keyboard, the corresponding grapheme letter pair that matches the letter sound recited (See FIG. 630).

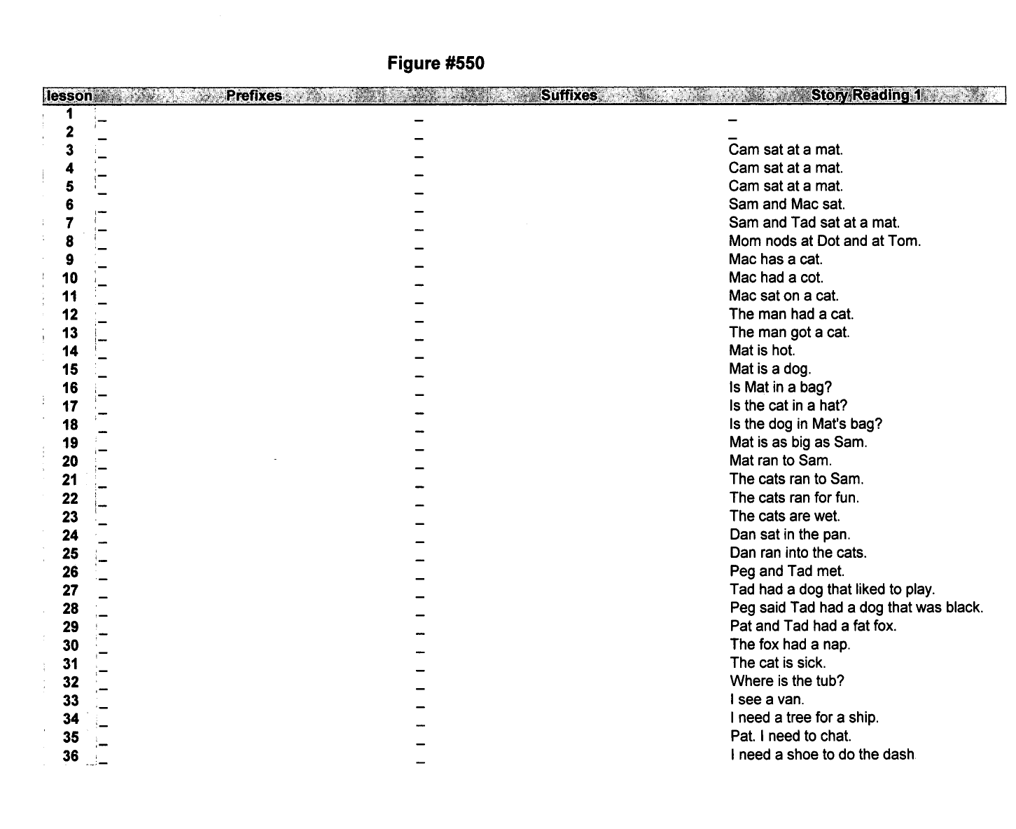

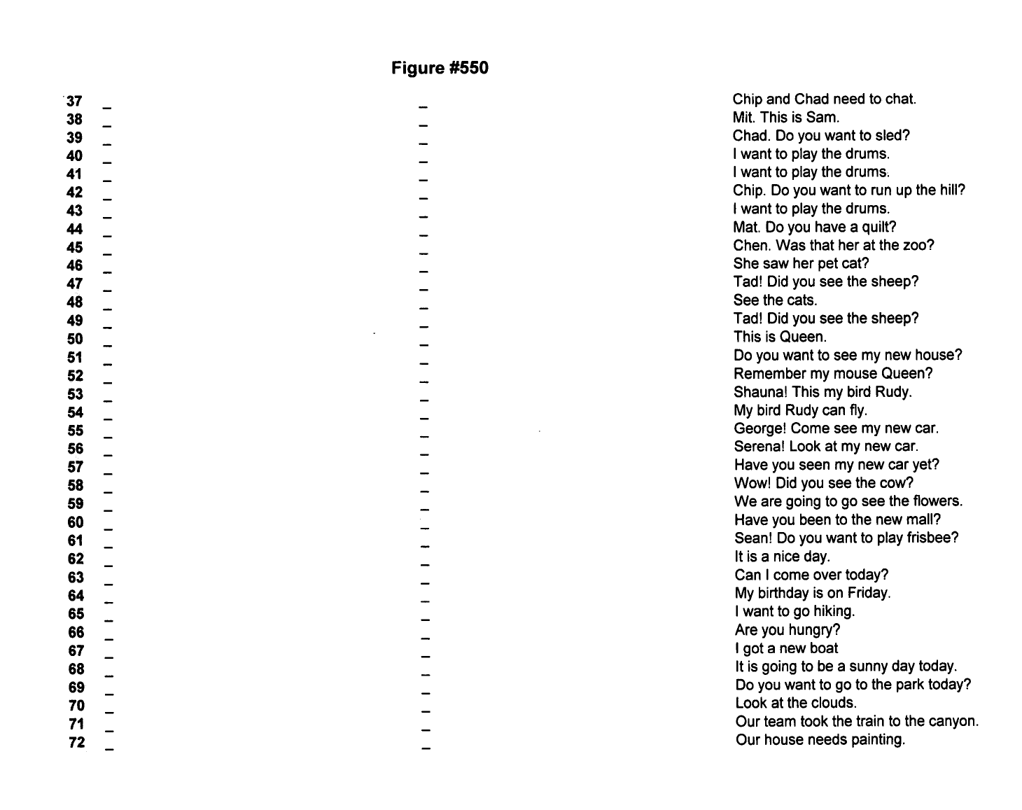

Instruction Element 2 Process (FIG. 502) is applied to a program that teaches the reading Alphabetic Principle skill of Spelling Sight Words wherein multiple instruction sets of Sight Words, Audio Data (FIG. 560), are audibly presented on the computer audio system, and the onscreen instructor recites a Sight Word where the user must then spell the corresponding Sight Word that matches the Sight Word sound recited (See FIG. 640).

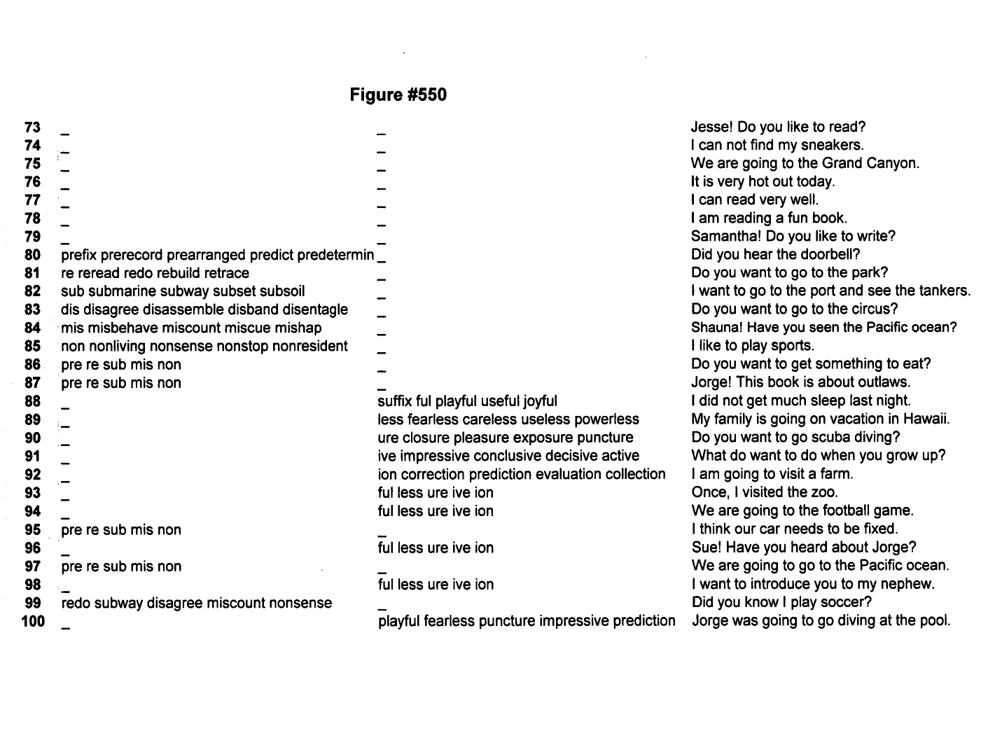

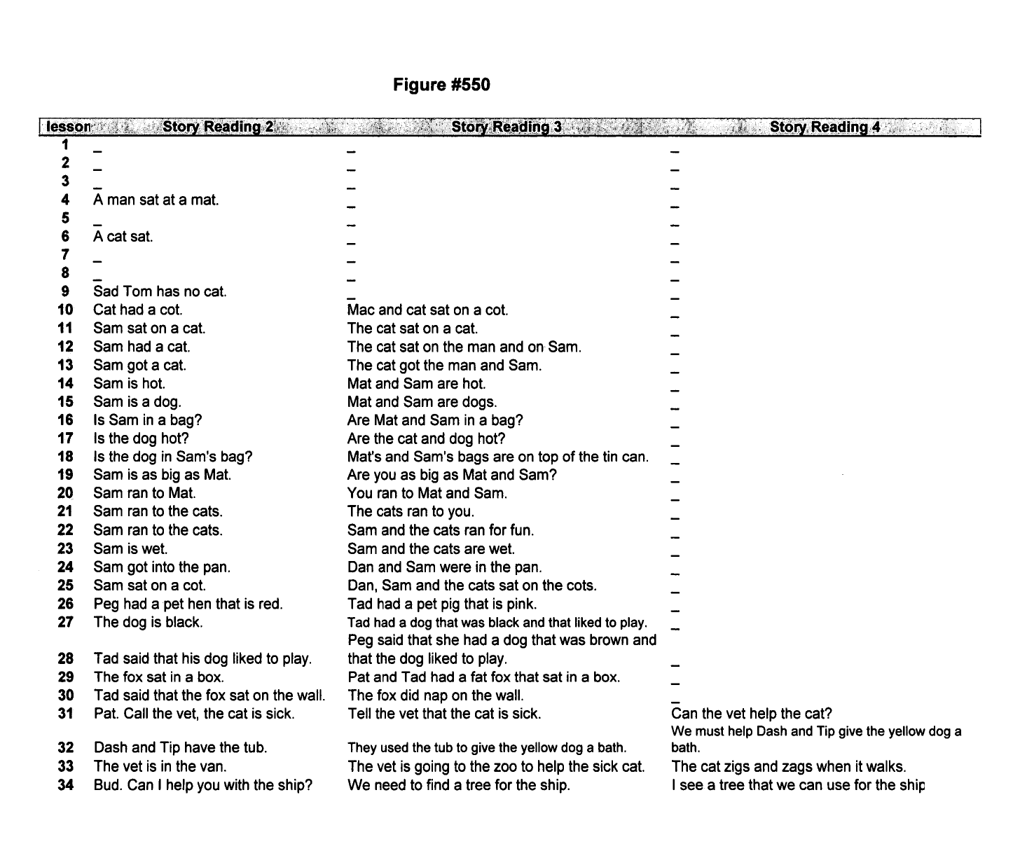

Instruction Element 2 Process (FIG. 502) is applied to a program that teaches the reading Alphabetic Principle skill of Spelling Silent E Words wherein multiple instruction sets of Silent E Words, Audio Data (FIG. 560), are audibly presented on the computer audio system, and the onscreen instructor recites one of the Silent E Words where the user must then spell the corresponding Silent E Word that matches the Silent E Word recited (See FIG. 650).

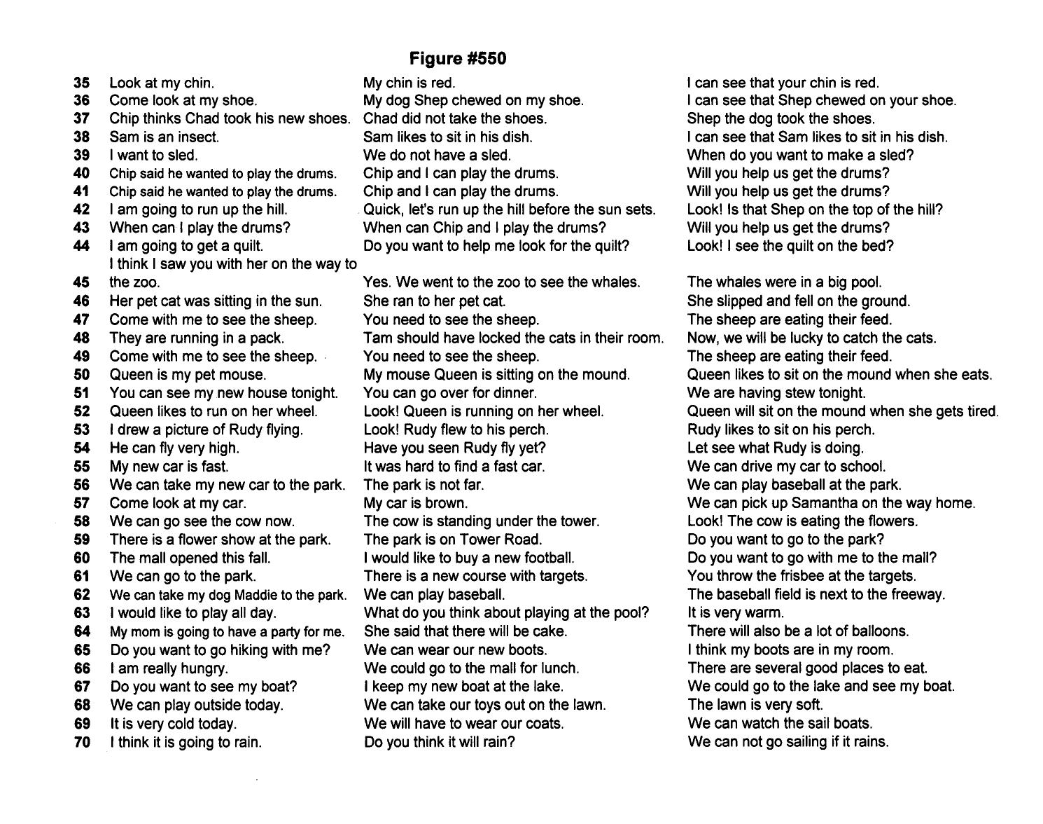

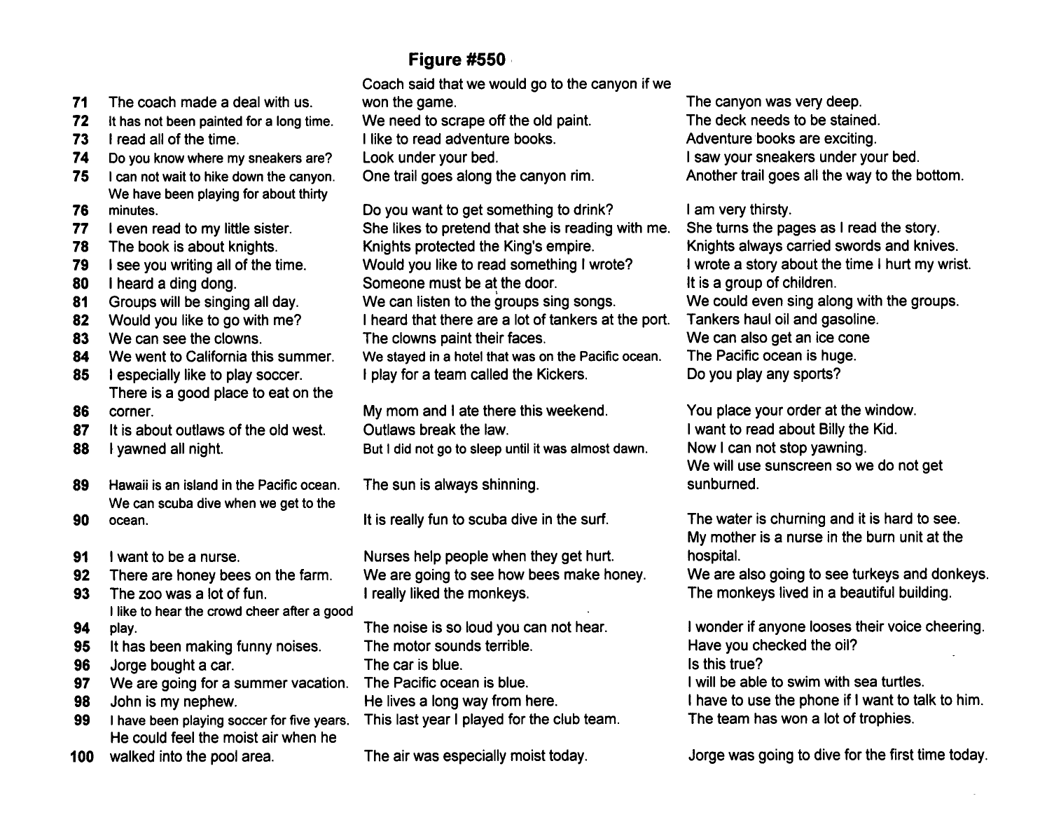

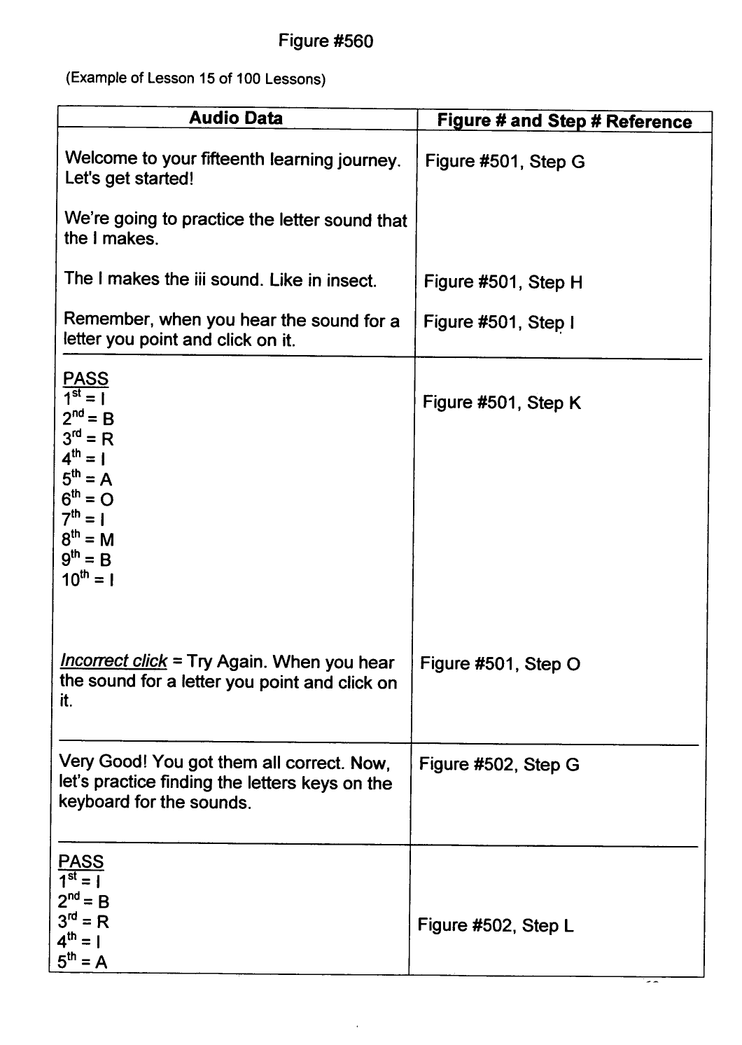

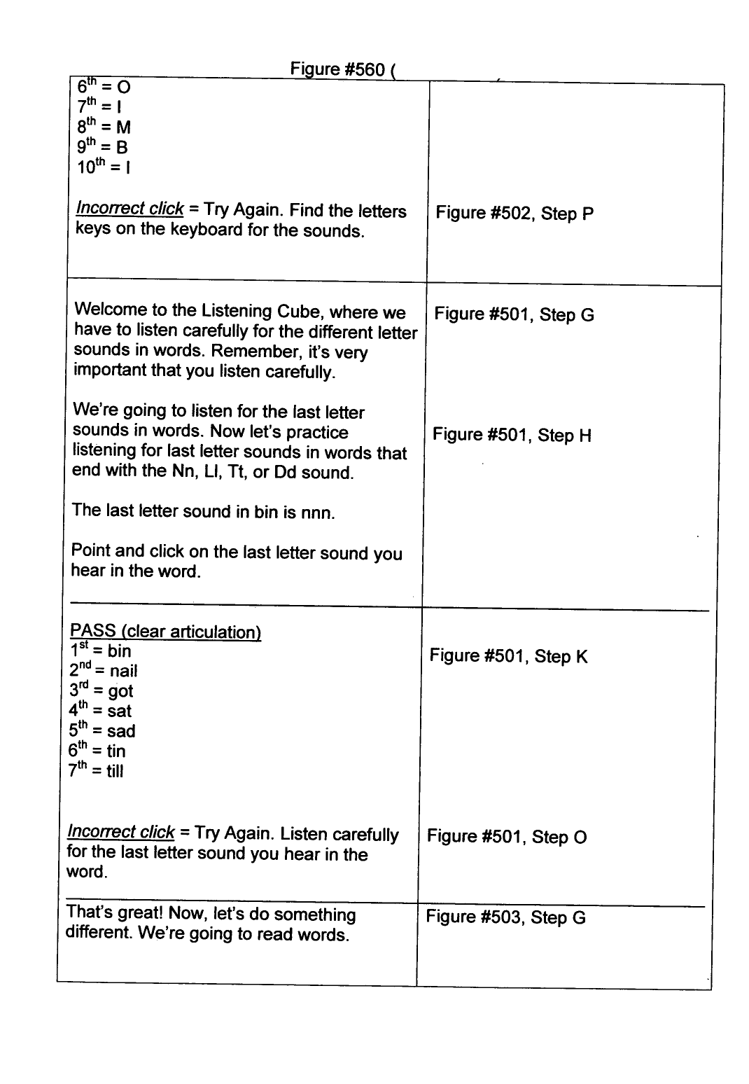

Instruction Element 3 Process (FIG. 503) is applied to a program that teaches the reading Alphabetic Principle skill of Word Blending wherein multiple instruction sets of High Frequency Sight Words, Lesson Data (FIG. 550) and Audio Data (FIG. 560), are visually and audibly presented on the computer screen and audio system, where the onscreen instructor recites one of the High Frequency Sight Word sounds, each being presented in two precise manners wherein first each individual letter sound that makes up the word is recited separately with a slight delay between each individual letter sound such that the word sound emerges from the blended rapidly sequenced individually recited letter sounds followed by a subsequent recitation of the word as it sounds in its regular form. Further, where the user must then click on the corresponding High Frequency Sight Word that matches the word sound recited (See FIG. 660 & FIG. 670).

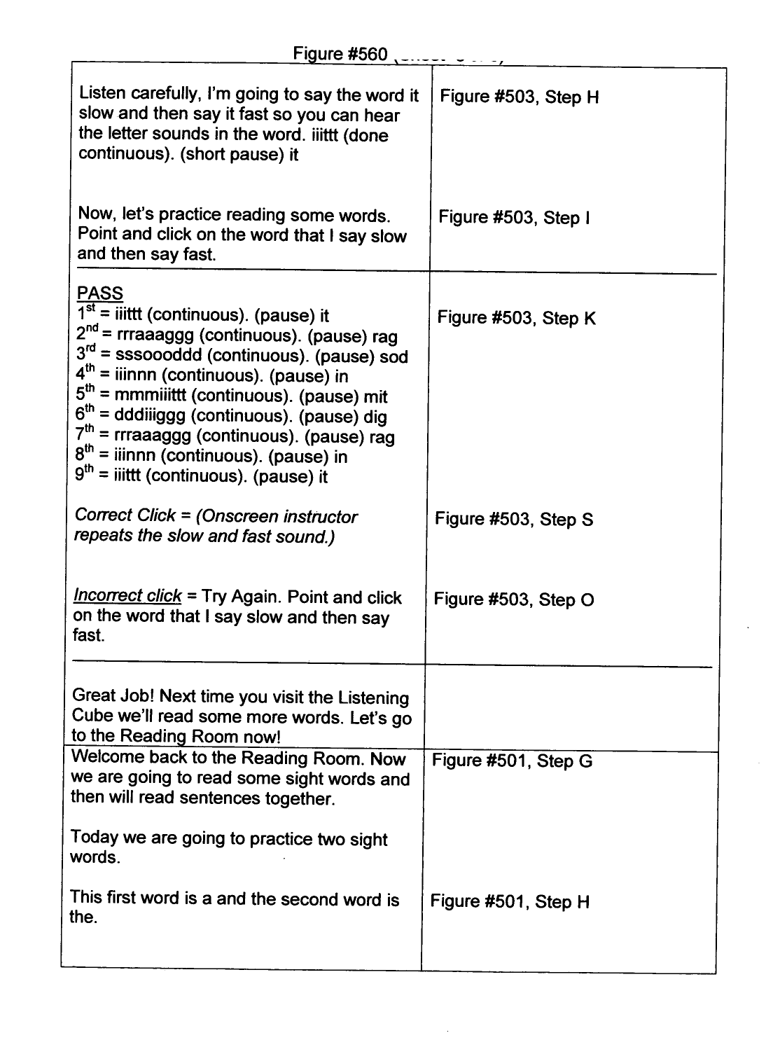

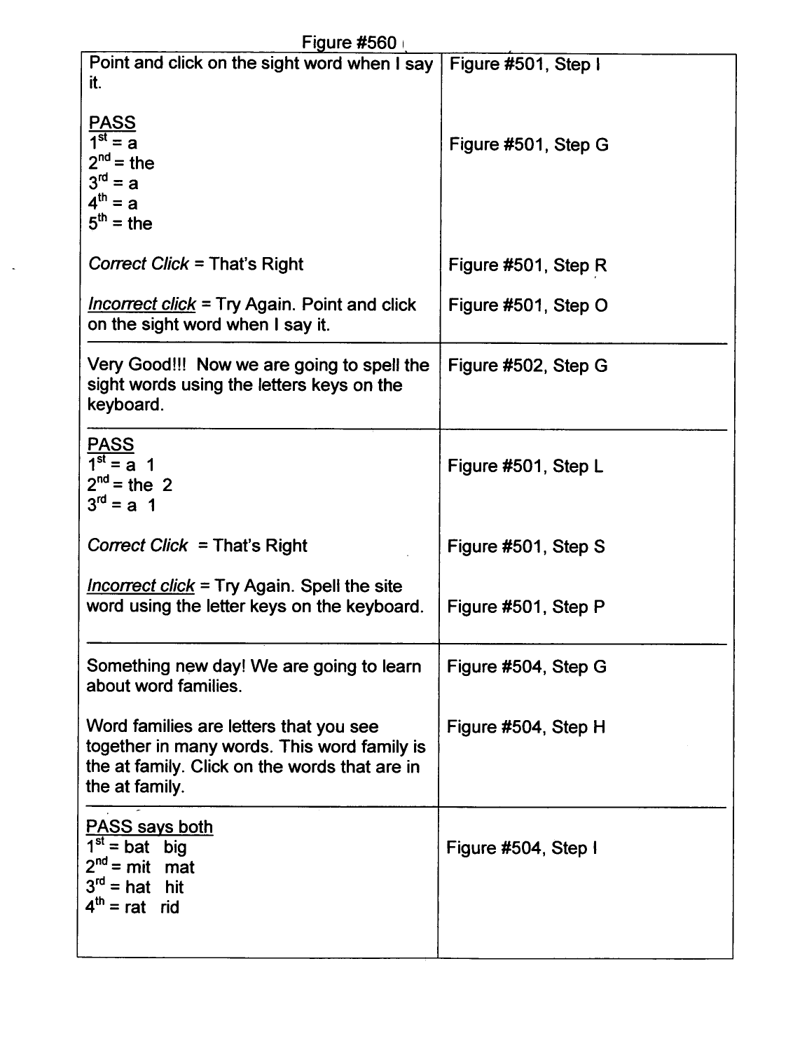

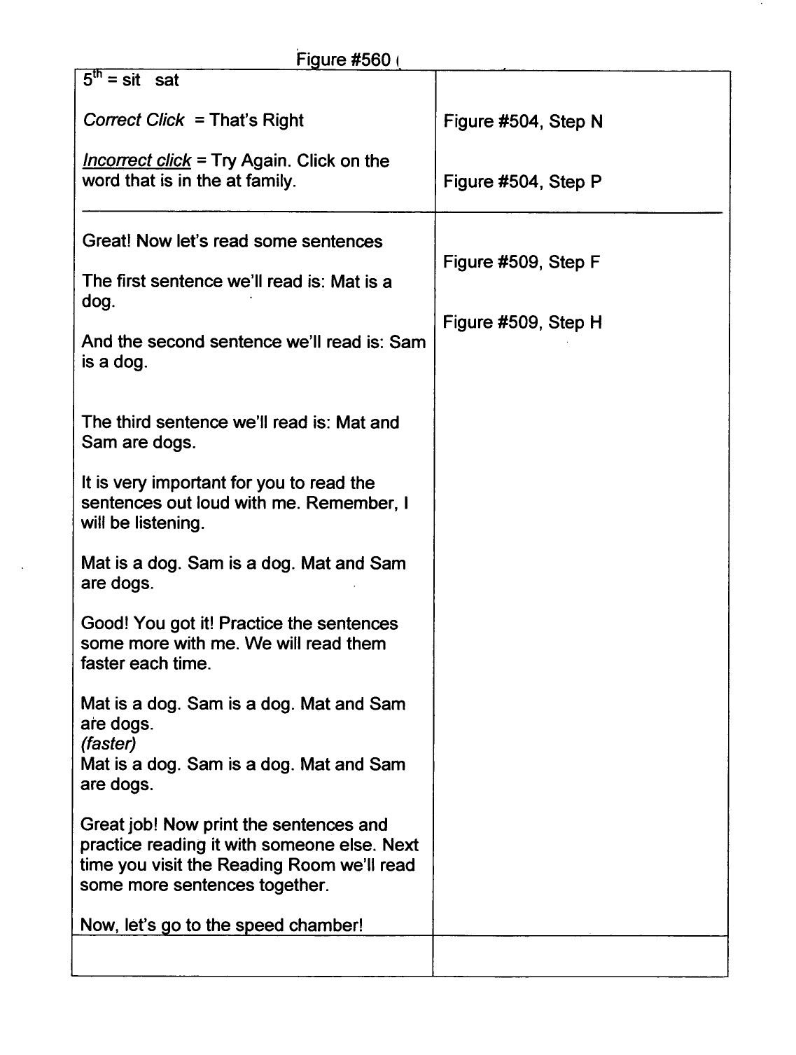

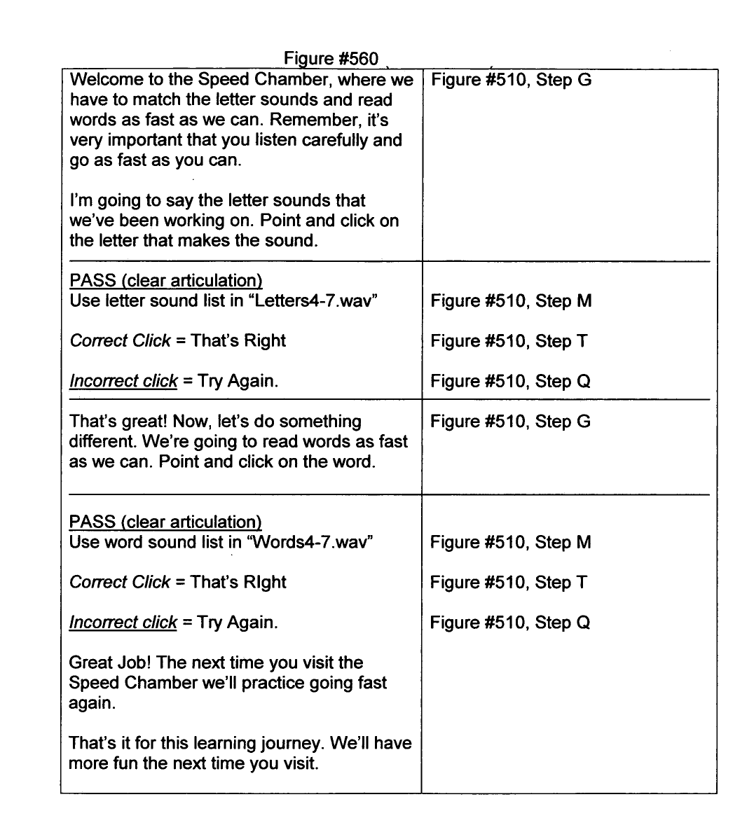

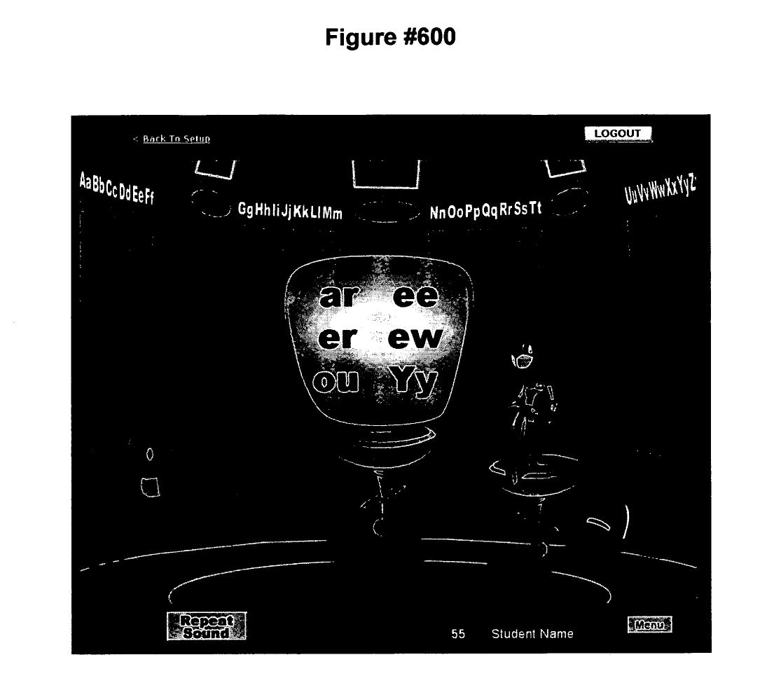

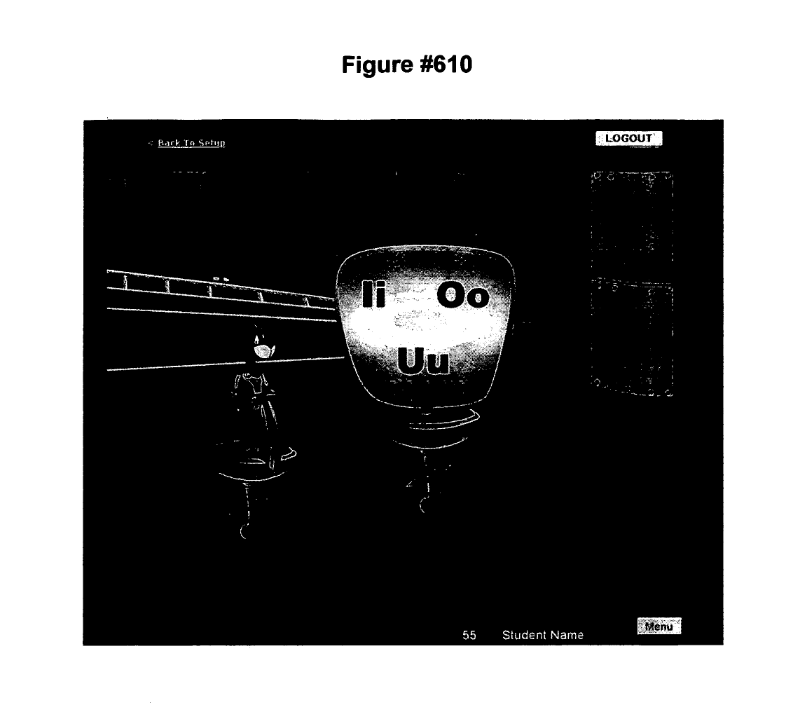

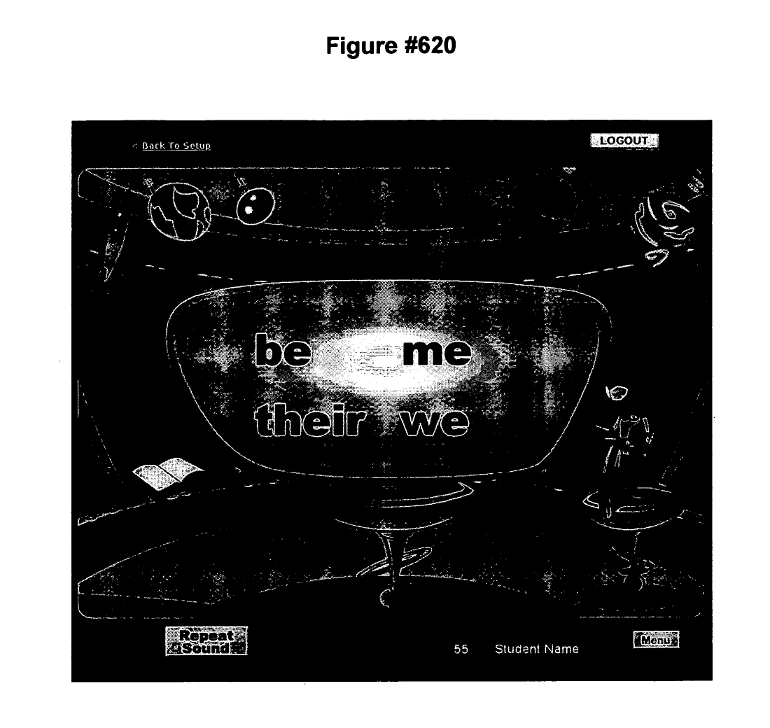

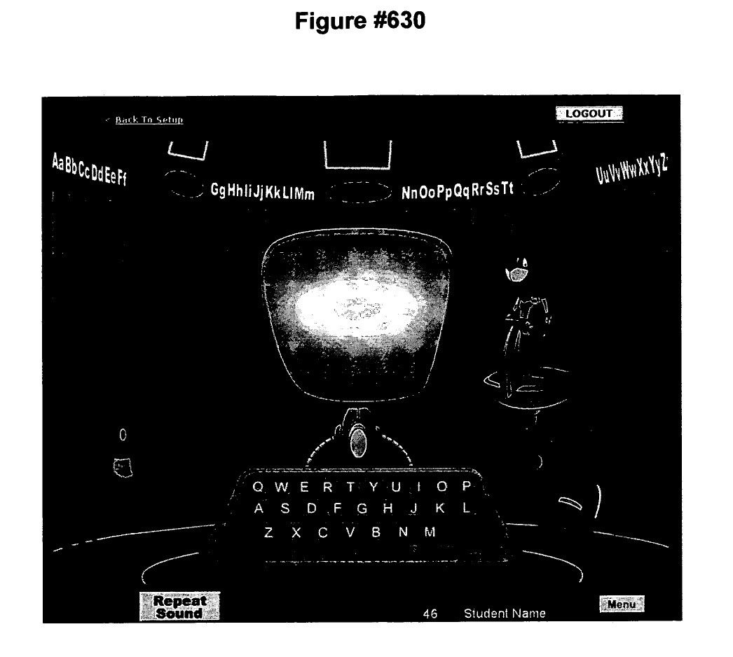

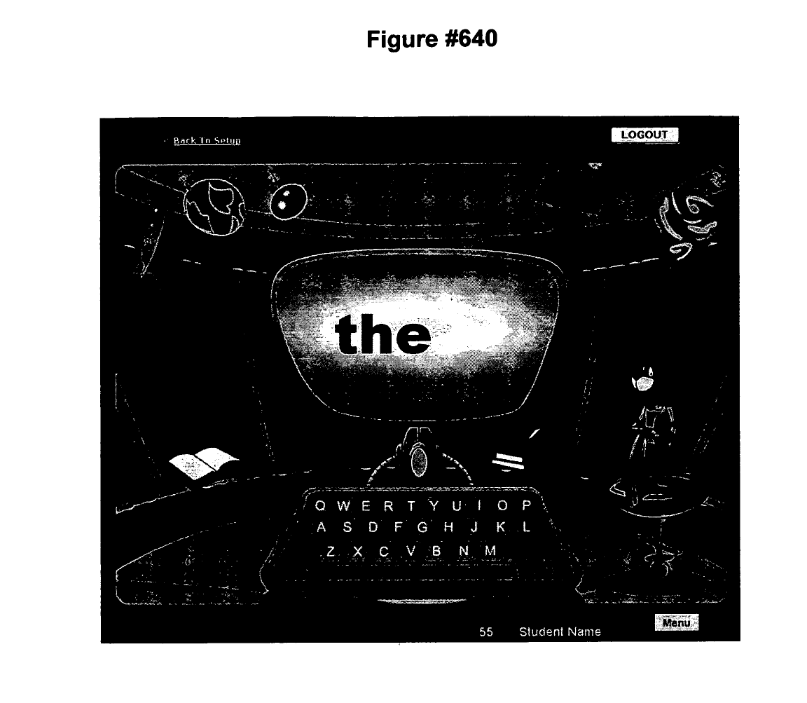

Instruction Element 4 Process (FIG. 504) is applied to a program that teaches the reading Alphabetic Principle skill of Word Families and Word Endings wherein multiple instruction sets (a Word Family or a Word Ending), Lesson Data (FIG. 550) and Audio Data (FIG. 560), are visually and audibly presented on the computer screen and audio system, where the onscreen instructor first recites the specific type of instruction set (the Word Family or Word ending name) being taught in the given lesson followed by recitation of a pair words displayed on the screen wherein only one of the words contains the usage of the instruction set type (specific Word Family or Word Ending) and the other does not where the user must then click on the corresponding word, from the word pair displayed, that contains the usage of the instruction set type (specific Word Family or Word Ending). (See FIGS. 680, 690, 700, 710, 720).

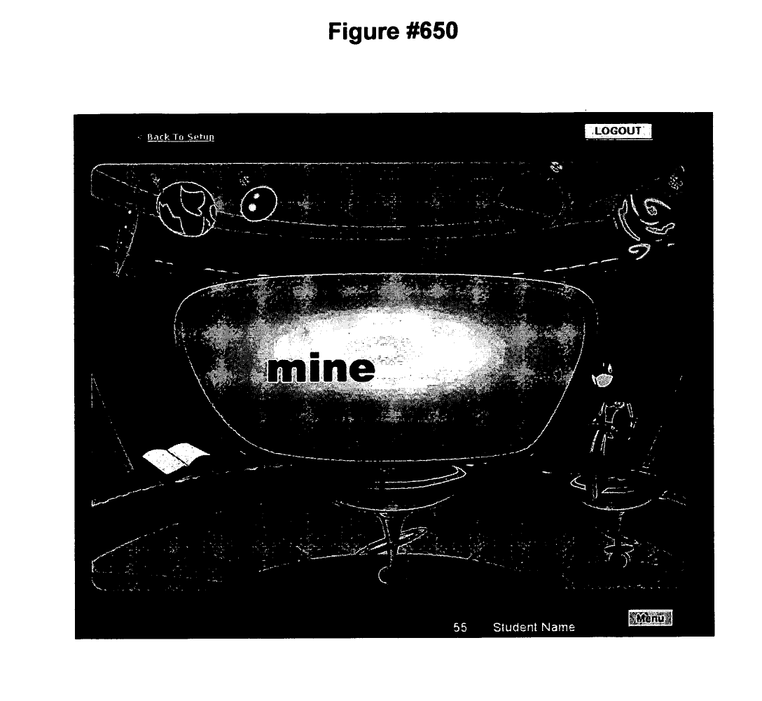

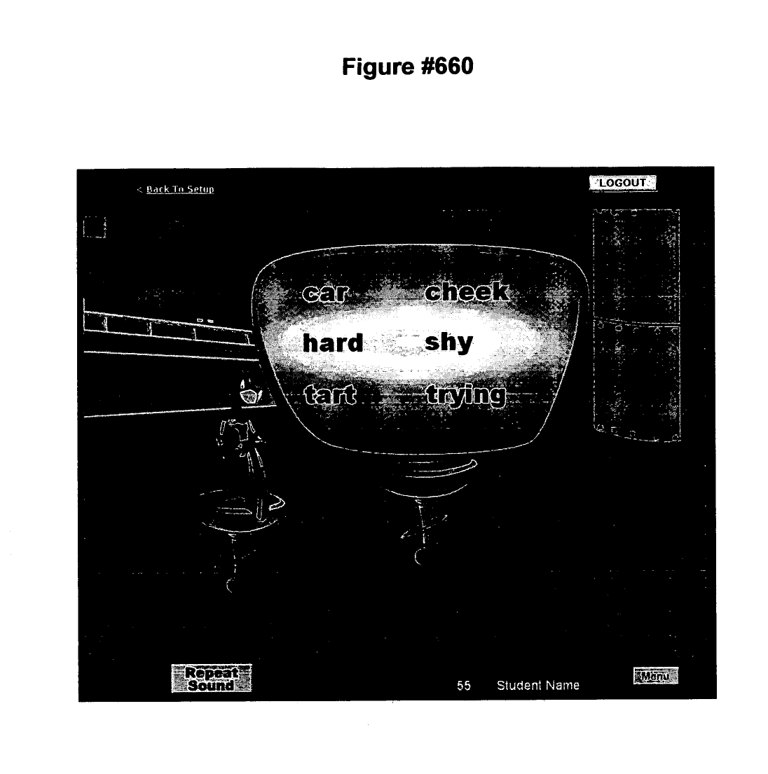

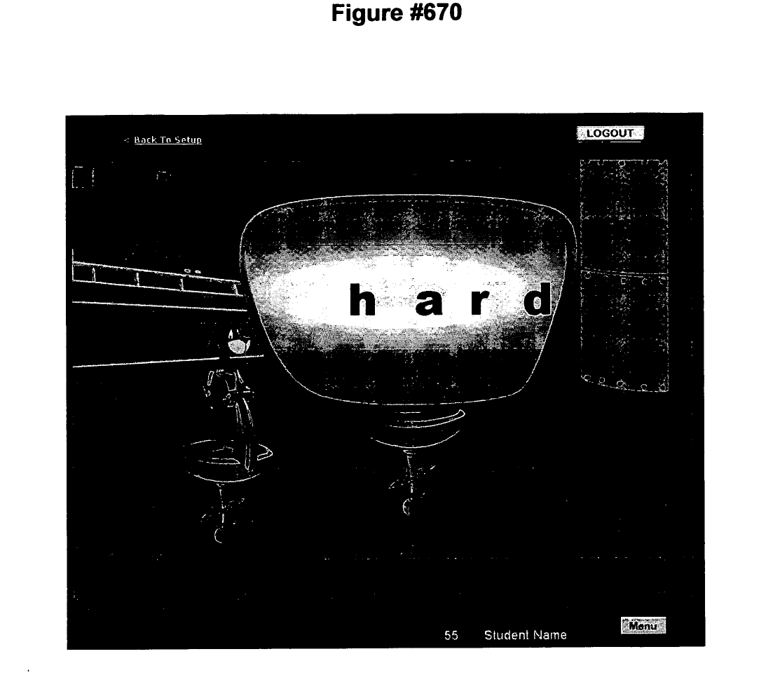

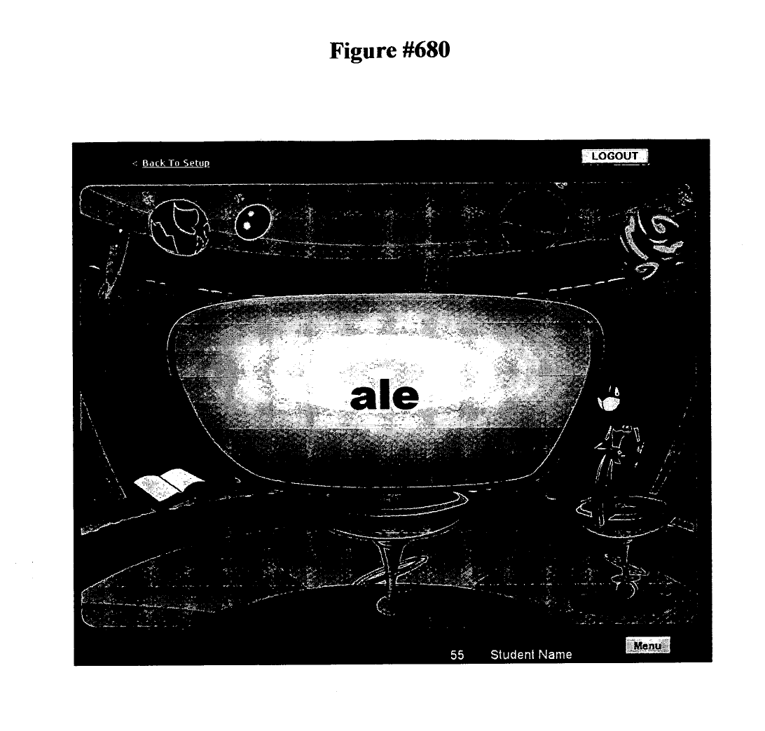

Instruction Element 6 Process (FIG. 506) is applied to a program that teaches the reading Alphabetic Principle skill of Sentence Construction wherein an instruction set where the instruction set (a sentence) contains multiple elements that have a prescribed order (the words that make up a sentence), Lesson Data (FIG. 550) and Audio Data (FIG. 560), are visually and audibly presented on the computer screen and audio system, wherein the onscreen instructor stimuli recites the instruction set elements in their proper prescribed order (recites the sentence) and where the user must then click on the corresponding elements (the words) in their proper order to construct the sentence which, are displayed on the Screen in a random order. (See FIGS. 730, 740).

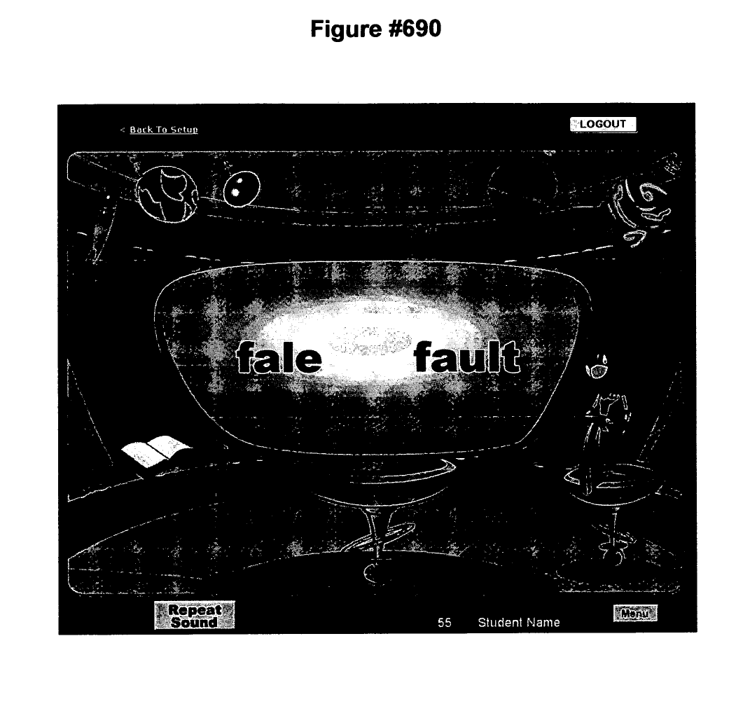

Instruction Element 7 Process (FIG. 507) is applied to a program that teaches the reading Alphabetic Principle skill of Sentence Dictation (spelling sentences) wherein an instruction set (a sentence), Lesson Data (FIG. 550) and Audio Data (FIG. 560), are visually and audibly presented on the computer screen and audio system, wherein the onscreen instructor stimuli recites the instruction set elements one element at a time separately (each word of the sentence) where the Student User must then type the corresponding elements (the words) on the computer keyboard. (See FIG. 750).

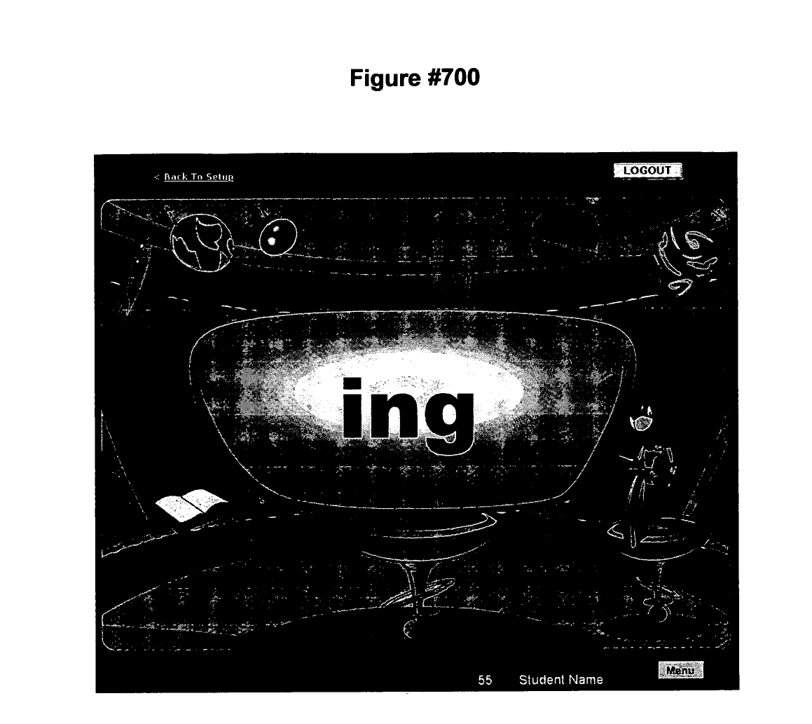

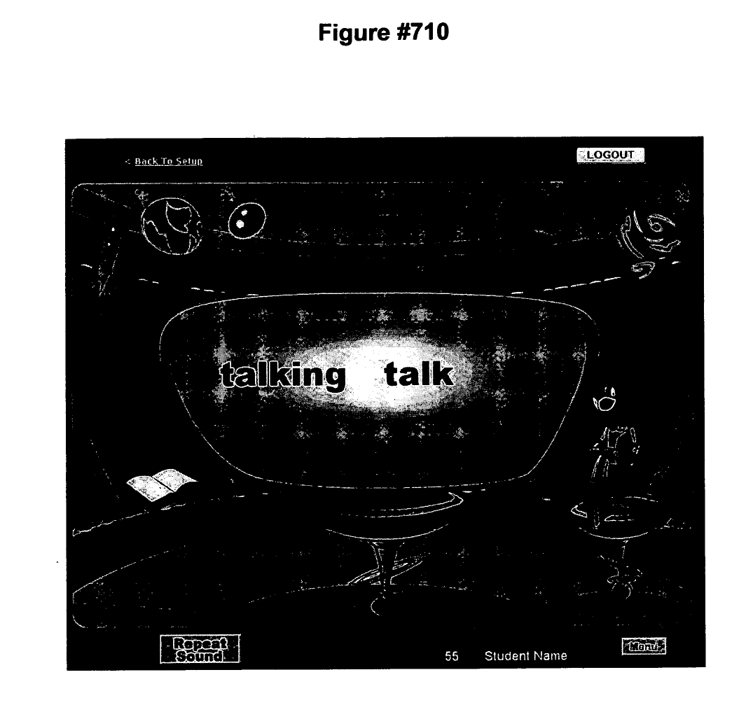

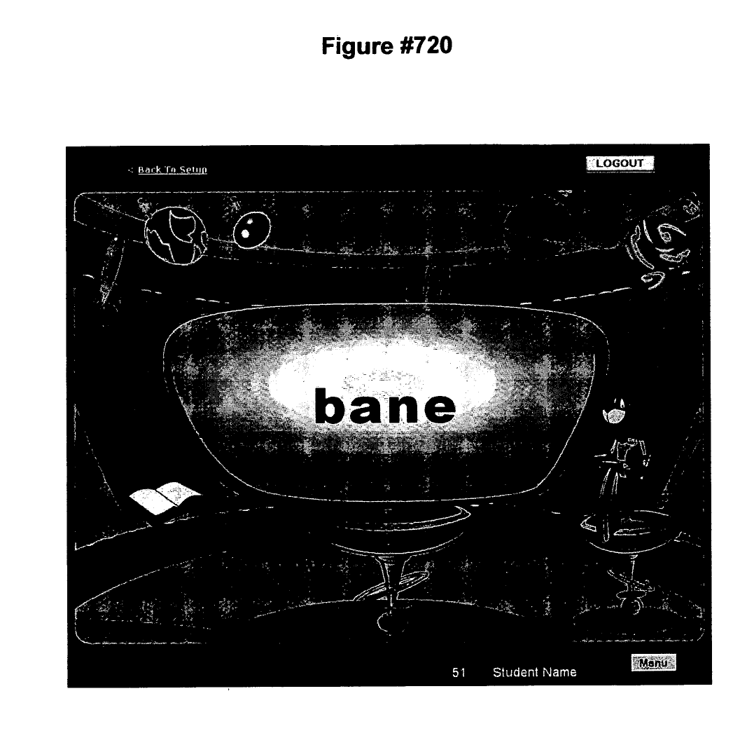

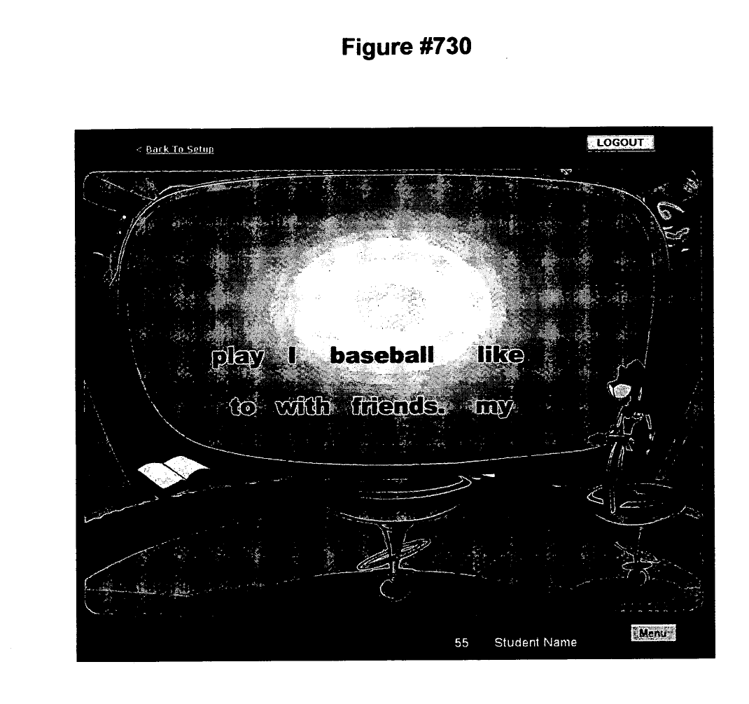

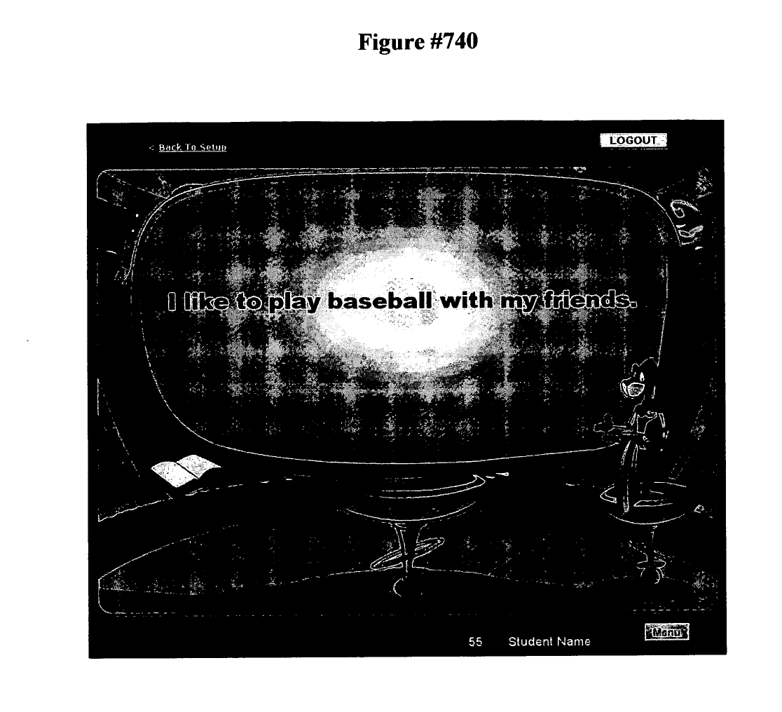

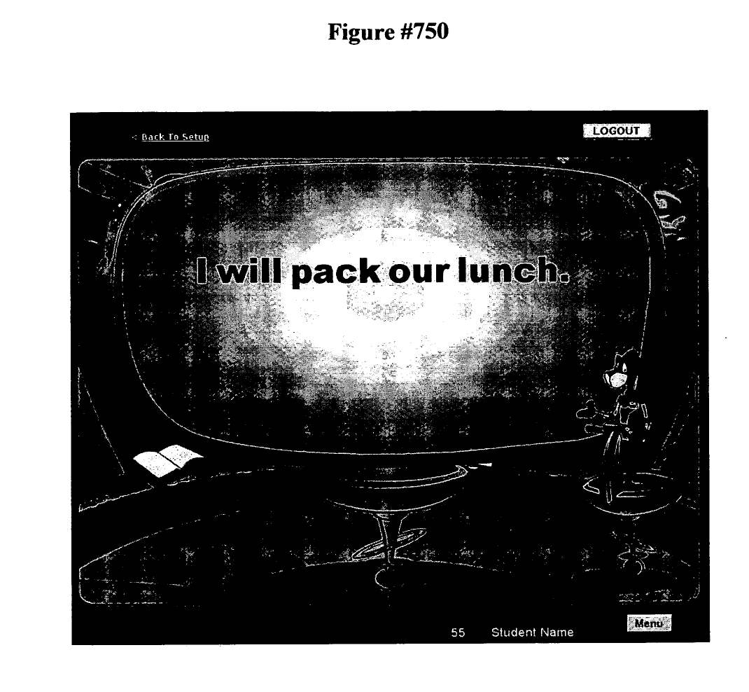

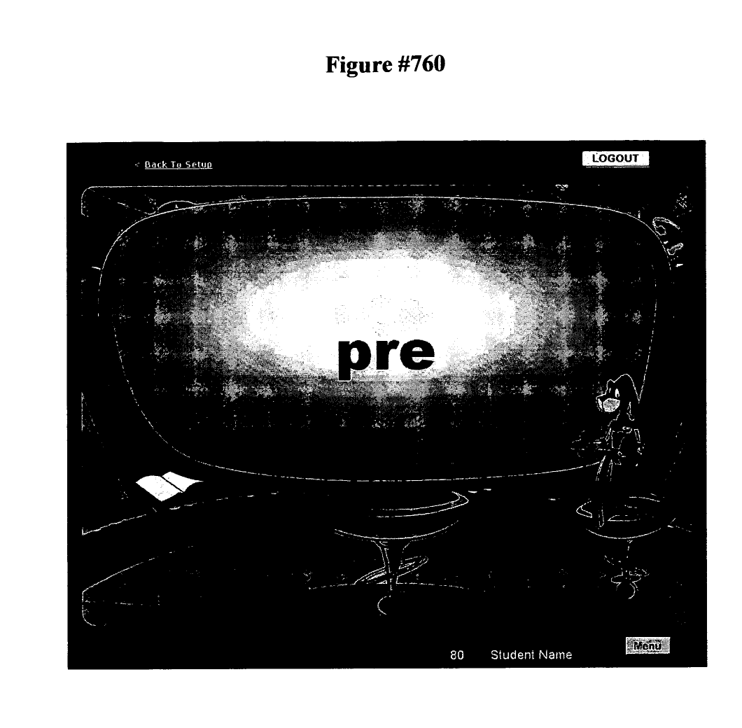

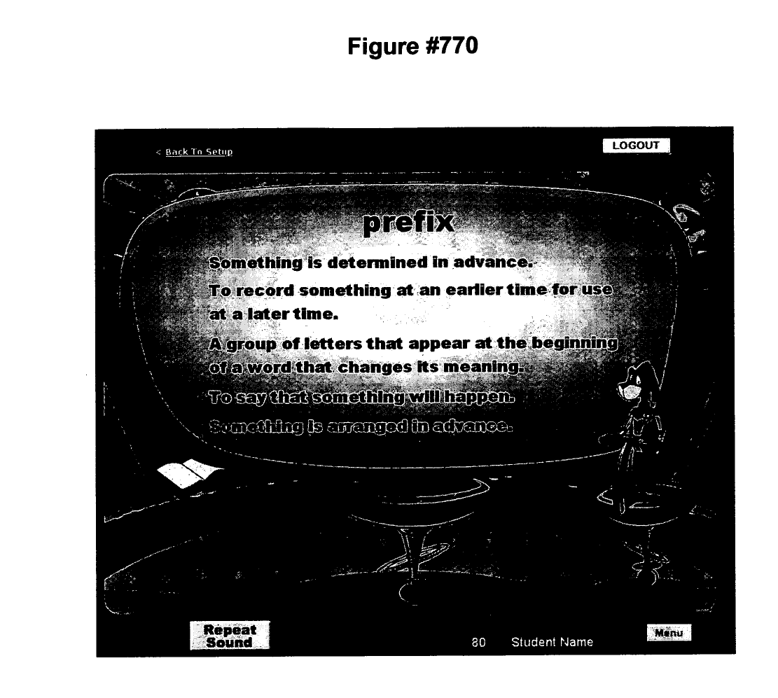

Instruction Element 8 Process (FIG. 508) is applied to a program that teaches the reading Alphabetic Principle skill of Prefixes and Suffixes wherein multiple instruction sets (sets of prefixes or suffixes), Lesson Data (FIG. 550) and Audio Data (FIG. 560), are visually and audibly presented on the computer screen and audio system, where one element from the set (a prefix or suffix) is displayed on the Screen with a set of optional meanings wherein the onscreen instructor stimuli recites the instruction set elements one element at a time separately (each prefix or suffix) where the Student User must then click on the corresponding meaning from the set of optional meanings that are displayed (See FIGS. 760, 770, 780, 790)

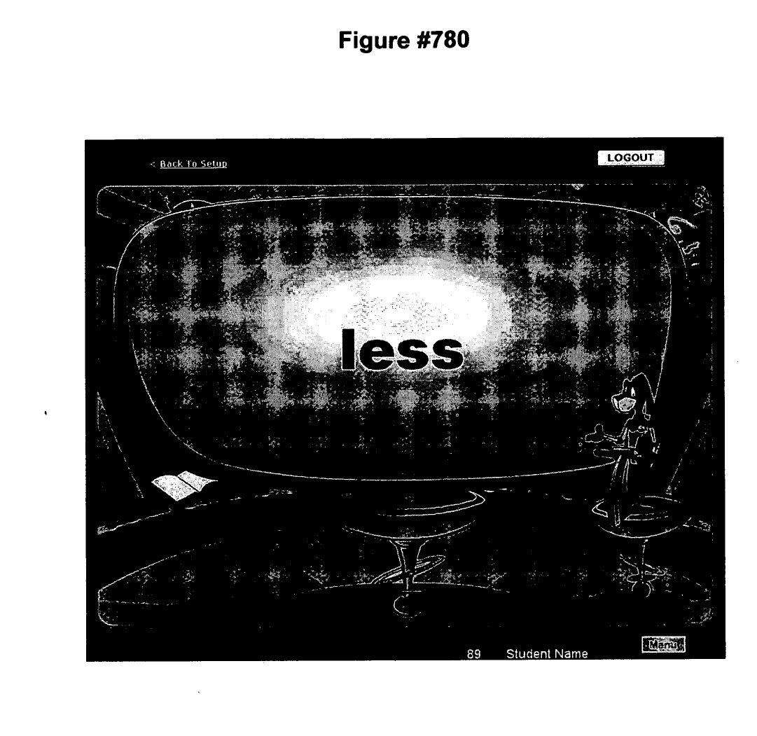

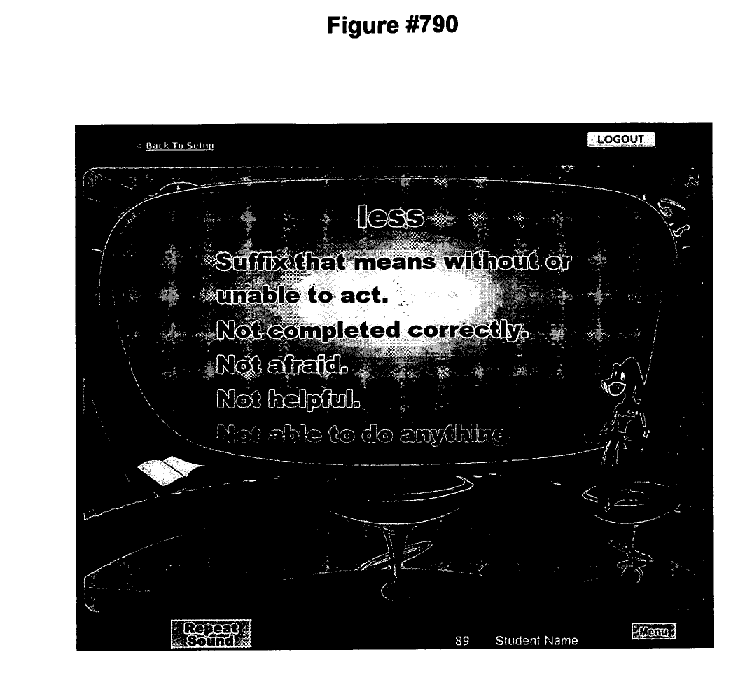

Instruction Element 9 Process (509) is applied to a program that teaches the reading Alphabetic Principle skill of Sentence Reading wherein multiple instruction sets (a group of sentences) where each set (a sentence) which contains multiple elements (words in a sentence), Lesson Data (FIG. 550) and Audio Data (FIG. 560), are visually and audibly presented on the computer screen and audio system, one set at a time on the Screen wherein the onscreen instructor stimuli recites the multiple elements of each set, one element at a time, where the Student User must listen carefully and is encouraged to read along out loud. Also, the multiple instruction sets are repeated three times where the first recitation is at a slower rate than normal speech followed by two additional recitations at a normal rate of speech. Further, simultaneously, as each element of an instruction set is displayed the corresponding displayed element is highlighted in a contrasting color from the other elements on the Screen. (See FIG. 800).

Instruction Element 10 Process (FIG. 510) is applied to a program that develops reading Fluency and Automaticity skills through Letter Sound and Word Reading review wherein multiple instruction sets (a group of graphemes or words) where each set contains multiple elements (graphemes or words), Lesson Data (FIG. 550) and Audio Data (FIG. 560), are visually and audibly presented on the computer screen and audio system, wherein the multiple elements of each instruction set are all displayed at the same time on the Screen wherein a random number generator selects a position number which is used to randomly select one of the elements for the onscreen instructor stimuli to recite where the Student User must click on the corresponding grapheme or word. Also, the multiple instruction sets are repeated randomly until a preset elapsed time counter expires. Further, a preset playback speed specifies the rate at which each randomly selected element is recited. (See FIGS. 810, 820)

What is claimed is:

1. An instructional learning system comprising a dynamic, distributed, processing approach wherein the processes are controlled by a set of multiple predefined instructional content, including Lesson Data and Audio Data control tables, and a user defined instruction control configuration instruction delivery system, wherein:
said instructional learning system utilizes a computer system that includes a central processing unit, monitor and keyboard wherein, the use thereof by said user enables said user to interact with said instructional learning system content, which is accessible by said user opening said instructional learning system;
said user includes one or more students, i.e. Student User, wherein each such Student User is a person using the instructional learning system to receive the instruction delivered by said instructional learning system, and one or more teachers, wherein each such teacher is a person who tracks the learning process using said user defined instruction control configuration for one or more Student Users;
said instruction delivery system includes predefined instructional content and simulates actual classroom instruction by including a virtual teacher, wherein:
said virtual teacher is programmed to re-teach as many times as necessary for instruction acquisition by repeating said predefined instructional content in its predetermined systematic sequence every single time an incorrect discrimination response is given by said Student User, and said virtual teacher pronounces all verbal instruction with a precision and consistency of recitation by employing state of the art voice recording and editing techniques;
said Student User may only access the instruction in that predetermined systematic sequence when prior correct discriminations have been made to advance through a lesson; and
subsequent to entering the user defined instruction control configuration, the instruction delivery system becomes entirely automated, requiring only start up of the learning system to deliver all instruction content in its precise sequence regardless of how many subsequent times the learning system is started to complete all instruction, nor of the length of time the instruction system is used each time it is started; and
said computer presents to said Student User said predefined instructional content, wherein such predefined instructional content is presented to said Student in a precise predetermined step-by-step sequence, and said Student User, utilizing said computer, responds to visual and audible prompts to select a discriminative response to said instructional content;
and further wherein the instruction delivery system is a lead-model-test instruction-presentation sequence that:
(i) first, leads the Student User by describing exactly what is each new instructional content presentation,
(ii) immediately follows with a modeled example demonstration of the new instructional content described,
(iii) then immediately follows with a test step wherein the Student User is given the opportunity to demonstrate such user's understanding of the new instruction content with an accurate discrimination response; or, in the event of an inaccurate response, repeats the lead-model-test instruction-presentation sequence;
further, said instruction delivery system is an errorless learning system that produces evidence of demonstrated mastery of all instructional content by building into the instructional learning system:
(i) the aforesaid systematic instruction,
(ii) the requirement that all correct aforesaid discriminations be made by a Student User before such Student User may advance to the next lesson, as well as to advance to each next instructional element in any given lesson,
(iii) the aforesaid lead-model-test instruction presentation process such that the correct discriminations are never revealed to the Student User,
(iv) the recording to a data storage device every single discrimination response made by each Student User for each lesson,
(v) the statistical reporting of individual lesson results that retrieves the entire discrimination response data collection for a specified lesson for a particular Student User and presents the data in a manner that pinpoints every single instructional element that was incorrectly discriminated, and
(vi) the statistical reporting over time of the cumulative results that retrieves the entire discrimination response data collection for a Student User and presents the data in a manner that particular pinpoints mastery and deficiencies.

2. The instructional learning system of claim 1, wherein the instruction delivery system is tailored to the learning needs and learning style of each individual Student User by incorporation of instruction delivery control mechanisms for students who benefit from such mechanisms and restricted from those who do not.

3. The instructional learning system of claim 2 wherein said instruction delivery control mechanisms are audible confirmations of correct discriminations.

4. The instructional learning system of claim 2 wherein said instruction delivery control mechanisms are minutes of instruction time durations that control specific portions of the learning system and may be adjusted to longer time periods for students who require a longer instruction cycle to acquire a specific skill or shorter time periods for those who quickly acquire specific skills.

5. The instructional learning system of claim 2 wherein said instruction delivery control mechanisms are instruction playback speeds that control specific portions of the learning system and may be adjusted to a slower speed for students who require instruction to be presented at a slower rate for effective skill acquisition or adjusted to a faster speed for students who require a faster rate of instruction presentation for effective skill acquisition.

6. The instructional learning system of claim 1, wherein the instruction delivery system, instructional lessons may be repeated for students who require additional instruction of a specific lesson content and repeated lessons omitted for those who do not.

7. The instructional learning system of claim 1, wherein the instruction delivery system student users may be grouped together such that students at the same or similar levels of acquired skill may be grouped together in the learning system to minimize the negative results that occur when students are engaged in instruction at the same time with others who are at notably differing skill levels.

8. The instructional learning system of claim 1, wherein the said computer system interfaces with the World Wide Web such that the instructional learning system content is accessible by said user logging on to the instructional learning system web site.

9. An instructional learning system allowing for the delivery over the internet of high resolution graphic movies of approximately 30 minute play times, or longer, that are voiceover narrated, interactive and containing comprehensive instructional content resulting in very large file sizes that are able to begin playback within approximately 15-20 seconds with continuous and uninterrupted playback on slow internet connection speeds of approximately 56 K by the distributed processing, wherein, in one embodiment, one instruction module is activated while the next one is being loaded at the same time and further, wherein in the event the next module is not loaded and ready for playback, module 1 which has already been loaded is reactivated to maintain continuous and uninterrupted playback while subsequent modules complete their loading process.

10. An instructional learning system comprised of a beginning reading program that includes instruction in spelling for keyboarding skill development.

11. An instructional learning system such that the user is capable of completing the entire setup to deliver the entire instruction content in 2 simple steps by using an Instruction Control Process Bulk Add Students function to add all student user names at the same time and depress an Add Students button and then depress a Run Lessons button.

12. An instructional learning system wherein the system allows instruction delivery using a computing device for users who have never used a computing device before by building into such system a lead-model-test instruction-presentation sequence that:
(iv) first, leads the Student User by describing exactly what is each new instructional content presentation,
(v) immediately follows with a modeled example demonstration of the new instructional content described,
(vi) then immediately follows with a test step wherein the Student User is given the opportunity to demonstrate such user's understanding of the new instruction content with an accurate discrimination response; or,
in the event of an inaccurate response, repeats the lead-model-test instruction-presentation sequence; further, wherein exactly what each instructional element is and a demonstration of how it is done combined with creation of the Lesson Data and Audio Data in such a manner that how to use the computing device is presented using such lead-model-test process along with the features of claim 11 and the systematic instruction delivery of a predetermined Lesson Data and Audio Data content wherein: a Student User may only access the instruction in that predetermined systematic sequence when prior correct discriminations have been made to advance through a lesson.

13. A method of presenting an instructional learning system, comprising:
(a) providing a computer system that includes a central processing unit, monitor and keyboard with which a Student User can interact so as to access the instructional learning system content,
(b) providing means for such access by said user to open the dynamic, distributed, processing program of said instructional learning system,
(c) providing means within the program to control the processes by a set of multiple predefined instructional content, including Lesson Data and Audio Data control tables, and a user defined instruction control configuration instruction delivery system,
(d) providing means to include more than one Student User to use the instructional learning system,
(e) providing means for one or more teachers to enter identification and progress data for each Student User, wherein each such teacher is a person who tracks the learning process using the user defined instruction control configuration for each such Student User,
(f) including in the instruction delivery system predefined instructional content a virtual teacher that simulates actual classroom instruction,
(g) programming said virtual teacher to re-teach as many times as necessary for instruction acquisition by repeating predefined instructional content in its predetermined systematic sequence every single time an incorrect discrimination response is given by a Student User,
(h) providing the virtual teacher with state of the art voice recording and editing techniques to enable the virtual teacher to pronounce all verbal instruction with a precision and consistency of recitation,
(i) providing controls such that each Student User may only access the instruction in the predetermined systematic sequence when prior correct discriminations have been made to enable such Student User to advance through a lesson,
(j) enabling the instruction delivery system to become entirely automated subsequent to entering the user defined instruction control configuration, requiring only start up of the learning system to deliver all instruction content in its precise sequence regardless of how many subsequent times the learning system is started to complete all instruction, nor of the length of time the instruction system is used each time it is started,
(k) enabling the computer program to present to the Student User the predefined instructional content, wherein such predefined instructional content is presented in a precise predetermined step-by-step sequence,
(l) enabling the Student User, through use of the computer, to responds to visual and audible prompts to select a discriminative response to the instructional content, and
(m) providing the instruction presentation sequence in a lead-model-test manner,
whereby,
(a) the Student User is led by first describing exactly what is each new instructional content presentation,
(a) following immediately with a modeled example demonstration of the new instructional content described,
(b) then immediately following with a test step that gives the Student User the opportunity to demonstrate such user's understanding of the new instruction content with an accurate discrimination response; or, in the event of an inaccurate response, repeats the lead-model-test instruction-presentation sequence, and
whereby, said instruction delivery system is an errorless learning system that produces evidence of demonstrated mastery of all instructional content by
(a) providing within the instructional learning system the aforesaid systematic instruction,
(b) providing the means to require that all correct aforesaid discriminations be made by a Student User before such Student User may advance to the next lesson, as well as to advance to each next instructional element in any given lesson,
(c) enabling the aforesaid lead-model-test instruction presentation process to be presented such that the correct discriminations are never revealed to the Student User,
(d) providing means for recording to a data storage device every single discrimination response made by each Student User for each lesson,
(e) providing means for statistical reporting of individual lesson results that retrieves the entire discrimination response data collection for a specified lesson for a particular Student User and presents the data in a manner that pinpoints every single instructional element that was incorrectly discriminated, and
(f) providing means for statistical reporting over time of the cumulative results that retrieves the entire discrimination response data collection for a Student User and presents the data in a manner that particularly pinpoints mastery and deficiencies.

14. The method of claim 13, wherein the instruction delivery system is tailored to the learning needs and learning style of each individual Student User by incorporation of instruction delivery control mechanisms for students who benefit from such mechanisms and restricted from those who do not.

15. The method of claim 14 wherein said instruction delivery control mechanisms are audible confirmations of correct discriminations.

16. The method of claim 14 wherein said instruction delivery control mechanisms are minutes of instruction time durations that control specific portions of the learning system and may be adjusted to longer time periods for students who require a longer instruction cycle to acquire a specific skill or shorter time periods for those who quickly acquire specific skills.

17. The method of claim 14 wherein said instruction delivery control mechanisms are instruction playback speeds that control specific portions of the learning system and may be adjusted to a slower speed for students who require instruction to be presented at a slower rate for effective skill acquisition or adjusted to a faster speed for students who require a faster rate of instruction presentation for effective skill acquisition.

18. The method of claim 13 wherein the instruction delivery system, instructional lessons may be repeated for students who require additional instruction of a specific lesson content and repeated lessons are omitted for those who do not.

19. The method of claim 13, wherein the instruction delivery system student users at the same or similar levels of acquired skill may be grouped together in the learning system to minimize the negative results that occur when students are engaged in instruction at the same time with others who are at notably differing skill levels.

20. The method of claim 13 wherein the said computer system interfaces with the World Wide Web such that the instructional learning system content is accessible by the user logging on to the instructional learning system web site.

21. The method for providing for the delivery over the internet of high resolution graphic movies of approximately 30 minute play times, or longer, that are voiceover narrated, interactive and containing comprehensive instructional content resulting in very large file sizes that are able to begin playback within approximately 15-20 seconds with continuous and uninterrupted playback on slow internet connection speeds of approximately 56 K by the distributed processing, wherein, in one embodiment, one instruction module is activated while the next one is being loaded at the same time and further, providing that in the event the next module is not loaded and ready for playback, module 1 which has already been loaded is reactivated to maintain continuous and uninterrupted playback while subsequent modules complete their loading process.

22. A method for enabling the user to complete the entire setup to deliver the entire instruction content in 2 simple steps by using an Instruction Control Process Bulk Add Students function to add all student user names at the same time and depress an Add Students button and then depress a Run Lessons button.
